(19) United States
(12) Patent Application Publication
(10) Pub. No.: US 2026/0187100 A1
(43) Pub. Date: Jul. 2, 2026

(54) DECENTRALIZED DATABASE MANAGEMENT SYSTEM

(71) Applicant: INERY, INC., Sheridan, WY (US)

(72) Inventors: Naveen Singh Suhag, Hitzkirch (CH); Ivan Vujic, Dubai (AE)

(21) Appl. No.: 19/423,474

(22) Filed: Dec. 17, 2025

Related U.S. Application Data
(60) Provisional application No. 63/740,646, filed on Dec. 31, 2024.
(60) Provisional application No. 63/740,672, filed on Dec. 31, 2024.
(60) Provisional application No. 63/740,711, filed on Dec. 31, 2024.

(51) Int. Cl. G06F 16/27; G06F 16/21; G06F 16/23; G06F 21/62

(52) U.S. Cl. CPC G06F 16/27; G06F 16/211; G06F 16/2379; G06F 21/6218

(57) ABSTRACT

A system for decentralized database management includes a graphical user interface (GUI) layer configured to receive user actions for database operations. The GUI layer includes an input mapping module to translate user actions into backend commands, a real-time monitoring module to display metrics related to node status, database health, and blockchain transactions, and an error handling module to categorize errors for troubleshooting. The system includes a hybrid database system integrated within a decentralized blockchain network supporting both relational and non-relational data models, with value contracts defining database schemas and rules, and an indexing mechanism for optimizing data retrieval. A Self-Delegated Proof of Equal Stake (SDPoES) consensus mechanism is provided to validate and synchronize database operations across nodes, including a dynamic scheduling engine to coordinate block production among master nodes and a stake validation system to manage master node qualification through memory staking requirements.

### CROSS-REFERENCE TO RELATED APPLICATIONS

This application claims priority to, and the benefit of, U.S. Provisional Patent Application No. 63/740,646, filed Dec. 31, 2024, U.S. Provisional Application No. 63/740,672, filed Dec. 31, 2024, and U.S. Provisional Application No. 63/740,711, filed Dec. 31, 2024, the entire contents of which are hereby incorporated by reference.

### TECHNICAL FIELD

The present disclosure relates to decentralized database management systems and distributed ledger technologies. More particularly, the present disclosure relates to an interactive graphical user interface (GUI) for a decentralized database management system that abstracts blockchain complexities and enables secure, efficient management of distributed data, a hybrid relational and non-relational database system designed for decentralized environments using blockchain technology, wherein the hybrid database system integrates structured data storage with schema-defined relationships alongside flexible, schema-less data structures within a unified platform, a Self-Delegated Proof of Equal Stake (SDPoES) consensus mechanism for blockchain-based systems that emphasizes equal authority among network participants, decentralized management through self-delegation via memory staking, and scalable network integrity through dynamic scheduling and a hybrid database framework, and a system that integrates all three components to provide a unified platform for secure, scalable, and user-accessible distributed data management across blockchain networks.

### BACKGROUND

Decentralized database management systems have emerged as an approach to address limitations of centralized architectures by distributing data across multiple nodes in a network. Such systems can offer improved scalability, reliability, and data integrity compared to traditional centralized database solutions. However, the decentralized nature of these systems introduces complexities in terms of data consistency, transaction management, and query processing across distributed nodes.

Blockchain technology provides a secure, transparent, and immutable ledger of transactions without relying on a central authority. The integration of blockchain concepts with database management systems offers possibilities for enhancing data security, traceability, and trust in distributed environments. Despite these potential benefits, adoption of decentralized and blockchain-based database systems is hindered by technical complexities involved in their implementation and management. Users seeking to interact with such systems typically require specialized knowledge of blockchain protocols, cryptographic key management, consensus mechanisms, and distributed ledger operations.

Existing graphical user interfaces for database management systems are generally designed for centralized architectures and do not adequately address the characteristics of decentralized and blockchain-based systems. Conventional interfaces lack mechanisms for abstracting blockchain complexities such as transaction signing, consensus validation, and distributed ledger interactions from end-users. Additionally, existing solutions often fail to provide integrated real-time monitoring of node status, database health, and blockchain transactions within a unified interface. Current approaches also lack streamlined workflows for translating user actions into blockchain-compatible instructions, requiring users to manually handle code compilation and deployment processes.

Furthermore, existing systems do not adequately address secure key management within the user interface layer, leaving users to manage private keys and authentication mechanisms through separate tools or manual processes. The absence of integrated error handling specific to blockchain operations makes troubleshooting difficult for users unfamiliar with distributed ledger technology. These limitations create barriers to entry for organizations that could benefit from decentralized data management solutions.

Accordingly, there is a need for a new interactive graphical user interface for decentralized database management systems that abstracts blockchain complexities from end-users, provides integrated real-time monitoring capabilities, streamlines the translation of user actions into blockchain-compatible instructions, and incorporates secure key management and error handling within a unified interface.

Beyond the user interface challenges described above, the underlying database architecture of decentralized systems presents additional technical obstacles. Indeed, database systems have long served as foundational components of information technology infrastructure, enabling organizations to store, manage, and retrieve data across diverse applications. Traditional relational databases have provided structured data storage with well-defined relationships between entities and powerful querying capabilities through structured query language (SQL). However, relational databases encounter difficulties when handling the variety and velocity of modern data streams, particularly as data volumes grow and data structures become increasingly complex. The rigid schema requirements of relational databases can limit flexibility when applications require storage of semi-structured or unstructured data types.

Non-relational or NoSQL databases emerged to address some limitations of relational systems by offering schema flexibility and horizontal scalability for handling diverse data types. However, non-relational databases can sacrifice some of the consistency guarantees and querying capabilities that relational databases provide, creating trade-offs between flexibility and data integrity.

The advent of blockchain technology has introduced new paradigms for data storage and management that emphasize immutability, transparency, and decentralization. Blockchain-based systems can provide enhanced resilience against single points of failure by distributing data across multiple participants in a network. However, integrating blockchain technology with traditional database functionalities presents challenges in terms of performance, scalability, and query capabilities. The consensus mechanisms that provide security and immutability in blockchain networks can introduce latency in transaction processing and limit throughput compared to centralized database systems.

Organizations increasingly operate in environments that span on-premises systems and cloud platforms, creating demand for database solutions that can handle diverse data types while supporting both transactional and analytical workloads. Maintaining data integrity, achieving performance at scale, and providing security measures remain ongoing concerns for database administrators and developers working with distributed data systems. The combination of relational structure, non-relational flexibility, and decentralized architecture presents technical challenges that existing database approaches have not been able to address.

Accordingly, there is a need for a new type of database system that integrates relational and non-relational data models within a decentralized blockchain architecture while providing scalability, data integrity, and flexible schema enforcement.

In addition to the user interface and database architecture challenges described above, the consensus mechanisms underlying decentralized database systems present further obstacles to effective implementation. As will be appreciated, blockchain consensus mechanisms serve as foundational components for distributed ledger systems, enabling network participants to agree on the state of shared data without relying on centralized authorities. However, existing consensus approaches such as Proof of Work, Proof of Stake, and Delegated Proof of Stake (DPoS) have their respective limitations that affect their suitability for different applications and network configurations.

For example, Proof of Work systems require participants to expend computational resources to validate transactions and produce blocks, creating barriers to entry that favor entities with access to specialized hardware and low-cost electricity. This resource-intensive approach leads to scalability constraints and concentration of mining operations among well-funded participants, thereby undermining the decentralized nature of blockchain networks.

Proof of Stake mechanisms reduce energy consumption compared to Proof of Work systems by selecting validators based on their cryptocurrency holdings rather than computational power. However, these systems exhibit centralization tendencies where participants with larger stakes accumulate disproportionate influence over network operations and governance decisions. The requirement to hold substantial amounts of cryptocurrency to become a validator limits participation to wealthy individuals and institutions.

Delegated Proof of Stake (DPOS) systems attempt to improve efficiency by allowing token holders to elect a limited number of delegates responsible for block production and validation. While this approach can enhance transaction throughput, it often concentrates authority among a small group of elected entities, creating risks of collusion and reducing the inclusivity of network participation. The delegation model favors nodes with the highest stakes in native currency, further contributing to power concentration.

In addition, traditional consensus mechanisms frequently prioritize block production efficiency over network resilience, which can lead to vulnerabilities in fault tolerance and system stability. Many existing approaches lack the adaptability to accommodate enterprise and supply chain use cases that require high transaction volumes, complex workflows, and real-time data processing capabilities.

Accordingly, there is a need for a new consensus mechanism that addresses the foregoing (and other) limitations of existing consensus mechanisms, such as the challenges of decentralization, scalability, inclusivity, and operational flexibility in distributed ledger systems.

There is also a need for a comprehensive system that integrates an interactive graphical user interface, a hybrid relational and non-relational database architecture, and an improved consensus mechanism into a unified platform for decentralized database management that addresses the deficiencies discussed above and more.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for decentralized database management is provided. The system includes an interactive graphical user interface (GUI) layer configured to receive user actions for database operations. The GUI layer can include an input mapping module configured to translate user actions into backend commands, a real-time monitoring module configured to display metrics related to one or more of node status, database health, and blockchain transactions, and/or an error handling module configured to categorize errors under specific codes for troubleshooting.

The system further includes a hybrid database system integrated within a decentralized blockchain network, where the hybrid database system is configured to support both relational and non-relational data models. The hybrid database system can include one or more value contracts defining database schemas and rules for data operations, and an indexing mechanism configured to create and maintain indexes for optimizing data retrieval operations.

The system also includes a Self-Delegated Proof of Equal Stake (SDPoES) consensus mechanism configured to validate and synchronize database operations across a plurality of nodes in the decentralized blockchain network. The SDPoES consensus mechanism can include a dynamic scheduling engine configured to coordinate block production activities among master nodes with equal stake authority, and a stake validation system configured to manage qualification of master nodes through memory staking requirements.

According to other aspects of the present disclosure, the system can include one or more of the following features. The input mapping module can be further configured to compile the backend commands into WebAssembly (WASM) format for execution within the decentralized blockchain network, and can generate Application Binary Interface (ABI) files during compilation. The real-time monitoring module can include an explorer lite plugin configured to provide monitoring of node performance, block production, and transaction inspection, and the GUI layer can enable users to customize dashboards by selecting specific metrics to monitor and setting thresholds for alerts. The GUI layer can further include visual tools configured for schema creation, data querying, and access control management, including a drag-and-drop interface for designing database schemas.

In some cases, the system can further include a node layer positioned between the GUI layer and the hybrid database system, where the node layer includes a proxy server configured to validate requests from the GUI layer and format the requests for blockchain interaction, a data buffer configured to temporarily store data during operations, a consensus interaction module configured to interface with the SDPoES consensus mechanism for confirming transactions, a load balancer configured to distribute traffic and transaction requests across nodes to prevent bottlenecks during high-demand periods, and/or a temporary database configured to store pending actions when network traffic is high or when a node is unable to push data to the decentralized blockchain network immediately. The proxy server can implement security measures including rate-limiting, IP filtering, and signature verification.

The one or more value contracts can be configured to define table structures, column types, and relationships between entities for relational data, and can provide flexible schema definitions for non-relational data while enforcing rules requiring specific metadata fields to be present in documents. The indexing mechanism can automatically generate indexes based on predefined rules and data usage patterns, support user-defined indexes that enable users to manually define custom indexes for specific records, and/or support up to sixteen different indexes per composition for query operations.

The hybrid database system can further include a permission management component configured to establish and enforce access controls for database operations at a blockchain level, where the permission management component can support dynamic permissions based on time constraints and network state, and record permission actions in an immutable ledger to maintain an audit trail of all authorized operations. The hybrid database system can also include a hybrid database transaction interface configured to package processed data into blocks for submission to the decentralized blockchain network for consensus validation.

The dynamic scheduling engine can include a round manager configured to organize master nodes into production rounds of seventeen master nodes each, and the SDPoES consensus mechanism can require a majority consensus of two-thirds of the seventeen master nodes in a production round to validate and confirm each transaction. The stake validation system can include a static IP validator configured to verify that master nodes maintain static IP addresses for continuous node availability, and a memory stake verifier configured to validate that nodes meet a minimum stake requirement for master node qualification. The SDPoES consensus mechanism can further include a block production controller configured to manage creation, validation, and synchronization of blocks within the decentralized blockchain network, where the block production controller enforces a block creation time window of 0.5 seconds for each master node in a production schedule and includes a network synchronizer configured to propagate validated blocks to all participating master nodes for data synchronization. The SDPoES consensus mechanism can also include a node performance monitor configured to track performance metrics including block production rate, uptime, and/or response time, and can automatically remove master nodes from a production schedule when the master nodes fail to meet established performance criteria for a pre-defined period. The system can further include a multi-cluster architecture including a centralized coordinator configured to oversee and coordinate operations between a plurality of clusters to ensure consistent data integrity and inter-cluster communication.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1A illustrates a block diagram of a system for a decentralized database management system with an interactive graphical user interface, according to aspects of the present disclosure.

FIG. 1B illustrates a block diagram of a system for a decentralized database management system with an interactive graphical user interface, according to an embodiment.

FIG. 2 illustrates a flowchart of a method for processing user actions through code compilation and blockchain execution, according to aspects of the present disclosure.

FIG. 3 illustrates a workflow for transforming user inputs into blockchain operations, according to an embodiment.

FIG. 4 illustrates a flowchart of a method for processing user actions through a decentralized database management system, according to aspects of the present disclosure.

FIG. 5 illustrates a flowchart of a method for managing network traffic in a decentralized database management system, according to an embodiment.

FIG. 6 illustrates a diagram of a decentralized database management system showing interaction between a user and system components through an interactive graphical user interface, according to aspects of the present disclosure.

FIG. 7 illustrates a system diagram for securing transactions within a decentralized database management system, according to an embodiment.

FIG. 8 illustrates a transaction pathway within a decentralized database management system, according to aspects of the present disclosure.

FIG. 9 illustrates a transaction lifecycle within a decentralized database management system, according to an embodiment.

FIG. 10A illustrates a system for processing user requests in a decentralized database management system, according to aspects of the present disclosure.

FIG. 10B illustrates a login service workflow for verifying user credentials in a decentralized database management system, according to an embodiment.

FIG. 11 illustrates a block diagram of a system architecture for a hybrid database system integrating an enterprise data processing system with a decentralized blockchain network, according to aspects of the present disclosure.

FIG. 12 illustrates a block diagram of a system for managing decentralized database operations across multiple clusters, according to aspects of the present disclosure.

FIG. 13 illustrates a flowchart for a method for processing unstructured and semi-structured data in a hybrid database system, according to aspects of the present disclosure.

FIG. 14 illustrates a flowchart for a query processing method in a hybrid database system, according to aspects of the present disclosure.

FIG. 15 illustrates a flowchart for a permission enforcement method within a hybrid database system, according to aspects of the present disclosure.

FIG. 16 illustrates a flowchart for a dynamic clustering management method in a hybrid database system, according to aspects of the present disclosure.

FIG. 17 illustrates a data flow diagram for processing unstructured and semi-structured data in a hybrid database system, according to aspects of the present disclosure.

FIG. 18 illustrates an indexing process diagram for a hybrid database system, according to aspects of the present disclosure.

FIG. 19 illustrates a block diagram of a hybrid database model demonstrating capability to handle multiple database paradigms, according to aspects of the present disclosure.

FIG. 20 illustrates a permission enforcement workflow within a hybrid database system, according to aspects of the present disclosure.

FIG. 21 illustrates a master production cycle comprising multiple production rounds within a Self-Delegated Proof of Equal Stake (SDPoES) consensus mechanism, according to aspects of the present disclosure.

FIG. 22 illustrates a distributed ledger system (DLS) network topology configured for distributed ledger operations in a blockchain environment, according to aspects of the present disclosure.

FIG. 23 illustrates a block diagram of an SDPoES consensus framework comprising interconnected components for managing blockchain consensus operations, according to aspects of the present disclosure.

FIG. 24 illustrates a node state flowchart representing communication and interaction structure among master nodes in a distributed blockchain network, according to aspects of the present disclosure.

FIG. 25 illustrates a dynamic consensus scheduling diagram representing master node scheduling and block production coordination, according to aspects of the present disclosure.

FIG. 26 illustrates a value contract workflow representing deployment and execution of value contracts within a distributed ledger system, according to aspects of the present disclosure.

FIG. 27 illustrates a flowchart for a method of master node onboarding and validation in the SDPoES consensus mechanism, according to aspects of the present disclosure.

FIG. 28 illustrates a flowchart for a method of dynamic scheduling and block production within the SDPoES consensus mechanism, according to aspects of the present disclosure.

FIG. 29 illustrates a flowchart for a method of automated node performance monitoring and management within the SDPoES consensus framework, according to aspects of the present disclosure.

FIG. 30 illustrates a flowchart for a method of system value contract deployment and execution within a blockchain network, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

### Interactive Graphical User Interface (GUI) for Decentralized Database Management System (DDBMS)

This section of the present disclosure relates to systems and methods for an interactive graphical user interface (GUI) for a decentralized database management system (DDBMS) that abstracts blockchain complexities and enables secure, efficient management of distributed data. Decentralized database management systems have emerged as an approach to address limitations of centralized architectures. By distributing data across multiple nodes in a network, decentralized database management systems may offer improved scalability, reliability, and data integrity. However, the decentralized nature of these systems introduces complexities in terms of data consistency, transaction management, and query processing across distributed nodes.

Blockchain technology provides a secure, transparent, and immutable ledger of transactions without relying on a central authority. While initially developed for cryptocurrencies, blockchain applications extend beyond financial transactions. The integration of blockchain concepts with database management systems offers possibilities for enhancing data security, traceability, and trust in distributed environments. Despite the benefits of decentralized and blockchain-based database systems, adoption is hindered by technical complexities involved in implementation and management. This creates a barrier to entry for organizations that could benefit from decentralized data management.

Graphical user interfaces have played a role in making complex software systems more accessible to a wider range of users. However, the characteristics of decentralized and blockchain-based systems present challenges for interface design, requiring approaches to abstract away underlying complexities while still providing functionality. As the field of decentralized database management continues to evolve, there is a growing need for user-friendly tools that can bridge the gap between the technical intricacies of these systems and the practical needs of database administrators, developers, and end-users. Such tools can accelerate the adoption of decentralized database technologies across various industries and enable organizations to harness the benefits of distributed data management without sacrificing ease of use or requiring extensive retraining of personnel.

The present disclosure addresses these considerations by providing an interactive GUI for a DDBMS. The interactive graphical user interface described herein provides a user-friendly interface that abstracts the complexities of blockchain technology, allowing users to interact with a decentralized database infrastructure seamlessly. The system integrates multiple layers to create a comprehensive solution for decentralized data management, including a graphical user interface layer, a node layer, and a blockchain layer. As further detailed below, the graphical user interface layer can include an input mapping module that translates user actions into backend commands, a real-time monitoring module that displays node status and database health, and an error handling module that assists users in troubleshooting issues. The node layer can serve as an intermediary between the graphical user interface layer and the blockchain layer, facilitating efficient communication and data management. The blockchain layer can form the foundation for secure and transparent data management, incorporating value contracts, a distributed ledger, and a blockchain application programming interface.

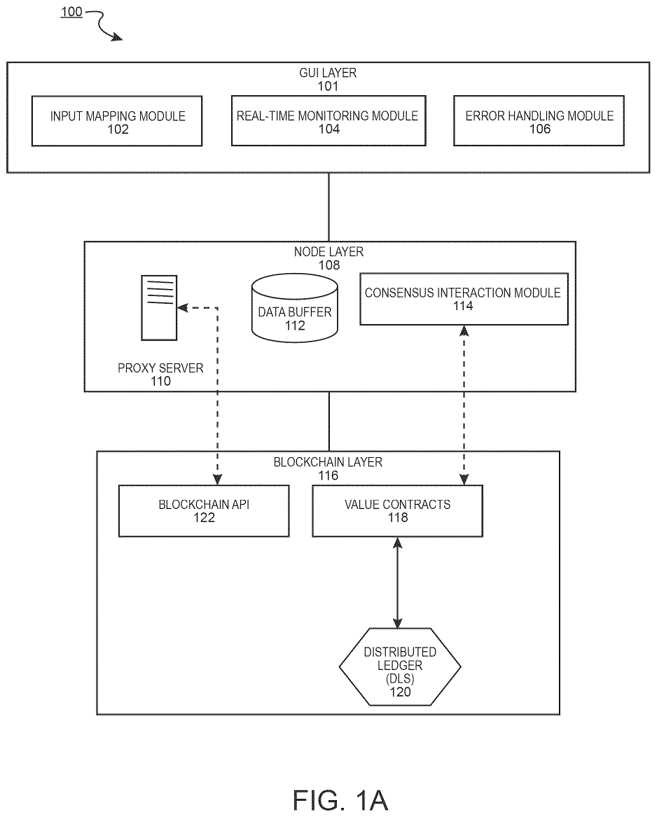

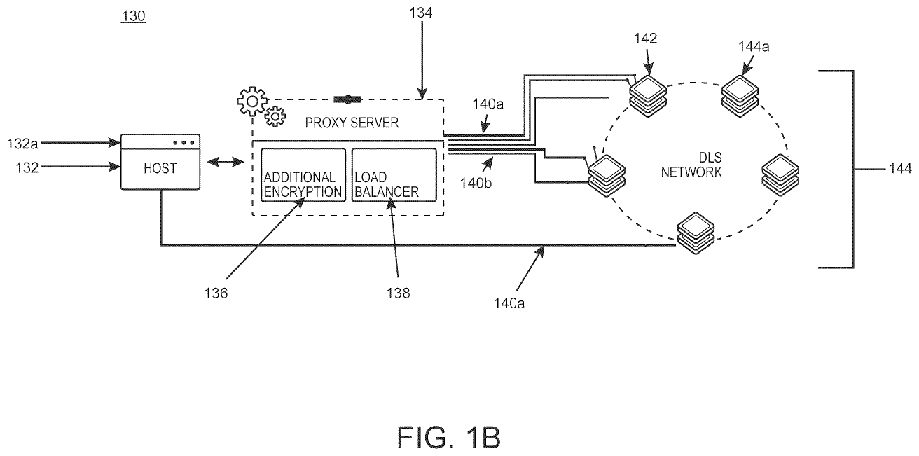

Turning now to FIG. 1A, a system 100 for a decentralized database management system with an interactive graphical user interface according to this disclosure is illustrated. The system 100 comprises three distinct layers: a GUI layer 101, a node layer 108, and a blockchain layer 116. These three layers work together to facilitate user interaction with a decentralized database infrastructure. The GUI layer 101 serves as the primary interface through which users interact with the decentralized database management system. The node layer 108 is shown below the GUI layer 101 and serves as an intermediary between the GUI layer 101 and the blockchain layer 116. The blockchain layer 116 is positioned at the bottom of the system 100 and forms the foundation for data management, ensuring data integrity, immutability, and security.

With continued reference to FIG. 1A, communication flows between the GUI layer 101, the node layer 108, and the blockchain layer 116 in a hierarchical manner. User actions initiated through the GUI layer 101 are transmitted to the node layer 108 for processing and validation. The node layer 108 then forwards validated requests to the blockchain layer 116 for execution. Results from the blockchain layer 116 can then be returned through the node layer 108 back to the GUI layer 101 for display to the user. This layered architecture enables the system 100 to abstract blockchain complexities from end-users while maintaining the security and transparency benefits of blockchain technology.

Referring now to FIG. 1B, an alternative perspective of a system 130 for a decentralized database management system with an interactive GUI is illustrated. The system 130 comprises a host 132, a proxy server 134, and a DLS network 144. The host 132 and proxy server 134 depicted in FIG. 1B can be incorporated within the system architecture shown in FIG. 1A. For instance, the host 132 and web application 132a of FIG. 1B can correspond to or reside within the GUI layer 101 of FIG. 1A, serving as the interface through which users interact with the system. The proxy server 134 of FIG. 1B corresponds to the proxy server 110 of FIG. 1A and thus, reside within the node layer 108 and functions as an intermediary between the GUI layer 101 and the blockchain layer 116. The host 132 is positioned on the left side of the system 130 and includes a web application 132a. The web application 132a serves as the interface through which users interact with the system 130. The host 132 connects to the proxy server 134 through bidirectional communication pathways, enabling data exchange between the user interface and an intermediate processing layer.

With continued reference to FIG. 1B, the proxy server 134 is positioned in the center of the system 130 and serves as an intermediary between the host 132 and the DLS network 144. The proxy server 134 can include an encryption module 136 and a load balancer 138. The encryption module 136 handles cryptographic operations to secure data transmitted through the system 130, whereas the load balancer 138 distributes incoming requests across multiple processing pathways to optimize performance and prevent system overload. The load balancer 138 can also distribute traffic and transaction requests evenly across nodes to prevent bottlenecks and single points of failure during high-demand periods.

As further shown in FIG. 1B, the proxy server 134 can process two types of requests: POST request(s) 140b and GET request(s) 140a. The POST request(s) 140b flow from the proxy server 134 toward the DLS network 144, while the GET request(s) 140a flow from the DLS network 144 toward the proxy server 134. These request pathways illustrate the bidirectional communication between the proxy server 134 and the DLS network 144. An RPC (Remote Procedure Call) API (Application Program Interface) 142 is positioned between the proxy server 134 and the DLS network 144. The RPC API 142 facilitates communication between the proxy server 134 and the distributed network infrastructure, translating requests into blockchain-compatible formats.

The DLS network 144 is positioned on the right side of the system 130 and is depicted as a collection of interconnected network node 144a elements arranged in a distributed configuration. The network node 144a elements represent the decentralized nature of the network. The DLS network 144 forms the underlying blockchain infrastructure for data storage and transaction processing. The system 130 demonstrates the flow of data from the web application 132a through the host 132 to the proxy server 134, where the encryption module 136 secures the data and the load balancer 138 optimizes request distribution. The processed requests are then transmitted through the RPC API 142 to the DLS network 144 for execution and storage across the distributed network node 144a elements. A Node.js backend, for example, can function as middleware between the web application 132a and the DLS network 144 to facilitate communication and execute services on the distributed ledger, ensuring seamless handling of multiple sessions without tying any single node to a single user.

Referring again to FIG. 1A, the GUI layer 101 in this example includes an input mapping module 102, a real-time monitoring module 104, and an error handling module 106. These modules provide the interface through which users interact with the system 100 and facilitate efficient management of decentralized databases without requiring extensive technical expertise from users.

With continued reference to FIG. 1A, the input mapping module 102 is positioned on the left side of the GUI layer 101. This input mapping module 102 can be configured to translate user actions into backend commands. For example, when a user creates a table or queries data through the interface, the input mapping module 102 can convert these actions into corresponding C++ instructions or other supported programming language instructions. To that end, the input mapping module 102 can be configured to support object and vector types alongside primary basic types to handle deeper, more complex data structures and nested queries. This capability enables the input mapping module 102 to manage intricate data relationships efficiently, ensuring accurate processing of user requests even when dealing with complex database operations.

As further shown in FIG. 1A, the real-time monitoring module 104 is positioned in the center of the GUI layer 101. The real-time monitoring module 104 can be configured to monitor, capture and/or display various metrics related to the performance and status of the system 100. For instance, the real-time monitoring module 104 can monitor and provide information relating to node status, database health, and blockchain transactions, to name a few. In some cases, the real-time monitoring module 104 can include an Explorer Lite plugin that provides monitoring of node performance, block production, and transaction inspection capabilities. The Explorer Lite plugin allows users to track metrics in real-time and view details of individual transactions for auditing or troubleshooting purposes. The system 100 allows users to customize dashboards by selecting specific metrics to monitor and setting thresholds for alerts. When a monitored metric exceeds or falls below a user-defined threshold, the system 100 can be configured to generate an alert or other type of notice, enabling proactive management of the database.

With continued reference to FIG. 1A, the GUI layer 101 can also include the error handling module 106. This module 106 can be configured to assists user in troubleshooting issues that may arise during database operations. For instance, the error handling module 106 can categorize errors under specific codes, with each code representing a distinct error type for precise identification and troubleshooting. This approach allows for more precise identification of problems. For instance, when a transaction fails or an invalid input occurs, the error handling module 106 can provide a clear error code, enabling users to understand the nature of the issue and take appropriate corrective actions.

In some cases, the GUI layer 101 can also include visual tools for schema creation, data querying, and access control management that allow users to perform complex database operations without extensive blockchain knowledge. For example, these visual tools can enable users to design a database schema using a drag-and-drop interface or construct complex queries using a visual query builder. By integrating the input mapping module 102, the real-time monitoring module 104, and the error handling module 106, the GUI layer 101 provides a comprehensive and intuitive interface for managing decentralized databases, making the capabilities of blockchain technology accessible to a wider range of users.

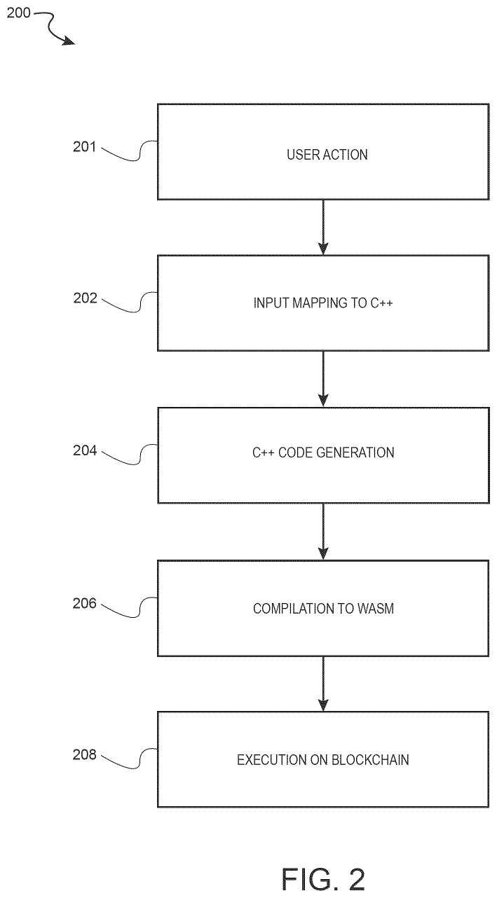

Referring now to FIG. 2, a method 200 for processing user actions in a decentralized database management system through code compilation and blockchain execution is illustrated. The method 200 begins with step 201, where a user action is received. The user action can include operations such as creating a table, querying data, and/or modifying database entries through the GUI layer 101.

The method 200 proceeds to step 202, Input Mapping to C++, where user actions are translated into C++ programming language instructions. The input mapping module 102 (FIG. 1A) can perform this translation by converting high-level user interactions into corresponding backend commands. Following step 202, the method 200 advances to step 204, C++ Code Generation, where the mapped inputs are converted into executable C++ code structures. This step 204 transforms the translated instructions into complete C++ code that can be further processed for blockchain execution.

Next, the method 200 continues to step 206, Compilation to WASM, where the generated C++ code is compiled into WebAssembly (WASM) format. In some cases, the input mapping module 102 (FIG. 1) can compile C++ code into WASM format using a specialized C++ to WASM compiler, such as an Inery(TM) compiler, for execution within the blockchain ecosystem. This compilation step 206 transforms the code into a platform-independent format suitable for blockchain execution. The method 200 concludes with step 208, Execution on Blockchain, where the compiled WASM code is executed within the blockchain environment of the blockchain layer 116.

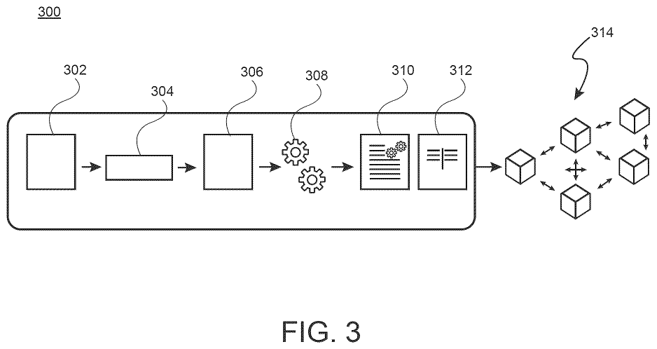

Turning now to FIG. 3, an exemplary workflow 300 diagram illustrating the transformation of user inputs into blockchain operations within the decentralized database management system is illustrated. The workflow 300 begins with user inputs 302, which can be structured in JSON format, for example, and serve as the starting point for the transformation process. The user inputs 302 represent database operations initiated through the GUI layer 101.

As further shown in FIG. 3, the workflow 300 proceeds to a generator 304, where the user inputs 302 are processed and converted. The generator 304 transforms the JSON-formatted data into C++ code 306, which represents the next stage in the transformation sequence. The C++ code 306 contains the executable instructions corresponding to the user's database operations.

Following the generation of the C++ code 306, the workflow 300 advances to a compiler 308. The compiler 308 processes the C++ code 306 and converts the C++ code 306 into a WASM format 310, producing a platform-independent executable format suitable for blockchain execution. During this compilation stage, the compiler 308 can also generate Application Binary Interface (ABI) files 312 that define the interface for interacting with the compiled code. The WASM format 310 and the ABI files 312 together provide the components for deploying and executing database operations on the blockchain.

With continued reference to FIG. 3, the workflow 300 concludes with the deployment of the WASM format 310 and the ABI files 312 to a DLS network 314. The DLS network 314 is depicted as a collection of interconnected nodes arranged in a distributed configuration, representing the decentralized infrastructure where the compiled code is executed. Each step in the workflow 300 flows linearly from the previous step, creating a systematic progression from user interface interactions to blockchain-compatible operations. This transformation process enables users to perform database operations through the GUI layer 101 without requiring direct knowledge of the underlying blockchain technology or programming languages.

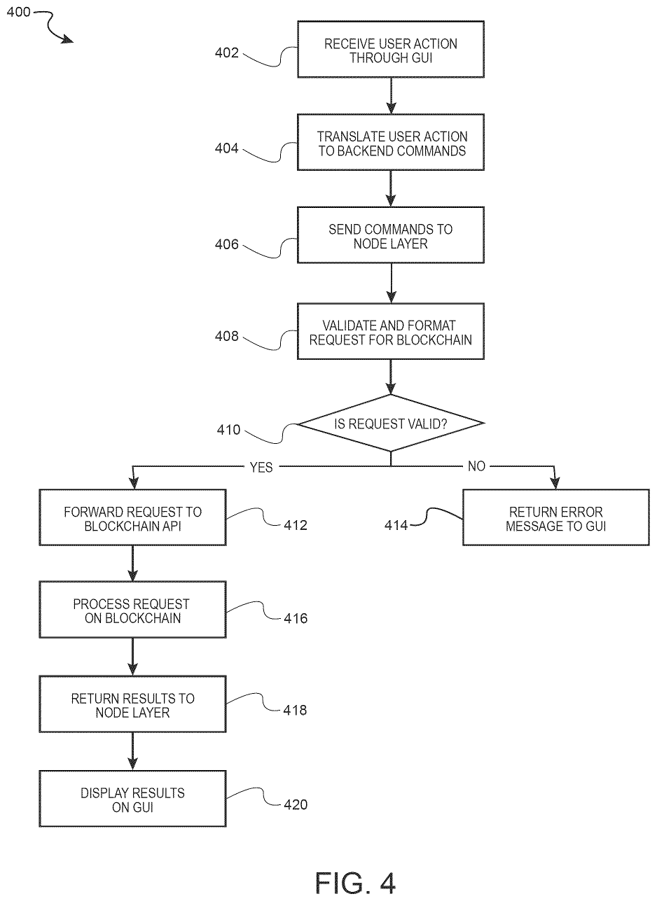

Referring now to FIG. 4, a method 400 for processing user actions through the decentralized database management system is illustrated. The method 400 begins with step 402, where a user action (also referred to as a ‘user request’) is received through the GUI layer 101 (FIG. 1A). The user action/request can include operations such as creating a table, querying data, updating records, and/or other database management tasks initiated through the graphical user interface.

The method 400 proceeds to step 404, where the user action is translated to backend commands. As noted above, the input mapping module 102 (FIG. 1A) can perform this translation by converting high-level user interactions into corresponding C++ instructions or other supported programming language instructions. Following step 404, the method 400 advances to step 406, where the commands are sent to the node layer 108 (FIG. 1A). The node layer 108 receives the translated commands and prepares the commands for further processing.

With continued reference to FIG. 4, the method 400 continues to step 408, where the user action/request is validated and formatted for blockchain interaction. In some implementations, the proxy server 110 (FIG. 1B) can perform validation by ensuring the request follows the correct protocol, is properly formatted, and adheres to access control rules. The proxy server 110 can also translate or route requests to the appropriate block producer or API endpoint for processing.

The method 400 then moves to step 410, which involves a decision point to determine whether the user action/request is valid. If the user action/request is valid (Yes branch), the method 400 proceeds to step 412, where the user action/request is forwarded to the blockchain API 122. If the user action/request is not valid at step 410 (No branch), the method 400 moves to step 414, where an error message is returned to the GUI layer 101 (FIG. 1A). Invalid or malformed user actions/requests can be rejected with error messages, while malicious actions/requests can be handled using security measures such as rate-limiting, IP filtering, and signature verification.

Following step 412, the method 400 advances to step 416, where the user action/request is processed on the blockchain layer 116 (FIG. 1A). The blockchain layer 116 (FIG. 1A) can store, retrieve, and/or update data based on the user's action, and transactions can be logged on the distributed ledger system 120 (FIG. 1A) for transparency and immutability. After the blockchain processing at step 416, the method 400 continues to step 418, where the results can be returned to the node layer 108 (FIG. 1A). The method 400 then proceeds to step 420, where the results are displayed on the GUI layer 101 (FIG. 1A), providing real-time feedback to the user.

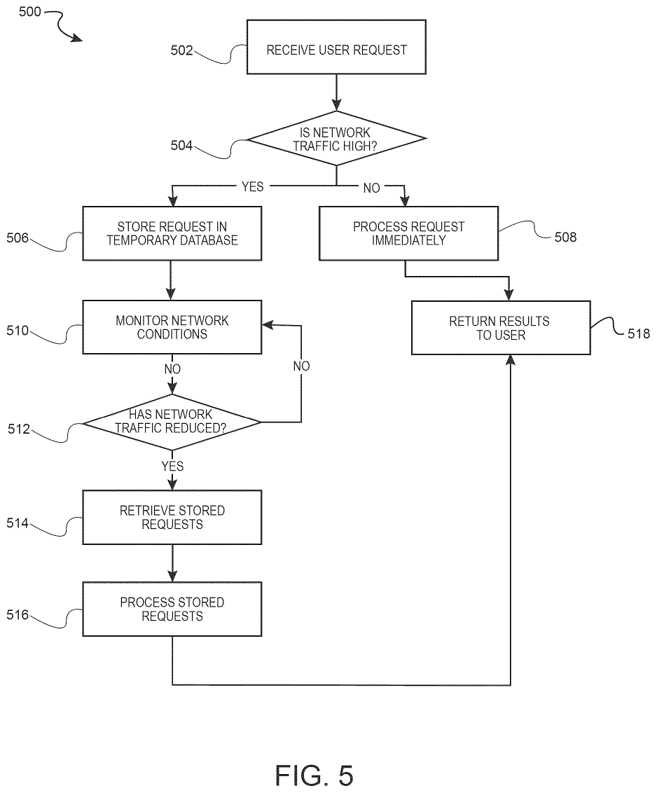

Turning now to FIG. 5, a method 500 for managing network traffic in the decentralized database management system is illustrated. The method 500 begins with step 502, where a user request is received. The method 500 then proceeds to step 504, which involves determining whether network traffic is high. This determination can be based on factors such as the number of pending transactions, network bandwidth utilization, and/or node processing capacity, among others.

With continued reference to FIG. 5, if network traffic is high (Yes branch), the method 500 moves to step 506, where the user request is stored in a temporary database. In some cases, the system 100 (FIG. 1A) can include a temporary database within the node layer 108 (FIG. 1A) that stores pending actions when there is high traffic or when a node is unable to push data to the DLS network 144 (FIG. 1B) immediately. This temporary database helps prevent data loss and ensures that transactions or updates are eventually processed, even if there are temporary issues with the node or network congestion.

Following step 506, the method 500 continues to step 510, where network conditions are monitored. The method 500 then proceeds to step 512, which involves checking whether network traffic has reduced. If network traffic has not reduced (No branch), the method 500 returns to step 510 to continue monitoring network conditions. This monitoring loop ensures that the system 100 (FIG. 1A) waits for appropriate network conditions before attempting to process stored requests.

If, however, network traffic has reduced (Yes branch), the method 500 advances to step 514, where stored requests can be retrieved from the temporary database. The method 500 can then move to step 516, where the stored requests are processed. The processing of stored requests follows the same validation and blockchain execution pathway as immediate requests, ensuring consistent handling of all user actions.

If network traffic is not high at step 504 (No branch), the method 500 proceeds directly to step 508, where the request is processed immediately without temporary storage. Following step 508, the method 500 continues to step 518, where results are returned to the user. After processing stored requests at step 516, the method 500 also proceeds to step 518, where results are returned to the user, completing the process. This traffic management approach enables the system 100 to handle varying workloads while maintaining responsiveness to user requests and preventing data loss during high-traffic periods.

Referring again to FIG. 1A, the node layer 108 of the system 100 serves as an intermediary between the GUI layer 101 and the blockchain layer 116, facilitating efficient communication and data management. The node layer 108 can comprise several components that work together to process user requests, manage data, and interact with the blockchain layer 116. As shown in FIG. 1A, the node layer 108 includes the proxy server 110 depicted on the left side, a data buffer 112 shown in the center, and a consensus interaction module 114 positioned on the right side.

With continued reference to FIG. 1A, the proxy server 110 can be configured to handle API requests from the GUI layer 101 and translate the API requests into blockchain-compatible instructions. To that end, the proxy server 110 implements validation through protocol checking to ensure that incoming requests follow the correct communication protocol. The proxy server 110 can also perform proper formatting verification to confirm that requests are structured according to expected formats before forwarding the requests to the blockchain layer 116. Additionally, the proxy server 110 can be configured to enforce access control rules to determine whether a requesting entity has authorization to perform the requested operation.

The proxy server 110 can also implement security measures to handle invalid or malicious requests. These security measures can include rate-limiting to prevent excessive requests from overwhelming the system 100, IP filtering to block requests from unauthorized or suspicious network addresses, and/or signature verification to authenticate the identity of requesting entities, among others. Invalid or malformed requests can be rejected by the proxy server 110 with corresponding error messages that are returned to the GUI layer 101 through the error handling module 106. The proxy server 110 can also translate or route requests to the appropriate block producer or API endpoint within the blockchain layer 116 for processing.

As further shown in FIG. 1A, the data buffer 112 is shown positioned in the center of the node layer 108 and is configured to temporarily hold data during operations to reduce latency and optimize performance. The data buffer 112 can have configurable size limits that are defined by node configuration based on available memory and network capacity. These size limits determine the maximum amount of data that the data buffer 112 can store at any given time. When the data buffer 112 reaches capacity, overflow handling mechanisms can discard older or less urgent data to make room for incoming data. In some cases, the node can temporarily halt processing of new transactions until space is freed up in the data buffer 112, helping prevent the system 100 from being overwhelmed and ensuring stability and continuous operation of the network.

With continued reference to FIG. 1A, the consensus interaction module 114 is shown positioned on the right side of the node layer 108 and is configured to interface with the blockchain layer 116 for confirming transactions. The consensus interaction module 114 communicates with the blockchain layer 116 to ensure that transactions are properly validated and recorded across the DLS network 144 (FIG. 1B). When a user initiates a database update through the GUI layer 101, the consensus interaction module 114 can communicate with the blockchain layer 116 to ensure that the transaction is confirmed according to the consensus mechanism employed by the distributed ledger system 120.

In some cases, the system 100 can be configured to support multiple user sessions simultaneously on a single node within the node layer 108. Session management can be dependent on browser memory for storing user-specific data for active sessions. This configuration allows the node layer 108 to handle requests from multiple users concurrently without tying any single node to a single user. The ability to manage multiple sessions enables the system 100 to serve a larger number of users while maintaining efficient resource utilization across the node layer 108.

With continued reference to FIG. 1A, the blockchain layer 116 of the system 100 forms the foundation for secure and transparent data management within the decentralized database management system. The blockchain layer 116 includes the blockchain API 122 shown on the left side, value contracts 118 positioned on the right side, and the distributed ledger system 120 depicted as a hexagonal shape at the bottom center. These components work together to ensure data integrity, immutability, and efficient processing of transactions across a DLS network (e.g., DLS network 144 of FIG. 1B).

The blockchain API 122 provides access for querying, storing, and updating data across the decentralized network. To that end, the blockchain API 122 facilitates interaction with nodes through predefined endpoints for database-specific functions. To handle high-frequency requests and large queries while avoiding bottlenecks, the blockchain API 122 can implement several performance optimization techniques. For instance, the blockchain API 122 can implement caching for frequently accessed data, allowing faster retrieval without overloading the blockchain layer 116. The blockchain API 122 can also utilize indexing to speed up query processing for large datasets, ensuring that the system 100 can handle large volumes of data efficiently.

As further shown in FIG. 1A, the blockchain API 122 can implement parallel processing to break down large queries and high-frequency requests into smaller components that are processed concurrently. This parallel processing approach enables efficient data handling without creating performance bottlenecks. The blockchain API 122 can also support optimized query execution, allowing for fast processing of large datasets and complex queries without significantly impacting system performance. These optimization techniques enable the blockchain API 122 to maintain responsiveness even during periods of high transaction volume or when processing complex database operations.

The value contracts 118 of FIG. 1A govern data storage, access permissions, and query execution within the decentralized database management system. The value contracts 118 enforce rules for database access, updates, and queries by defining specific permissions and validation logic that are followed for any operation. The value contracts 118 can specify which users or entities can access particular data and under what conditions, ensuring that authorized actions are allowed on the database. When an unauthorized or invalid query or update is attempted, the value contracts 118 can automatically reject the operation, ensuring data integrity and security across the system 100.

The value contracts 118 can also define complex logic for data consistency and access control rules for specific roles or users. For example, the value contracts 118 can implement permission validation that verifies whether a requesting entity has the appropriate authorization level before allowing database operations to proceed. This permission-based approach enables fine-grained control over database access while maintaining the decentralized nature of the system 100. The value contracts 118 communicate with the distributed ledger system 120 through bidirectional connections, enabling data exchange between these components during transaction processing. Further details and aspects of the value contracts 118 are discussed below.

Referring still to FIG. 1A, the distributed ledger system 120 maintains an immutable record of all transactions and changes made to the database. The distributed ledger system 120 can utilize a Self-Delegated Proof of Equal Stake (SDPoES) consensus mechanism (discussed in further detail below) to maintain consistency across geographically dispersed nodes in the DLS network 144 (FIG. 1B). Under the SDPoES consensus mechanism, nodes are rotated in a schedule to ensure that no single node is overburdened with transaction processing. This rotation approach helps distribute the workload evenly across the network, improving overall system performance and reliability.

The SDPoES consensus mechanism can require a majority consensus of two-thirds of seventeen nodes to validate and confirm each transaction. This consensus requirement ensures that updates to the distributed ledger system 120 are consistent and agreed upon by a large portion of the network before being recorded. Synchronization protocols across nodes ensure that even during high-transaction volumes, each node holds an identical and up-to-date version of the ledger. When a database update is confirmed through the consensus mechanism, the distributed ledger system 120 can record the change along with relevant metadata such as timestamps and user identity information, providing a transparent and auditable history of all database operations.

In some cases, the system 100 can include automation features for database deployment, backup, and version control while maintaining decentralization and user control. These automation capabilities can streamline database management processes by reducing manual intervention for routine tasks. The automation features can operate in conjunction with the value contracts 118 to ensure that automated operations adhere to the same permission and validation rules as user-initiated operations. This approach enables users to benefit from automated database management while preserving the security and integrity guarantees provided by the blockchain layer 116.

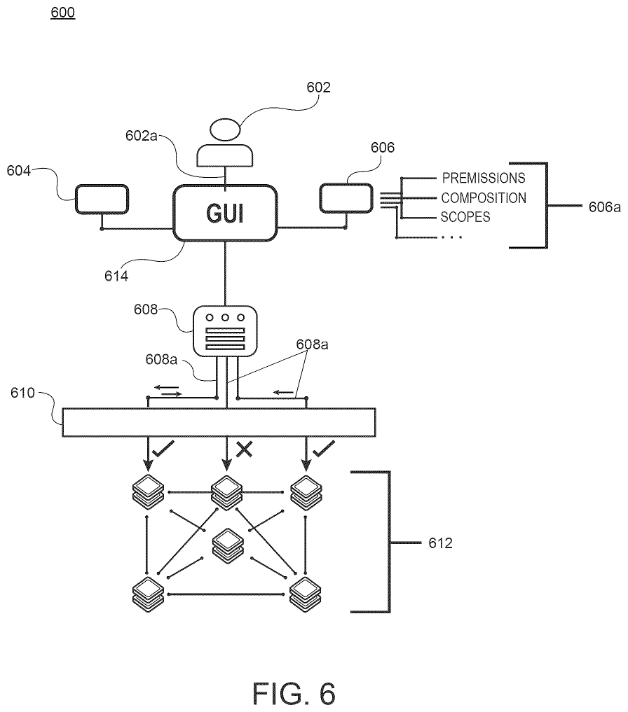

Referring now to FIG. 6, a diagram 600 of a decentralized database management system showing the interaction between a user 602 and various system components through an interactive GUI 614 is illustrated. The diagram 600 demonstrates the flow of data and communication pathways within the system architecture, providing a visual representation of how users can access monitoring and management capabilities through the graphical user interface described herein.

At the top of the diagram 600, the user 602 is represented as a figure icon. The user 602 connects to the interactive GUI 614, which serves as the primary interface for user interaction with the system. The interactive GUI 614 is depicted as a rectangular component positioned centrally in the upper portion of the diagram 600. Through the interactive GUI 614, the user 602 can access various tools and features for managing decentralized databases without requiring direct knowledge of the underlying blockchain technology.

With continued reference to FIG. 6, the interactive GUI 614 in this example can connect to an explorer lite plugin 604, shown on the left side of the diagram 600. The explorer lite plugin 604 provides monitoring and inspection capabilities for the system, enabling users to track node performance, block production, and transaction details in real-time. The explorer lite plugin 604 can allow the user 602 to view live metrics for database performance, node health, and blockchain transactions. Through the explorer lite plugin 604, users can also inspect individual transactions for auditing or troubleshooting purposes, providing visibility into the operations occurring within the distributed network.

Adjacent to the explorer lite plugin 604, a DB overview 606 is positioned on the right side of the diagram 600. The DB (database) overview 606 includes key elements 606a, which are displayed as a list containing items such as permissions, composition, scopes, and additional database management entries. The key elements 606a enable users to inspect and manage database components through the interactive GUI 614. The DB overview 606 provides a centralized view of database structures and configurations, allowing users to monitor and adjust database settings without navigating through complex command-line interfaces or blockchain-specific tools.

As further shown in FIG. 6, user information 602a is shown flowing from the user 602 toward the interactive GUI 614, indicating the transmission of user credentials or data into the system. The user information 602a can include authentication credentials, database queries, and configuration parameters, for example, that the user 602 provides through the interface. This data flow enables the interactive GUI 614 to process user requests and route the requests to appropriate system components for execution.

Below the interactive GUI 614, a proxy server 608 is positioned as an intermediary component. The proxy server 608 receives requests from the interactive GUI 614 and processes the requests for transmission to the distributed network infrastructure. The proxy server 608 can validate incoming requests, format the requests for blockchain interaction, and manage secure communication between the user interface and the network layer, as discussed above.

The proxy server 608 connects to an RPC API 610, which is shown as a horizontal bar or interface layer below the proxy server 608. The RPC API 610 facilitates communication between the proxy server 608 and a DLS network 612, translating requests into blockchain-compatible formats. The RPC API 610 provides predefined endpoints for database-specific functions, enabling standardized communication between the user interface components and the distributed ledger infrastructure.

The DLS network 612 is illustrated at the bottom of the diagram 600 as a collection of interconnected nodes arranged in a distributed configuration. The nodes within the DLS network 612 are represented as geometric shapes connected by lines, depicting the decentralized nature of the network infrastructure. The DLS network 612 forms the underlying blockchain infrastructure where transactions are validated, executed, and stored across multiple network nodes.

Directional arrows throughout the diagram 600 indicate the flow of data and requests between components. Communication pathways connect the interactive GUI 614 to both the explorer lite plugin 604 and the DB overview 606, enabling real-time data exchange between monitoring components and the user interface.

The interactive GUI 614 can provide visual tools for schema creation, data querying, and access control management. These visual tools enable users to design database schemas using, for example, drag-and-drop interfaces and construct complex queries using visual query builders. Through the DB overview 606, users can manage permissions and scopes for database access, configuring which entities can read, write, or modify specific data entries within the decentralized database.

The interactive GUI 614 can also include automation features for database deployment, backup, and version control. These automation capabilities streamline routine database management tasks while maintaining decentralization and user control. Users can configure automated backup schedules, deploy new database configurations, and manage version histories through the interface without requiring manual intervention for each operation. The automation features operate in conjunction with the value contracts 118 (FIG. 1A) to ensure that automated operations adhere to the same permission and validation rules as user-initiated operations.

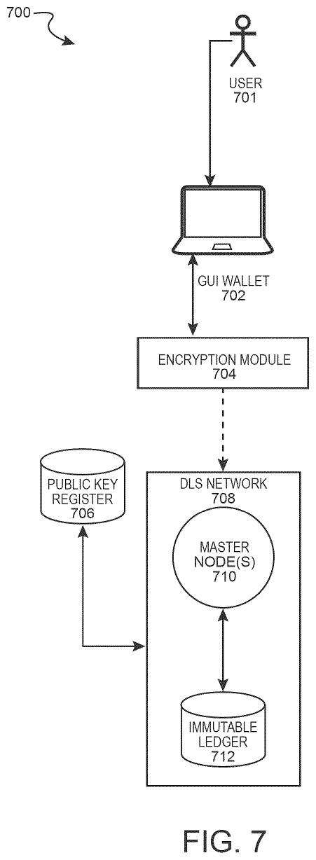

Referring now to FIG. 7, a system 700 for securing transactions within the decentralized database management system is illustrated. The system 700 demonstrates the flow of data from a user 701 through various security and validation components to the distributed ledger system 120 (FIG. 1A). The system 700 includes a GUI Wallet 702, an encryption module 704, a public key register 706, a DLS network 708, master node(s) 710, and an immutable ledger 712. These components work together to ensure secure transaction creation, encryption, and validation within the blockchain-based architecture.

As shown, the user 701 interacts with the GUI Wallet 702 via, for example, a computing device. The GUI Wallet 702 serves as the interface through which the user 701 can initiate transactions and manage interactions with the decentralized database system. The GUI Wallet 702 connects to the encryption module 704, shown as a rectangular box below the GUI Wallet 702. The encryption module 704 handles the cryptographic operations for securing transactions before transmission to the network.

With continued reference to FIG. 7, the system 700 can utilize Transport Layer Security (TLS) encryption protocols, for example, for end-to-end encryption between the GUI Wallet 702, nodes within the node layer 108 (FIG. 1A), and the blockchain layer 116 (FIG. 1A). These TLS protocols ensure that all data transmitted over the network is encrypted and protected from interception or tampering. When an encryption plugin is enabled, additional custom encryption can be applied at the application level, ensuring that sensitive data remains encrypted even within the blockchain and providing an extra layer of security.

The public key register 706 is shown on the left side of the system 700, and it can be configured to store public keys associated with users in the system. Public key information can flow from the public key register 706 to the DLS network 708 for validation purposes.

The DLS network 708 in this system includes multiple components, such as master node(s) 710 and an immutable ledger 712. The master node(s) 710 receive encrypted transactions from the encryption module 704, as indicated by a dashed line connection. The master node(s) 710 can also receive public key information from the public key register 706, which is in communication with the DLS network 708. In operation, the master node(s) 710 validate transactions by comparing the transactions against the stored public keys.

Below the master node(s) 710 within the DLS network 708, the immutable ledger 712 is shown. The immutable ledger 712 is in communication with the master node(s) 710 such that validated transactions can be recorded on the immutable ledger 712, and the master node(s) 710 can access the ledger 712 for verification purposes.

The system 700 can utilize a key plugin for secure key management. The key plugin securely stores keys for each permission, with the keys being encrypted and secured to prevent unauthorized access. Private keys can be stored locally and encrypted, adding a layer of protection against unauthorized access. The system 700 allows users to create multiple keys with different permissions, providing flexibility and continued access even if a single key is lost. This multi-key approach enables users to perform actions with other keys that were previously created if one key becomes unavailable.

To address private key loss scenarios, the system 700 can optionally provide a 12-word recovery phrase mechanism. This recovery phrase can allow users to regain access to their account in the event of private key loss. The 12-word recovery phrase can be used to restore account access without compromising security. However, after key loss, transactions cannot be initiated until access is restored through the recovery phrase. The recovery phrase mechanism ensures that users can restore their accounts while maintaining the security guarantees of the decentralized database management system.

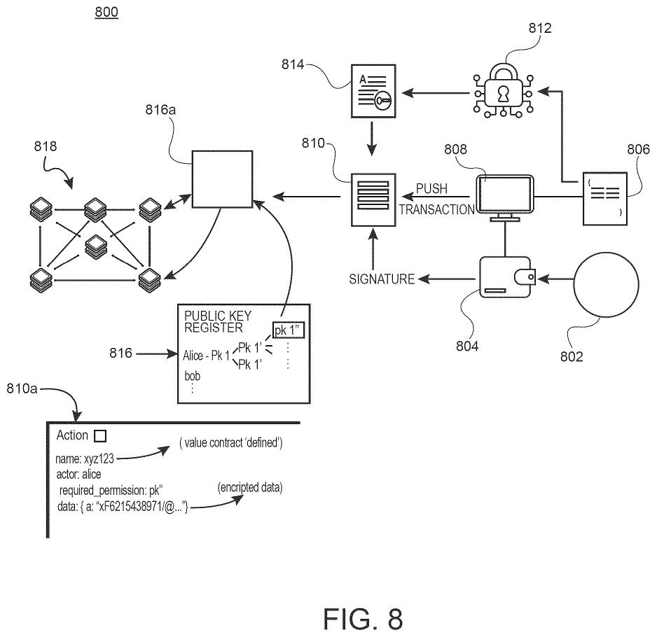

Turning now to FIG. 8, a transaction pathway 800 within the decentralized database management system is illustrated. The transaction pathway 800 shows the flow of data from a user through encryption and validation components to a distributed ledger system. The transaction pathway 800 demonstrates the process of secure transaction creation, signing, and validation within the blockchain-based architecture.

The transaction pathway 800 begins with a user private key 802, which can be imported into a user's GUI wallet 804, enabling the creation of signed transactions. The GUI wallet 804 can be access via the interactive GUI 808, which serves as the interface through which the user can initiate transactions and manage interactions with the decentralized database system.

With continued reference to FIG. 8, user data 806, such as information provided by the user (e.g., credentials, transaction details, etc.), can be submitted via the interactive GUI 808, processes the user data 806 and facilitates the creation of transactions 810. Transaction details 810a can include information associated with the transaction 810, such as an action component that itself contains details such as name, actor, required permissions, encrypted data, etc. Using the user private key 802, the interactive GUI 808 can be configured to create the transaction 810 including the user data 806, sign the transaction 810, and generate a user-specific signed transaction.

As further shown in FIG. 8, the transaction 810 can be processed through an AES 812 encryption module, for example. The AES 812 encryption module can perform cryptographic operations to secure the transaction data using Advanced Encryption Standard encryption. Following encryption, the data becomes ciphered text 814, thereby enduring that transaction contents remain protected during transmission across the network.

A public key register 816 is illustrated as a rectangular component containing public key information. The public key register 816 stores public keys associated with users in the system, including entries for users with their respective public key values. An arrow connects the public key register 816 to a validated signature 816a component, which represents a signature validation process. The validated signature 816a verifies the signed transaction against the public keys stored in the public key register 816.

The validated signature 816a connects to a DLS network 818. Upon successful validation, the transaction 810 can be applied to the DLS network 818. The DLS network 818 represents the decentralized infrastructure where transactions are validated and recorded. Arrows indicate the flow of information from the ciphered text 814 to the DLS network 818, and from the validated signature 816a to the DLS network 818, demonstrating the validation process where encrypted transactions are verified against stored public keys before being recorded in the distributed ledger.

The transaction pathway 800 ensures that every action performed within the interactive GUI 808 requires the user to authenticate with the user private key 802, ensuring that only the rightful user can perform sensitive actions. The combination of private key authentication, encrypted key storage through the GUI wallet 804, and signature validation through the public key register 816 provides a multi-layered security approach for protecting transactions within the decentralized database management system.

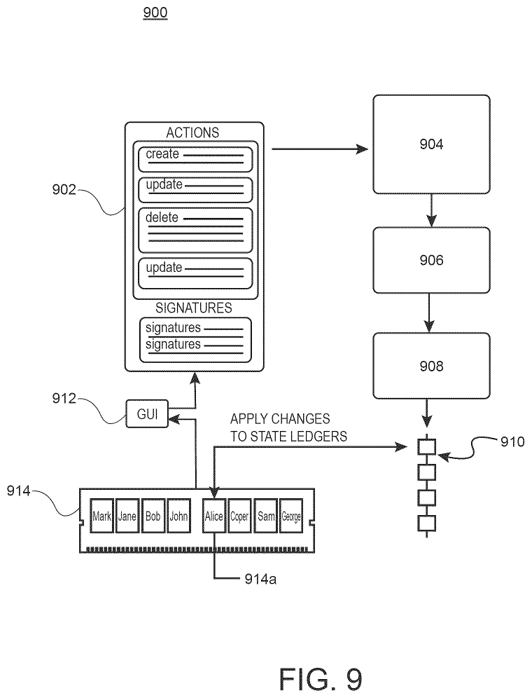

Referring now to FIG. 9, a transaction lifecycle 900 within the decentralized database management system is illustrated. The transaction lifecycle 900 demonstrates the flow of a transaction through various validation and storage stages, showing the process by which transactions are validated, compiled into blocks, and recorded in an immutable ledger. The transaction lifecycle 900 provides a comprehensive view of how database operations initiated through the user interface progress through the blockchain infrastructure to achieve permanent storage and state updates.

The transaction lifecycle 900 begins with a transaction 902. The transaction 902 can comprise any number of actions that can be automatically created, such as create, update, delete, custom-defined operations, and so on. These actions in the transaction 902 can represent database operations that users can initiate through an interactive GUI 912. To that end, the interactive GUI 912 can display transaction fields such as “actions” and “signatures,” with subsections including “create,” “update,” “delete,” and “custom,” into which a user can provide the requested transaction information. Once the necessary information is provided, the interactive GUI 912 can be used to initiate the transaction 902.

With continued reference to FIG. 9, following initiation through the interactive GUI 912, the transaction 902 proceeds to a transaction consensus validation 904 stage. During the transaction consensus validation 904 stage, the transaction 902 can be submitted to the DLS network 818 (FIG. 8), where master nodes validate the transaction according to the SDPoES consensus mechanism. As previously noted, the SDPoES consensus mechanism can ensure consistent validation across the distributed network by requiring a majority consensus of two-thirds of seventeen nodes to validate and confirm each transaction. This consensus requirement ensures that updates are consistent and agreed upon by a large portion of the network before proceeding to subsequent stages.

As explained in further detail below, under the SDPoES consensus mechanism, nodes are rotated in a schedule to ensure that ensure equity among nodes, while also ensuring that no single node is overburdened with transaction processing. This rotation approach distributes the workload evenly across the network, improving overall system performance and reliability. The use of synchronization protocols across nodes also ensures that even during high-transaction volumes, each node can hold an identical and up-to-date version of the ledger state. This synchronization enables the transaction consensus validation 904 stage to maintain consistency across geographically dispersed nodes in the network.

Following the transaction consensus validation 904 stage, the transaction lifecycle 900 proceeds to a block creation 906 stage. During the block creation 906 stage, validated transactions are compiled into blocks that can include one or more transactions along with metadata such as timestamps and cryptographic hashes linking the block to previous blocks in the chain.

Next, the transaction lifecycle 900 continues to a block validation 908 stage. During this stage 908, the newly created block undergoes verification by the master nodes 710 (FIG. 7) to ensure that all transactions within the block are valid and that the block structure conforms to the protocol requirements. The block validation 908 stage provides an additional layer of verification before the block is permanently recorded.

Following the block validation 908 stage, the transaction lifecycle 900 advances to an immutable ledger 910 stage, during which the validated block is recorded in the immutable ledger 712 (FIG. 7). That is, once the block is finalized in the immutable ledger 910 stage, the transactions contained within the block become permanently recorded on the immutable ledger 712 and cannot be altered or deleted, ensuring data integrity and providing a transparent audit trail of all database operations.

As further shown in FIG. 9, state databases 914 include multiple database instances labeled with names such as “John,” “Bob,” “Alice,” “Emma,” and “Sara.” A specific instance, a state DB (User A) 914a, is included within the state databases 914 and pertains to a particular user, namely, User A. Once a block is recorded in the immutable ledger, the block updates the user's (e.g., User A) state database with the new data. This state update mechanism ensures that each user's database reflects the current state of their data as recorded on the blockchain.

The state databases 914 maintain the current state of data for each user in the system. When transactions are finalized through the immutable ledger 910 stage, the corresponding changes are propagated to the appropriate state database of user A 914a and other user state databases within the state databases 914. This propagation ensures that users can access their current data state through the interactive GUI 912 without needing to traverse the entire transaction history stored in the immutable ledger.

Notably, the system 100 (FIG. 1A) described herein provides horizontal scalability by supporting the addition of more nodes as needed to distribute workloads and maintain performance as the network grows in size and user base. As additional nodes are added to the DLS network 818 (FIG. 8), the transaction consensus validation 904 stage can distribute validation tasks across the expanded node pool, enabling the system to handle increasing numbers of users, nodes, and transactions while maintaining performance. This horizontal scalability approach ensures that the decentralized database management system can accommodate growth without degradation in transaction processing speed or validation accuracy.

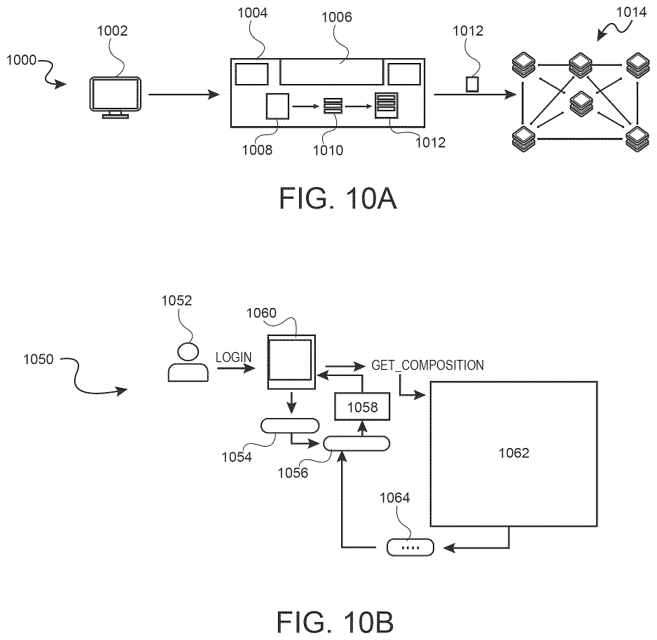

Referring now to FIG. 10A, a system 1000 for processing user requests in the decentralized database management system is illustrated. The system 1000 shows a data flow pathway and demonstrates how user requests can be processed and transformed into DLS transactions.

The data flow pathway can begin with a user submitting a user request 1008 to the system 1000 via an interactive GUI 1002. Once submitted, the user request 1008 flows from the interactive GUI 1002 to a proxy server 1004. The proxy server 1004 can include a value contract generator 1006, shown as a module within or in communication with the proxy server 1004. The value contract generator 1006 can create C++ value contract files when, for example, the user request 1008 involves managing database structures. These C++ value contract files can then be compiled into WASM and ABI files, as described above with reference to FIG. 3, and pushed to a DLS network 1014 for execution.

With continued reference to FIG. 10A, the proxy server 1004 performs a process request 1010 operation on the user request 1008, which can involve parsing and processing the user request 1008 to determine the appropriate handling pathway. For requests involving database structure management, the proxy server 1004 can utilize the value contract generator 1006 to create corresponding value contract files, as noted above. For other types of requests, such as those related to managing user data, the proxy server 1004 can process the data into actions and directly push these actions to the DLS network 1014 for execution without generating new value contracts.

Following the process request 1010 operation, a DLS transaction 1012 is generated and transmitted to the DLS network 1014. The DLS network 1014 is illustrated as a collection of interconnected nodes arranged in a distributed configuration, representing the decentralized infrastructure where transactions are executed and stored. The DLS transaction 1012 can include one or more actions corresponding to the user request 1008, such as create, update, delete, and/or custom-defined operations on the database, to name a few.

In some embodiments, the system 1000 can handle different types of requests through alternative processing pathways. For example, when the user request 1008 includes JSON body data for database structure modifications, the interactive GUI 1002 can be configured to parse and process the request before routing the request to the value contract generator 1006. The value contract generator 1006 can then create a corresponding C++ value contract file, which is compiled and deployed to the DLS network 1014. When the user request 1008 relates to data manipulation operations rather than structure modifications, for example, the proxy server 1004 can bypass the value contract generator 1006 and process the data directly into actions for immediate transmission to the DLS network 1014.

Turning now to FIG. 10B, a login service workflow 1050, which demonstrates an authentication process for verifying user credentials, is illustrated. This login service workflow 1050 can be implemented via the system 1000 shown in FIG. 10A. This workflow 1050 can commence with a user 1052 providing login credentials, such as an account name and PIN, via an interactive GUI 1060. The interactive GUI 1060 receives the login credentials and initiates the authentication process.

The workflow 1050 further includes a hash service 1054 that parses the login credentials provided by the user 1052 and hashes the provided PIN. In some cases, the hash service 1054 converts a plaintext PIN into a hashed representation using a cryptographic hash function. This hashing operation ensures that the actual PIN value is not transmitted or compared in plaintext form, providing protection against credential interception.

Following the hash service 1054, the login service workflow 1050 proceeds to a compare service 1056. The compare service 1056 receives the hashed PIN from the hash service 1054 and compares the hashed PIN with a stored PIN hash 1064 located in a DLS network 1062. The stored PIN hash 1064 resides within the user's database state in the DLS network 1062, specifically within the database composition's scope associated with the user 1052. The compare service 1056 retrieves the stored PIN hash 1064 from the DLS network 1062 and performs a comparison operation between the newly hashed PIN and the stored PIN hash 1064.

Following the comparison operation performed by the compare service 1056, the login service workflow 1050 proceeds to an access decision 1058. The access decision 1058 determines whether to grant or deny access based on the PIN comparison results. Upon a successful match between the hashed PIN from the hash service 1054 and the stored PIN hash 1064, the access decision 1058 can grant access to the user 1052. When the comparison fails, the access decision 1058 can deny access. Results of the grant or deny access decision can then be displayed via the interactive GUI 1060, providing feedback to the user 1052 regarding the authentication outcome.

The login service workflow 1050 serves as an example of a service architecture within the system 1000. Alternative authentication mechanisms can be implemented using similar service-based architectures. For instance, the system 1000 can support multi-factor authentication by incorporating additional verification services beyond the hash service 1054 and compare service 1056. The system 1000 can also support biometric authentication, token-based authentication, certificate-based authentication, and/or others through corresponding service modules that interface with the DLS network 1062 for credential verification.

The system 1000 can process different categories of user requests through configurable routing logic within the proxy server 1004. Database definition requests, such as creating tables or modifying schemas, can be routed through the value contract generator 1006 for compilation and deployment. Data manipulation requests, such as inserting, updating, or deleting records, can be processed directly into actions without value contract generation. Query requests for retrieving data can be handled through optimized query pathways that leverage caching and indexing capabilities of the blockchain API 122 (FIG. 1A). Administrative requests for managing permissions and access controls can be processed through the value contracts 118 (FIG. 1A) that govern access permissions within the decentralized database management system.

As discussed above, the decentralized database management system described herein integrates the GUI layer, node layer, and blockchain layer to provide a comprehensive solution for managing decentralized databases. This integration enables seamless user interaction while maintaining the security and transparency benefits of blockchain technology. The layered architecture abstracts blockchain complexities from end-users, allowing database administrators, developers, and end-users to perform database operations without requiring extensive knowledge of the underlying distributed ledger technology.

The GUI layer serves as the primary interface through which users interact with the decentralized database infrastructure. User actions initiated through the GUI layer are translated into backend commands by an input mapping module, which converts high-level user interactions into corresponding programming language instructions. A real-time monitoring module provides visibility into system performance, node status, and transaction details, enabling users to track database health and blockchain operations. An error handling module assists users in troubleshooting issues by categorizing errors under specific codes for precise identification and resolution.

The node layer functions as an intermediary between the GUI layer and the blockchain layer, facilitating efficient communication and data management. A proxy server within the node layer validates incoming requests, formats the requests for blockchain interaction, and manages secure communication between the user interface and the distributed network. A data buffer can temporarily hold data during operations to reduce latency and optimize performance, while a consensus interaction module interfaces with the blockchain layer for confirming transactions according to the consensus mechanism.

The blockchain layer forms the foundation for secure and transparent data management. Value contracts govern data storage, access permissions, and query execution by defining specific permissions and validation logic for database operations. The distributed ledger maintains an immutable record of all transactions and changes made to the database, providing a transparent and auditable history of database operations. The blockchain API provides access for querying, storing, and updating data across the decentralized network through predefined endpoints for database-specific functions.

The integration of these three layers provides advantages for decentralized database management. For example, enhanced security is achieved through local generation and storage of private keys, ensuring that users retain exclusive access to manage their data. The encryption module secures data transmitted through the system using protocols such as TLS, protecting communications from interception or tampering. Private key authentication ensures that every action performed within the GUI requires user authentication, preventing unauthorized access to sensitive database operations.

Improved data integrity results from blockchain integration, which ensures immutability of all transactions recorded on the distributed ledger. The SDPoES consensus mechanism maintains consistency across geographically dispersed nodes by requiring majority consensus to validate and confirm each transaction. Synchronization protocols across nodes ensure that each node holds an identical and up-to-date version of the ledger state, even during high-transaction volumes.

Streamlined database management processes are achieved through intuitive visual tools and automation features within the GUI layer. Users can design database schemas using drag-and-drop interfaces, for example, construct complex queries using visual query builders, and manage permissions and access controls through the database overview interface. Automation capabilities for database deployment, backup, and version control reduce manual intervention for routine tasks while maintaining decentralization and user control.

Real-time monitoring capabilities enable users to track database performance and blockchain transactions efficiently. The explorer lite plugin provides monitoring of node performance, block production, and transaction inspection, allowing users to view live metrics and inspect individual transactions for auditing or troubleshooting purposes. Customizable dashboards allow users to select specific metrics to monitor and set thresholds for alerts, enabling proactive management of the database.

Flexible error handling and customization options enable users to tailor the system to their specific needs. The error handling module can categorize errors under specific codes, providing clear identification of problems when transactions fail or invalid inputs occur. Users can customize their dashboards to focus on metrics relevant to their work and receive timely notifications when monitored values exceed or fall below defined thresholds.

Scalability inherent to decentralized systems enables the architecture to handle diverse workloads from small applications to enterprise-level databases. Horizontal scalability supports the addition of more nodes as needed, distributing workloads and maintaining performance as the network grows in size and user base. Dynamic node scheduling through the SDPoES consensus mechanism balances workloads by rotating nodes in production schedules, preventing overburdening of any single node. Load balancing distributes traffic and transaction requests evenly across nodes, preventing bottlenecks and single points of failure during high-demand periods. The temporary database stores pending actions during periods of extreme traffic or when nodes are unable to push data to the network, ensuring that transactions are eventually processed without data loss.

The combination of these integrated components and features lowers the barrier to entry for organizations seeking to adopt decentralized data management solutions. The system enables a wider range of users to harness the advantages of distributed data management while maintaining ease of use and operational efficiency. By abstracting blockchain complexity through the user-friendly GUI layer while preserving the security, transparency, and decentralization benefits of the underlying blockchain infrastructure, the system provides an accessible platform for managing decentralized databases securely and efficiently.

### Hybrid Relational and Non-Relational Database System

This section of the present disclosure relates to systems and methods for managing data in a hybrid relational and non-relational database integrated within a decentralized blockchain network. The hybrid database system combines strengths of both relational and non-relational database architectures within a decentralized framework to address limitations of traditional database systems.

Relational databases provide structured data storage and querying capabilities through SQL (structured query language), offering well-defined relationships between data entities. Non-relational or NoSQL databases provide greater flexibility and scalability for handling diverse data types and structures. The hybrid database system described herein integrates both relational and non-relational data models within a single platform, enabling users and organizations to manage complex, structured datasets alongside flexible, unstructured information.

This hybrid database system leverages blockchain technology to provide a decentralized architecture that distributes data across a network of nodes. The decentralized architecture provides enhanced data redundancy and resilience against single points of failure. The blockchain integration enables immutability of data records and transparency of data operations across the distributed network.

In addition, the hybrid database system described herein provides enhanced flexibility in data storage and retrieval by supporting both structured data with predefined schemas and flexible, schema-less data structures. This system dynamically adapts to the nature of the data being processed, providing storage and retrieval methods suited for each data type. As a result, users and organizations can leverage the strengths of both relational and non-relational paradigms within a unified platform.

Further, the hybrid database system provides scalability through a distributed node architecture that can expand to accommodate growing data volumes and network demands. To that end, the hybrid database system can cluster nodes into multiple sub-networks based on factors such as geographic location, workload, or data type. The clustering approach enables the system to handle increasing data volumes without overloading existing network resources.

The hybrid database system also provides security through blockchain-level permission management and consensus-based validation of data operations. The system enforces access controls through system value contracts (or simply, “value contracts”) that define which private keys or roles have access to database actions. The consensus mechanism discussed herein validates transactions across multiple nodes before data is committed to the distributed ledger, maintaining data integrity and consistency across the network.

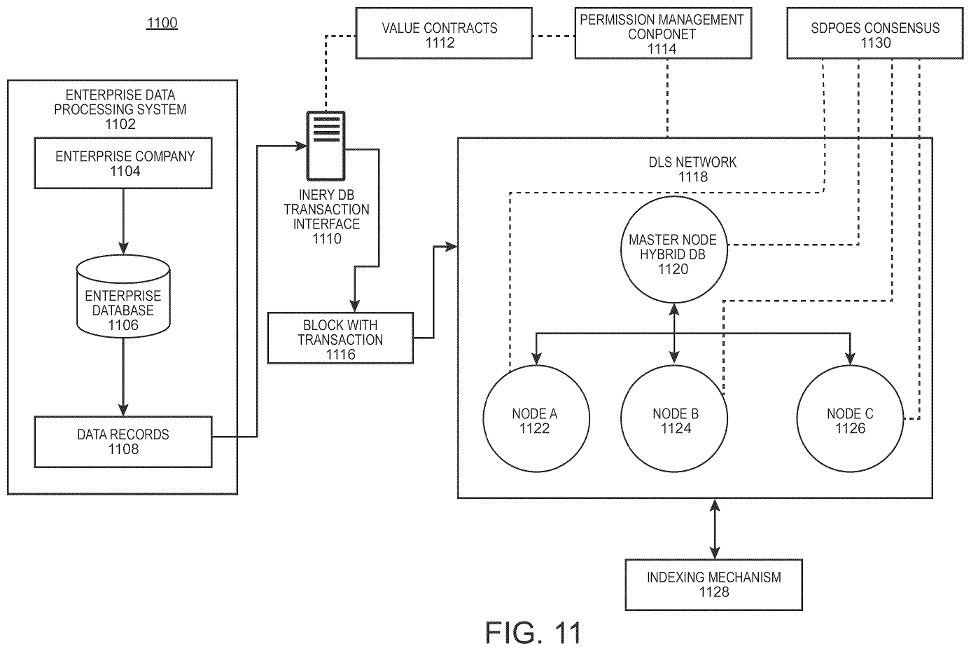

Referring now to FIG. 11, a system architecture 1100 for a hybrid database system according to this disclosure is shown. The system architecture 1100 illustrates integration of an Enterprise Data Processing System 1102 with a decentralized blockchain network to facilitate blockchain-based data management. The system architecture 1100 demonstrates how enterprise data flows from source systems through processing interfaces and into a distributed ledger system for storage, validation, and synchronization across multiple nodes.

The Enterprise Data Processing System 1102 can comprise an Enterprise Company 1104 that connects to an Enterprise Database 1106. The Enterprise Company 1104 can represent any organization or entity that generates and manages data within the hybrid database system. The Enterprise Database 1106 stores and manages Data Records 1108, which represent individual data entries within the enterprise system. The Data Records 1108 can include structured data with well-defined relationships, semi-structured data, or unstructured data depending on the data storage requirements of the Enterprise Company 1104.

With continued reference to FIG. 11, the Data Records 1108 flow from the Enterprise Database 1106 to a Hybrid DB Transaction Interface 1110. The Hybrid DB Transaction Interface 1110 serves as a bridge between the Enterprise Data Processing System 1102 and a DLS Network 1118. The Hybrid DB Transaction Interface 1110 receives data from the Data Records 1108 and processes the data for blockchain integration. In some cases, the Hybrid DB Transaction Interface 1110 can translate data requests into blockchain transactions that can be propagated through the network, validated by a consensus mechanism, and recorded on the distributed ledger.

Value Contracts 1112 connect to the Hybrid DB Transaction Interface 1110 and define database schemas and rules for data operations within the hybrid database system. The Value Contracts 1112 can function as predefined schemas that specify the structure, relationships, and validation rules for data stored in the database. In some cases, the Value Contracts 1112 can define table structures, column types, and relationships between entities for relational data. For non-relational data, the Value Contracts 1112 can provide flexible schema definitions while enforcing rules such as requiring specific metadata fields to be present in documents.

Also shown in FIG. 11 is a Permission Management Component 1114 that connects to the Value Contracts 1112 and establishes access controls for database operations at the blockchain level. The Permission Management Component 1114 can define which private keys or roles have access to specific actions within the database. In some cases, the Permission Management Component 1114 can support hierarchical permission structures with different levels of access for various roles. The Permission Management Component 1114 can also support dynamic permissions based on specific conditions such as time constraints or network state.

The Hybrid DB Transaction Interface 1110 can be configured to package data into a Block with Transaction 1116. The Block with Transaction 1116 represents the formatted data structure that can be recorded on the blockchain. The Block with Transaction 1116 flows from the Hybrid DB Transaction Interface 1110 into the DLS Network 1118 for distribution and storage across the decentralized network.

With continued reference to FIG. 11, the DLS Network 1118 comprises a distributed architecture with multiple nodes for data storage and validation. The DLS Network 1118 includes a Master Node Hybrid DB 1120, which serves as a coordination point within the network. The Master Node Hybrid DB 1120 represents a hybrid database structure that supports both relational and non-relational data models. The Master Node Hybrid DB 1120 can connect bidirectionally to nodes such as Node A 1122, Node B 1124, and Node C 1126, forming a distributed node structure within the DLS Network 1118.

Node A 1122, Node B 1124, and Node C 1126 are shown positioned within the DLS Network 1118 and maintain synchronized copies of the blockchain data. In some cases, each node in the DLS Network 1118 can maintain a full copy of the ledger, contributing to system redundancy and fault tolerance. The decentralized nature of the DLS Network 1118 ensures that there is no single point of failure, enhancing overall reliability and availability of the database system.

As further shown in FIG. 11, an Indexing Mechanism 1128 connects to the DLS Network 1118 through a bidirectional connection. The Indexing Mechanism 1128 creates and maintains indexes for optimizing data retrieval operations across the distributed nodes. In some cases, the Indexing Mechanism 1128 can automatically generate indexes based on predefined rules and data usage patterns, as discussed in further detail below. The Indexing Mechanism 1128 can also support user-defined indexes that allow users to manually define and add custom indexes for specific records.

An SDPoES Consensus Mechanism 1130 component connects to the DLS Network 1118 and validates and synchronizes database operations across the plurality of nodes within the network. The SDPoES Consensus Mechanism 1130 represents a novel self-selegated proof of equal stake consensus mechanism that ensures integrity and consistency of data across all nodes in the network. In some cases, the SDPoES Consensus Mechanism 1130 can require nodes in an active schedule to validate blocks by reaching a consensus before any data is committed, ensuring consistency across all nodes. The SDPoES Consensus Mechanism 1130 allows for validation of transactions and maintains security of the distributed ledger. The SDPoES Consensus Mechanism 1130 is discussed in further detail below.

As noted above, the Value Contracts 1112 enforce schema rules and maintain data integrity within the hybrid database system. The Value Contracts 1112 comprise predefined schemas that define the structure, relationships, and validation rules for data stored in the database. The Value Contracts 1112 play a role in ensuring consistency and reliability of data across both relational and non-relational models within the hybrid database system.

In the context of relational data, the Value Contracts 1112 can define table structures, column types, and relationships between entities. For example, a value contract for a customer database can specify that each customer record includes a unique identifier, a name field limited to a predetermined number of characters, and a valid email address. The value contract can also define foreign key relationships between customer records and associated orders, ensuring referential integrity across related data entities.

For non-relational data, the Value Contracts 1112 can provide flexible schema definitions while enforcing rules for data consistency. In some cases, a value contract for document-based storage can allow for varying field structures but require specific metadata fields to be present in all documents. For instance, a contract for storing IoT (Internet of Things) sensor data can mandate that each document includes a timestamp and device identifier, while allowing for flexible additional fields based on the sensor type. This approach accommodates the dynamic nature of non-relational data while maintaining baseline data quality standards.

When data is submitted to the hybrid database system, the system can automatically validate the incoming information against the rules defined in the relevant value contract. In some cases, if the submitted data violates the schema or validation rules, the hybrid database system can reject the transaction. This enforcement helps maintain the integrity and consistency of the database by preventing the introduction of invalid or corrupted data into the distributed ledger.

The Value Contracts 1112 can also define complex validation rules beyond simple data types and structures. In some cases, these contracts can include custom logic to enforce business rules or data dependencies. For example, a value contract for a financial transaction system can include rules to ensure that account balances do not fall below zero or that certain types of transactions are permitted during specific time windows. These complex validation rules enable the hybrid database system to enforce domain-specific constraints at the database level.

The use of the Value Contracts 1112 in the hybrid database system provides several benefits for data management. First, the Value Contracts 1112 support data integrity by enforcing schema rules that help maintain the consistency and reliability of data across the database system. Second, the Value Contracts 1112 provide flexibility by accommodating both rigid relational structures and flexible non-relational data models, allowing the hybrid database system to adapt to diverse data storage requirements. Third, the Value Contracts 1112 enable error prevention through automatic validation that catches and prevents data errors at the point of entry, reducing the need for data cleanup or correction processes. Fourth, the Value Contracts 1112 simplify application logic by handling data validation at the database level, allowing application developers to focus on business logic rather than implementing extensive data validation routines in application code. Fifth, the Value Contracts 1112 provide centralized rule management by offering a centralized location for defining and managing data rules, making it easier to update and maintain data integrity policies across the system.

In some cases, the hybrid database system can provide mechanisms for updating or evolving the Value Contracts 1112 over time to accommodate changing data requirements. These updates can be subject to governance processes to ensure that changes do not compromise existing data or system integrity. By leveraging the Value Contracts 1112 for schema enforcement, the hybrid database system offers a foundation for managing complex data structures in a hybrid relational and non-relational environment, ensuring data integrity and consistency across diverse applications and use cases.

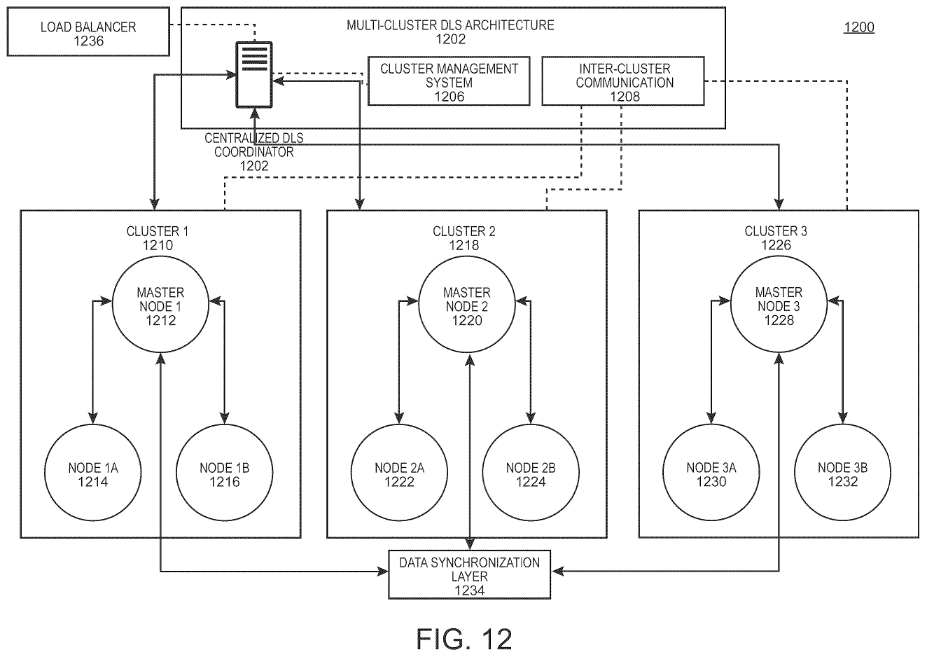

Referring now to FIG. 12, a system 1200 for managing decentralized database operations across multiple clusters is shown. The system 1200 comprises a Multi-Cluster DLS Architecture 1202 that facilitates distributed data management and coordination across a plurality of clusters. The Multi-Cluster DLS Architecture 1202 enables the hybrid database system to scale as data volume grows beyond what a single DLS Network 1118 can manage by organizing nodes into multiple sub-networks or clusters based on factors such as geographic location, workload, or data type.

The Multi-Cluster DLS Architecture 1202 includes a Centralized DLS Coordinator 1204. The Centralized DLS Coordinator 1204 serves as a coordination layer that oversees and coordinates operations between clusters to ensure consistent data integrity and inter-cluster communication. In some cases, the Centralized DLS Coordinator 1204 can facilitate seamless data sharing and query execution across clusters, ensure global consistency by synchronizing ledger updates across all clusters, and monitor cluster performance to redistribute workloads or data for improved efficiency.

With continued reference to FIG. 12, the Centralized DLS Coordinator 1204 can connect to a Cluster Management System 1206 and an Inter-Cluster Communication 1208 component through bidirectional connections. The Cluster Management System 1206 can be configured to manage operational aspects of the clusters within the Multi-Cluster DLS Architecture 1202. In some cases, the Cluster Management System 1206 can monitor workloads and evaluate data volume, query patterns, and node performance to determine when clustering is required. The Cluster Management System 1206 can also be configured to facilitate dynamic cluster formation, enabling new clusters to be created on-demand as the system adapts to growth.

The Inter-Cluster Communication 1208 can be configured to facilitate data exchange and coordination between different clusters within the Multi-Cluster DLS Architecture 1202. In some cases, the Inter-Cluster Communication 1208 can enable communication pathways between clusters to support distributed query execution and data synchronization. The Inter-Cluster Communication 1208 connects to multiple clusters through communication pathways, enabling coordination between clusters for operations that span multiple sub-networks.

The system 1200 also includes a Load Balancer 1236 connected to the Centralized DLS Coordinator 1204 through a bidirectional connection. The Load Balancer 1236 can distribute incoming requests across the cluster infrastructure to optimize system performance. In some cases, the Load Balancer 1236 can connect to individual clusters to distribute workloads based on current cluster capacity and performance metrics. The Load Balancer 1236 helps ensure that no single cluster becomes overloaded while other clusters remain underutilized.

The system 1200 can also include a Cluster 1 1210 that comprises a Master Node 1212. The Master Node 1212 connects bidirectionally to one or more nodes, such as Node 1A 1214 and Node 1B 1216, forming a distributed node structure within Cluster 1 1210. The Centralized DLS Coordinator 1204 can connect to Cluster 1 1210 through a connection to the Master Node 1212. In some cases, each cluster can function as an independent network with its own subset of the ledger and consensus mechanism.

With continued reference to FIG. 12, a second cluster—Cluster 2 1218—is shown comprising a respective Master Node 1220 connected bidirectionally to Node 2A 1222 and Node 2B 1224, forming another distributed node structure within the Cluster 2 1218. The Centralized DLS Coordinator 1204 can connect to the Cluster 2 1218 through a connection to its Master Node 1220. The structure of Cluster 2 1218 mirrors that of Cluster 1 1210, with Master Node 1220 coordinating operations among Node 2A 1222 and Node 2B 1224.

A third cluster—Cluster 3 1226—is included in this system 1200. As shown, Cluster 3 1226 comprises a Master Node 1228 connected bidirectionally to Node 3A 1230 and Node 3B 1232, forming a distributed node structure within Cluster 3 1226. The Inter-Cluster Communication 1208 can connect to the Cluster 3 1226 through a connection extending from the top of the architecture. Cluster 3 1226 operates in a manner similar to Cluster 1 1210 and Cluster 2 1218, with its Master Node 1228 serving as the coordination point for Node 3A 1230 and Node 3B 1232.

As further shown in FIG. 12, a Data Synchronization Layer 1234 is positioned to connect to all three clusters through bidirectional connections. The Data Synchronization Layer 1234 receives connections from Cluster 1 1210, Cluster 2 1218, and Cluster 3 1226, maintaining synchronized data states across the distributed cluster architecture. In some cases, the Data Synchronization Layer 1234 can ensure that updates to the ledger are synchronized across all clusters, maintaining a single source of truth for the distributed database system.

The clustering approach within the Multi-Cluster DLS Architecture 1202 provides several benefits for scalability and performance. For example, clustering improves performance by isolating workloads within clusters, reducing the query and processing burden on individual nodes and networks. In addition, clustering enables data localization by storing and processing data closer to where the data is needed, which reduces latency. Further still, clustering supports scalability by allowing additional clusters to be created as data volume increases without overloading existing clusters.

The system 1200 demonstrates a hierarchical organization of distributed ledger nodes across multiple clusters, with the Centralized DLS Coordinator 1204 overseeing cluster operations, the Inter-Cluster Communication 1208 facilitating data exchange between clusters, and the Data Synchronization Layer 1234 ensuring consistency across all nodes in the distributed architecture. This multi-cluster approach enables the hybrid database system to handle increasing data volumes and network demands while maintaining data integrity and system performance.

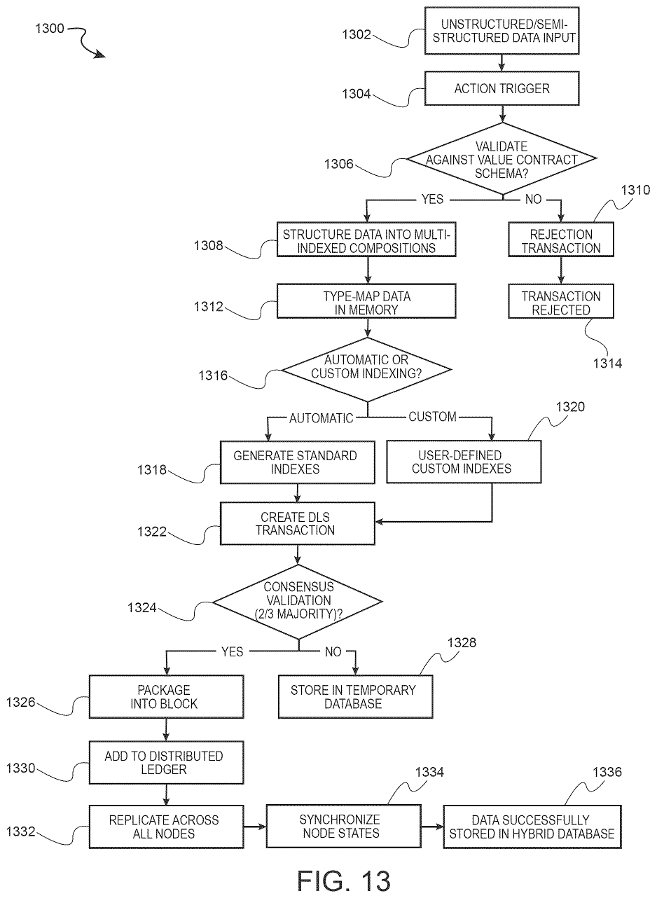

Referring now to FIG. 13, a method 1300 for processing unstructured and semi-structured data in the hybrid database system is shown. The method 1300 illustrates the sequential operations for receiving, validating, structuring, and storing data within the decentralized blockchain network. The method 1300 demonstrates how the hybrid database system transforms diverse data types into structured compositions suitable for distributed ledger storage.

The method 1300 begins with step 1302, where unstructured and semi-structured data input is received. The unstructured and semi-structured data input can include data that does not conform to a predefined schema or data that has partial structure such as JSON documents, log files, or IoT sensor readings. Step 1302 serves as the entry point for data into the hybrid database system.

Following step 1302, the method 1300 proceeds to step 1304, which involves an action trigger that initiates the data processing sequence. Step 1304 activates the value contract processing logic to handle the incoming data. In some cases, the action trigger at step 1304 can invoke specific operations defined within the Value Contracts 1112 (FIG. 11) to process input parameters of the unstructured and semi-structured data.

Next, the method 1300 continues to step 1306, which presents a decision point to validate the incoming data against a value contract schema. At step 1306, the system evaluates whether the submitted data conforms to the rules and structure defined in the relevant value contract. The validation at step 1306 can check data types, required fields, relationships, and any custom validation logic specified in the value contract.

If the validation at step 1306 is successful, the method 1300 proceeds to step 1308, where the data is structured into multi-indexed compositions. At step 1308, the system transforms the unstructured and semi-structured data into a NoSQL format with defined indexes that support query operations. The structuring at step 1308 organizes the data into compositions that can support up to sixteen different indexes (or more) for query operations.

If the validation at step 1306 fails, the method 1300 moves to step 1310, where the transaction is rejected. Step 1310 handles data that violates the schema or validation rules defined in the value contract. Following step 1310, the method 1300 proceeds to step 1314, where the transaction rejection is finalized. Step 1314 completes the rejection process and can return an error indication to the requesting entity.

Following successful structuring at step 1308, the method 1300 advances to step 1312, where the data is type-mapped in memory. At step 1312, the structured data is organized in memory with type information that ensures efficient access and processing. The type-mapping at step 1312 enables fast retrieval and manipulation of the data during subsequent operations.

Method 1300 then reaches step 1316, which presents a decision point for automatic or custom indexing. At step 1316, the system determines whether to generate indexes automatically based on predefined rules or to apply user-defined custom indexes. The decision at step 1316 can be based on configuration settings, value contract specifications, or data usage patterns.

If automatic indexing is selected at step 1316, the method 1300 proceeds to step 1318, where standard indexes are generated. At step 1318, the Indexing Mechanism 1128 automatically creates indexes such as timestamps (e.g., created_at and updated_at) and primary key identifiers. The automatic index generation at step 1318 ensures that basic query operations can be performed without manual intervention.

If custom indexing is selected at step 1316, the method 1300 moves to step 1320, where user-defined custom indexes are created. At step 1320, users can manually define and add custom indexes for specific records, transforming selected fields into searchable indexes. The custom indexing at step 1320 allows users to tailor the database structure to their specific requirements and optimize query performance for particular use cases.

Both indexing paths 1318, 1320 converge at step 1322, where a DLS transaction is created. At step 1322, the system packages the structured and indexed data into a transaction format suitable for the distributed ledger system. The DLS transaction created at step 1322 contains the data along with associated metadata and index information.

The method 1300 then proceeds to step 1324, which presents a consensus validation decision point. At step 1324, the SDPoES Consensus Mechanism 1130 validates the transaction across multiple nodes in the network. In some cases, the consensus validation at step 1324 can require a two-thirds majority of nodes in an active schedule to validate the transaction before the data is committed.

If consensus validation is achieved at step 1324, the method 1300 continues to step 1326, where the transaction is packaged into a block. At step 1326, the validated transaction is formatted into a Block with Transaction 1116 structure (FIG. 11) that can be added to the distributed ledger. The block packaging at step 1326 prepares the data for permanent storage on the blockchain.

If consensus validation fails at step 1324, the method 1300 moves to step 1328, where the data can be stored in a temporary database. Step 1328 handles situations where a node experiences high traffic or cannot immediately push data to the network. The temporary database at step 1328 can store pending actions until conditions stabilize and the data can be pushed to the blockchain, ensuring no data is lost during network congestion or node unavailability.

Following successful block packaging at step 1326, the method 1300 proceeds to step 1330, where the block is added to the distributed ledger. At step 1330, the Block with Transaction 1116 (FIG. 11) is recorded as an immutable entry in the DLS Network 1118 (FIG. 11). The ledger addition at step 1330 creates a permanent record of the data that cannot be altered or deleted.

The method 1300 then continues to step 1332, where the data is replicated across all nodes in the network. With reference again to FIG. 11, step 1332 could involve distributing the newly added block, for example, to Node A 1122, Node B 1124, Node C 1126, and other nodes within the DLS Network 1118. The replication at step 1332 ensures redundancy and fault tolerance by maintaining multiple copies of the data across the distributed network.

Returning to FIG. 13, the method 1300 subsequently advances to step 1334, where node states are synchronized across the distributed system. At step 1334, nodes synchronize their states during each production cycle to ensure consistency. In some cases, if discrepancies arise during step 1334, nodes can perform automated recovery by comparing their state with the confirmed ledger on the blockchain.

The method 1300 concludes with step 1336, where the data is successfully stored in the hybrid database. Step 1336 represents the completion of the data processing workflow, with the unstructured and semi-structured data now transformed into structured, indexed, validated, and distributed data within the hybrid database system.

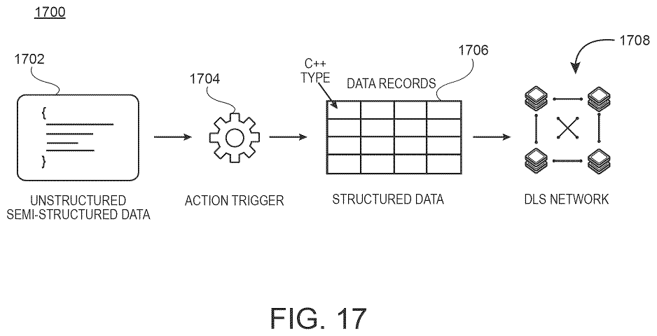

Referring now to FIG. 17, a data flow diagram 1700 illustrates the transformation of data through the hybrid database system. The data flow diagram 1700 demonstrates the sequential processing stages from initial data input through final storage in the distributed ledger network.

The data flow diagram 1700 begins with unstructured and semi-structured data 1702, which represents the initial data input to the system. The unstructured and semi-structured data 1702 can include documents, log files, sensor readings, or other data that does not conform to a rigid schema. The unstructured and semi-structured data 1702 flows into the processing pipeline for transformation and storage.

The unstructured and semi-structured data 1702 flows through a value contract action trigger 1704. The value contract action trigger 1704 processes the incoming data by structuring the data into multi-indexed compositions according to predefined rules and schemas defined in a value contract, such as the Value Contracts 1112 discussed above with reference to FIG. 11. The value contract action trigger 1704 validates the data against schema rules and transforms the data into a format suitable for distributed storage.

Following processing by the value contract action trigger 1704, the data becomes structured data 1706. The structured data 1706 represents the transformed data organized into records with defined fields and indexes. The structured data 1706 is type-mapped in memory, ensuring efficient organization and fast access during query operations.

The structured data 1706 then flows into a DLS network 1708 for distributed storage. The DLS network 1708 represents the distributed ledger system where the structured data 1706 is stored and replicated across multiple nodes. Each node in the DLS network 1708 can maintain a synchronized copy of the data, enabling consistency, redundancy, and data integrity across the network. The data flow diagram 1700 demonstrates how the hybrid database system transforms diverse data types into structured, distributed data suitable for blockchain-based storage and retrieval.

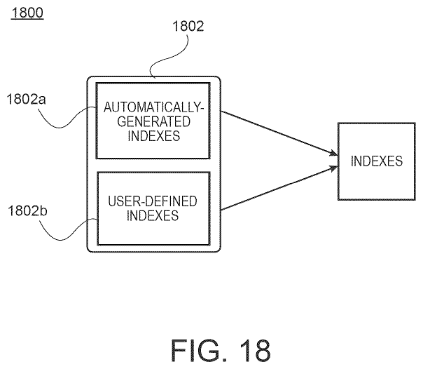

Referring now to FIG. 18, an indexing process diagram 1800 for the hybrid database system is shown. The indexing process diagram 1800 demonstrates how indexes are created and managed through an interactive GUI 1802 to optimize data retrieval operations within the distributed database environment. The indexing process diagram 1800 illustrates the dual approach to index management that combines automated index generation with user-defined customization capabilities.

The interactive GUI 1802 can provide two distinct options for index management. An upper section of the interactive GUI 1802 contains functionality for automatically-generated indexes 1802a, which are created by the system without manual intervention. As noted above, the automatically-generated indexes 1802a can include standard indexes such as, for example, timestamps (e.g., created\_at and updated\_at) and primary key identifiers (e.g., type uint64\_t). The automatic creation of the automatically-generated indexes 1802a ensures that basic query operations can be performed without requiring manual configuration by users or administrators.

A lower section of the interactive GUI 1802 contains functionality for user-defined indexes 1802b, which allow users to manually define and add custom indexes for specific records. The user-defined indexes 1802b enable users to transform selected fields into searchable indexes, tailoring the database structure to their specific requirements. In some cases, users can leverage the user-defined indexes 1802b to optimize query performance for particular use cases that are not addressed by the automatically-generated indexes 1802a.

Both the automatically-generated indexes 1802a and the user-defined indexes 1802b can flow from the interactive GUI 1802 to a repository 1804, for example, where both automatically-generated and user-defined indexes can be stored and maintained for optimizing query performance within the hybrid database system. This repository 1804 can support query operations across both relational and non-relational data models within the hybrid database.

The decision-making process for automatic index creation in the hybrid database system can be based, for example, on predefined rules and real-time analysis of data usage patterns. In some cases, these rules can be defined in the Value Contracts 1112 (FIG. 11), which serve as blueprints for database schemas and dictate how actions are performed. During execution of WebAssembly (WASM) code, for example, additional indexes can be dynamically created in the ledger state to support specific operations, ensuring the hybrid database adapts to the needs of its workload.

The hybrid database system discussed herein supports various indexing methods to optimize retrieval performance in distributed environments. In some cases, these methods can include hash-based indexing, tree-based indexing, multi-dimensional indexing, and others. Hash-based indexing can provide constant-time lookups for exact match queries by mapping data values to specific storage locations (or buckets). Tree-based indexing can enable efficient traversal for range queries by organizing data in hierarchical structures that support ordered access. Multi-dimensional indexing can handle queries involving multiple attributes or spatial data by organizing data across multiple dimensions simultaneously. These indexing techniques can be tailored to handle large-scale, decentralized datasets and enable fast lookups, range queries, and filtering operations across the DLS Network 1118 (FIG. 11).

The Indexing Mechanism 1128 discussed in FIG. 11 can utilize lower and upper bounds for each index to enhance query efficiency for large datasets. The lower and upper bounds can define the starting and ending points of a query, enabling the system to retrieve a subset of the dataset at a time. In some cases, the bounded indexing approach can minimize resource consumption and network load by focusing on a specific range instead of scanning the entire dataset. For example, in a dataset of transactions, a query can use an index with a lower bound of TransactionID greater than 1000 and an upper bound of TransactionID less than or equal to 2000 to fetch transactions in that range without unnecessary overhead.

The bounded indexing approach can be particularly useful for pagination and dataset traversal operations. In some cases, the use of LIMIT clauses in queries can ensure that a manageable number of results are retrieved per request, reducing the computational and memory burden on nodes within a DLS network (e.g., DLS Network 1118). For instance, a query for the first 100 records in a dataset can retrieve Index[0:100] using bounds, while subsequent pages fetch Index[101:200], and so on. This pagination approach enables efficient navigation through large datasets without requiring retrieval of all records simultaneously.

In some cases, the hybrid database system can support up to 16 different indexes per composition for optimized query operations. In some cases, these indexes can facilitate operations such as querying by range and querying by limit. The ability to define multiple indexes per composition can provide precise control over data retrieval and enable efficient execution of complex queries across the distributed network. Each composition can be configured with a combination of the automatically-generated indexes 1802a and the user-defined indexes 1802b to address specific query requirements.

The interactive GUI 1802 can function as a GUI for a decentralized database management system (DDBMS) that allows manual composition and index creation. As noted above, the interactive GUI 1802 can offer users the ability to define custom actions for complex retrieval scenarios. These custom actions can allow users to define advanced query logic, enabling the retrieval of specific datasets based on nuanced conditions or patterns. The DDBMS GUI capabilities of the interactive GUI 1802 can streamline database optimization and enhance query performance by providing a visual interface for index configuration and management.

The hybrid database system can also include an AI Composer for automated index management and optimization. In some cases, the AI Composer can analyze query patterns, data distribution, and usage trends to recommend index compositions for specific use cases. The AI Composer can enhance the indexing process by suggesting optimized actions and indexes based on historical queries and workload patterns. By combining automatic index generation through the automatically-generated indexes 1802a, user-defined indexing capabilities through the user-defined indexes 1802b, and AI-driven optimization through the AI Composer, the Indexing Mechanism 1128 (FIG. 11) can provide a foundation for efficient data retrieval and query performance in the hybrid, decentralized database system.

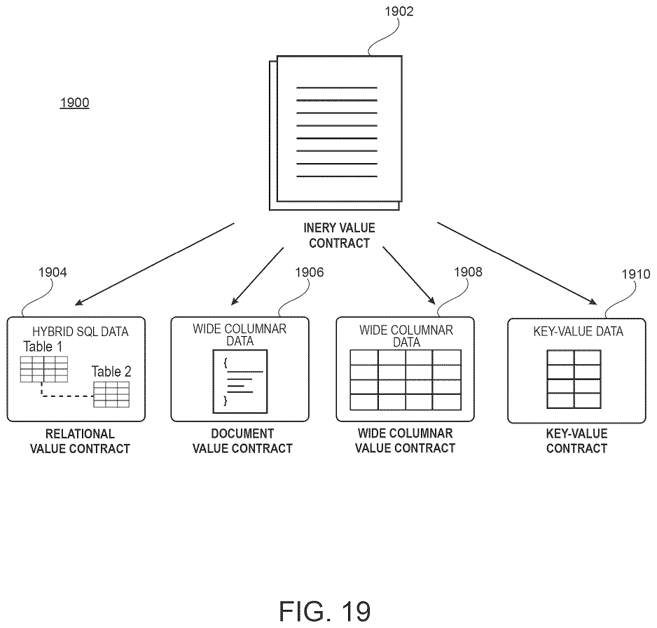

Referring now to FIG. 19, an exemplary hybrid database model 1900 is shown to demonstrate the capability of the hybrid database system to simultaneously handle multiple database paradigms. The hybrid database model 1900 illustrates how the system supports both relational and non-relational data models within a unified framework, enabling users to leverage the strengths of different database architectures based on their specific data storage and retrieval requirements.

The hybrid database model 1900 comprises a value contract 1902 positioned at the top of the architecture. The value contract 1902 serves as the foundational schema definition component for the database system, functioning similarly to the Value Contracts 1112 discussed above with reference to FIG. 11. The value contract 1902 defines schemas, validation rules, and operational logic that govern how data is stored, accessed, and manipulated across different database paradigms within the hybrid database system.

The value contract 1902 connects to four distinct database contract types through directional connections extending from the value contract 1902. These four database contract types represent different data storage and organization paradigms that can be implemented within the hybrid database system. Each contract type addresses specific data storage requirements and query patterns, enabling the system to accommodate diverse application needs within a single platform.

A relational value contract 1904 represents structured data storage with defined relationships between data entities. The relational value contract 1904 can organize data in tables with predefined schemas, enforcing relationships between entities through the value contract 1902. In some cases, the relational value contract 1904 can define table structures, column types, and foreign key relationships that ensure referential integrity across related data entities. The relational value contract 1904 can support traditional SQL-like queries, allowing for complex joins, filters, and aggregations on structured datasets. This approach can be suitable for systems where data structure and relationships are well-defined, such as inventory systems, financial records, or customer management systems.

With continued reference to FIG. 19, a document value contract 1906 can represent document-based storage structures. The document value contract 1906 can store data in a flexible, schema-less format that accommodates varying field structures within documents. In some cases, the document value contract 1906 can allow for nested data structures and dynamic field additions without requiring schema modifications. The document value contract 1906 can be suitable for use cases involving semi-structured data such as JSON documents, user-generated content, or configuration data where the structure can vary between records.

A wide columnar value contract 1908 can represent wide columnar database structures. The wide columnar value contract 1908 can organize data in a columnar format optimized for analytical queries and large-scale data processing. In some cases, the wide columnar value contract 1908 can store data across multiple columns and rows in a grid pattern that enables efficient retrieval of specific columns across large datasets. The wide columnar value contract 1908 can be suitable for applications involving time-series data, analytics workloads, or scenarios where queries frequently access specific columns rather than entire rows.

A key-value contract 1910 can represent key-value storage structures. The key-value contract 1910 can store data as key-value pairs for efficient lookup operations based on unique identifiers. In some cases, the key-value contract 1910 can provide constant-time access to data when the key is known, making the key-value contract 1910 suitable for caching, session management, or scenarios requiring fast retrieval of individual records by identifier.

The hybrid database model 1900 demonstrates the flexibility of the hybrid database system in supporting NoSQL structures including document-based, key-value, and wide-columnar formats alongside relational structures. The value contract 1902 serves as the central governance mechanism that defines schemas, validation rules, and operational logic for each of the connected database contract types. In some cases, the value contract 1902 can implement a hybrid SQL approach where indexes are utilized as primary and foreign keys directly within the action logic of the value contract 1902.

The transition between relational and non-relational functionality in the hybrid database system can be seamless based on the nature of the data being stored or queried. In some cases, the system can provide a unified interface, such as a unified API, for interacting with both relational and non-relational data. Whether the data is structured or unstructured, users can access and manipulate the data using the same set of tools and interfaces. The value contract 1902 can define how data is handled, specifying validation rules, permissions, and actions for both relational and non-relational data within the hybrid database model 1900.

Query processing in the hybrid database system can adapt based on the data model being accessed. For relational queries through the relational value contract 1904, the system can leverage traditional indexing and query optimization techniques to execute structured queries with schema enforcement. For non-relational queries through the document value contract 1906, the wide columnar value contract 1908, or the key-value contract 1910, the system can utilize specialized indexing methods optimized for object lookups, columnar access, or hierarchical data traversal. The Indexing Mechanism 1128 discussed above (FIG. 11), for example, can support both relational and non-relational query patterns through the various indexing methods discussed above.

The hybrid database model 1900 enables practical applications across various domains by supporting multiple data paradigms simultaneously. For enterprise solutions, the hybrid database system can manage structured transactional data through the relational value contract 1904 alongside unstructured analytics data through the document value contract 1906 or the wide columnar value contract 1908 within a single system. For IoT data management scenarios, the hybrid database system can handle diverse data types from connected devices using the key-value contract 1910 for fast sensor readings and the document value contract 1906 for flexible metadata storage within the decentralized framework.

As a further illustration, healthcare records management can benefit from the hybrid database model 1900 by enforcing strict schemas for sensitive patient data through the relational value contract 1904 while accommodating unstructured logs or reports through the document value contract 1906. In supply chain management applications, the hybrid database system can track structured records through the relational value contract 1904 and dynamic, non-relational inputs through the document value contract 1906 or the key-value contract 1910 in a transparent and decentralized manner. The flexibility provided by the hybrid database model 1900 allows the hybrid database system to adapt to various use cases, enabling organizations to manage complex data ecosystems within a unified, decentralized platform.

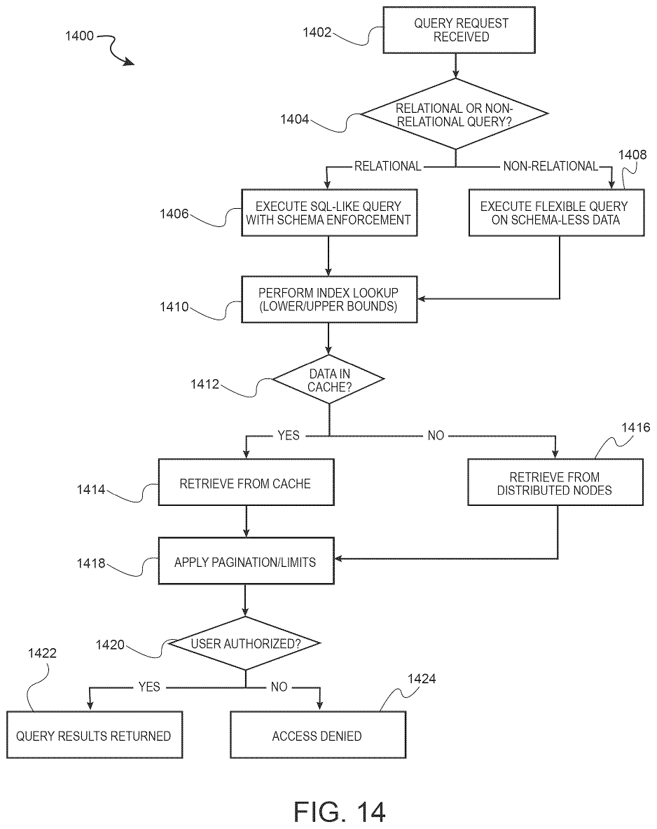

Referring now to FIG. 14, a method 1400 for query processing in the hybrid database system is shown. The method 1400 illustrates the sequential operations for receiving, processing, and returning query results within the decentralized blockchain network. The method 1400 demonstrates how the hybrid database system handles both relational and non-relational queries through a unified processing pipeline that incorporates caching, authorization, and distributed data retrieval.

The method 1400 begins with step 1402, where a query request is received. Step 1402 serves as the entry point for query operations within the hybrid database system. The query request received at step 1402 can originate from applications using libraries such as Inery-JS TM for JavaScript applications, Inery-Sharp TM for .NET environments, RESTful APIs, command-line interfaces, and so on. In some cases, the query request can target relational data, non-relational data, or a combination of both data types within the hybrid database.

Following step 1402, the method 1400 proceeds to step 1404, which involves determining whether the query is relational or non-relational. Step 1404 evaluates the nature of the query request to route the query to the appropriate processing path. The determination at step 1404 can be based on the query syntax, the target data model, or metadata associated with the query request, among others. This determination enables the hybrid database system to apply the appropriate query execution strategy for the data type being accessed.

If the query is determined to be relational at step 1404, the method 1400 moves to step 1406, where an SQL-like query is executed with schema enforcement. Step 1406 processes structured queries that target data organized in tables with predefined schemas, such as data stored through a relational value contract 1904, as shown in FIG. 19. The query execution at step 1406 can leverage traditional indexing and query optimization techniques to execute complex joins, filters, and aggregations on structured datasets. In some cases, step 1406 can enforce schema rules defined in the value contracts, such as those discussed above with reference to FIG. 11 (e.g., Value Contracts 1112), to ensure query operations comply with the defined data structure and relationships.

If the query is determined to be non-relational at step 1404, the method 1400 proceeds to step 1408, where a flexible query is executed on schema-less data. Step 1408 processes queries that target data stored in flexible formats such as, for example, documents, key-value pairs, or wide columnar structures. The query execution at step 1408 can utilize specialized indexing methods optimized for object lookups, hierarchical data traversal, or columnar access patterns, for example. In some cases, step 1408 can access data stored through the document value contract 1906, the wide columnar value contract 1908, or the key-value contract 1910 (FIG. 19).

With continued reference to FIG. 14, both step 1406 and step 1408 converge to step 1410, where an index lookup is performed using lower and upper bounds. Step 1410 can utilize the Indexing Mechanism 1128 (discussed in FIG. 11) to locate the requested data within the distributed database. The index lookup at step 1410 can employ the bounded indexing approach discussed above, where lower and upper bounds define the starting and ending points of the query to retrieve a subset of the dataset. In some cases, step 1410 can utilize hash-based indexing for exact match queries, tree-based indexing for range queries, or multi-dimensional indexing for queries involving multiple attributes.

The method 1400 then moves to step 1412, which determines whether the requested data is available in cache. Step 1412 checks the caching layers of the hybrid database system to determine if the query can be satisfied from cached data rather than retrieving data from distributed nodes. The cache check at step 1412 can reduce latency and improve query performance by avoiding disk I/O operations and network communication when cached data is available.

The hybrid database system can employ caching mechanisms to reduce latency and improve query performance. In some cases, the caching mechanisms can include state caching, action and transaction caching, and database index caching. State caching stores frequently accessed data, such as account states and contract information, in memory to minimize disk I/O operations. Action and transaction caching temporarily stores actions and transactions during processing to optimize performance and reduce the load on the underlying storage system. Database index caching stores commonly used indexes in memory for faster query execution, minimizing the need for disk reads during query processing.

If the data is available in cache at step 1412, the method 1400 proceeds to step 1414, where the data is retrieved from cache. Step 1414 accesses the cached data from one or more of the caching layers, such as state cache, action and transaction cache, or database index cache. The cache retrieval at step 1414 can provide faster response times compared to retrieving data from distributed nodes, as the data is already available in memory.

If the data is not available in cache at step 1412, the method 1400 moves to step 1416, where the data can be retrieved from distributed nodes. Step 1416 can access a DLS network (e.g., the DLS Network 1118 of FIG. 11) to retrieve the requested data from nodes such as Node A 1122, Node B 1124, or Node C 1126. In some cases, step 1416 can involve parallel query execution across multiple nodes to retrieve data that is distributed across the network. The retrieval at step 1416 can also populate the cache layers for subsequent queries targeting the same data.

Both step 1414 and step 1416 lead to step 1418, where pagination and limits are applied to the retrieved data. Step 1418 processes the retrieved data to apply any pagination parameters or result limits specified in the query request. The pagination at step 1418 can utilize LIMIT clauses to ensure that a manageable number of results are retrieved per request, reducing the computational and memory burden on nodes. In some cases, step 1418 can apply the bounded indexing approach to retrieve specific pages of results, such as, for example, Index[0:100] for the first page and Index[101:200] for subsequent pages.

The method 1400 then proceeds to step 1420, which checks whether the user is authorized to access the data. Step 1420 evaluates the permissions associated with the query request against the access controls established by the Permission Management Component 1114 (FIG. 11). The authorization check at step 1420 can verify that the private key or role associated with the query request has permission to access the requested data. In some cases, step 1420 can evaluate dynamic permissions based on conditions such as time constraints or network state.

If the user is authorized at step 1420, the method 1400 moves to step 1422, where the query results are returned. Step 1422 delivers the processed and paginated query results to the requesting application or user. The results returned at step 1422 can include data from relational sources, non-relational sources, or a combination of both, depending on the nature of the original query request.

If the user is not authorized at step 1420, the method 1400 proceeds to step 1424, where access is denied. Step 1424 handles unauthorized query attempts by rejecting the request and returning an access denied indication to the requesting entity. The access denial at step 1424 ensures that data access controls established through the Value Contracts 1112 and the Permission Management Component 1114 are enforced at the query level.

The method 1400 demonstrates the unified approach of the hybrid database system for processing diverse query types while maintaining data security and retrieval efficiency in a distributed database environment. The multi-layer caching mechanisms, including state caching, action and transaction caching, and database index caching, work together to reduce latency and improve query performance across the DLS network. The method 1400 incorporates authorization checks to ensure secure data access while supporting both relational and non-relational query patterns through the same processing pipeline.

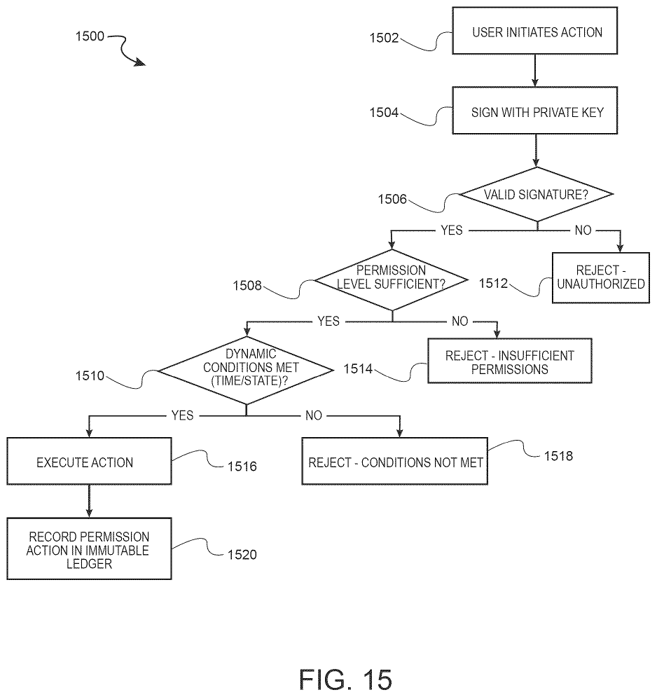

Referring now to FIG. 15, a method 1500 for permission enforcement within the hybrid database system is shown. The method 1500 illustrates the sequential operations for validating user actions, checking permissions, evaluating dynamic conditions, and recording authorized actions within the decentralized blockchain network. The method 1500 demonstrates a multi-layered permission validation process that incorporates signature verification, permission level checking, and dynamic condition evaluation to ensure secure access control across the distributed database system.

The method 1500 begins with step 1502, where a user initiates an action. Step 1502 serves as the entry point for permission enforcement within the hybrid database system. The action initiated at step 1502 can include database operations such as data insertion, updates, deletions, or queries that require authorization before execution. The Permission Management Component 1114 (FIG. 11) discussed above can establish the access controls that govern which actions require authorization and which roles or private keys can perform specific operations.

Following step 1502, the method 1500 proceeds to step 1504, where the action is signed with a private key to establish user identity and authorization. Step 1504 creates a cryptographic signature that associates the requested action with a specific user or role within the system. The private key signing at step 1504 enables the hybrid database system to verify the identity of the requesting entity and determine the permission level associated with the request.

The method 1500 continues to step 1506, which involves a decision point to determine if the signature is valid. Step 1506 validates the cryptographic signature created at step 1504 against the associated public key stored in the system. The signature validation at step 1506 ensures that the action request originates from an authorized entity and has not been tampered with during transmission.

If the signature is valid at step 1506, the method 1500 proceeds to step 1508, which checks whether the permission level is sufficient for the requested action. Step 1508 evaluates the permissions associated with the signing key against the access controls established by the Permission Management Component 1114. The permission level checking at step 1508 can verify that the role or key associated with the request has authorization to perform the specific action being requested.

If the signature is invalid at step 1506, the method 1500 moves to step 1512, where the action is rejected due to unauthorized access. Step 1512 handles requests that fail signature validation by rejecting the action and returning an unauthorized access indication to the requesting entity. The rejection at step 1512 prevents unauthorized entities from executing actions within the hybrid database system.

If the permission level is sufficient at step 1508, the method 1500 advances to step 1510, which evaluates whether dynamic conditions such as time constraints or network state requirements are met. Step 1510 checks any conditional requirements associated with the permission before allowing the action to proceed. In some cases, step 1510 can evaluate time-based constraints that allow or restrict access to certain data or actions based on defined time windows. For example, a user can be granted write access during business hours but restricted to read-only access outside of those hours. In some cases, step 1510 can evaluate network state conditions that grant additional privileges during low traffic periods or restrict access during maintenance or high-load scenarios.

If the permission level is insufficient at step 1508, the method 1500 proceeds to step 1514, where the action is rejected due to insufficient permissions. Step 1514 handles requests where the user has a valid signature but lacks the authorization level required for the requested action. The rejection at step 1514 enforces the hierarchical permission structures defined by the Permission Management Component 1114.

The hybrid database system supports hierarchical permission structures with different levels of access for various roles. In some cases, the hierarchical permission structures can include master administrative (“admin”) override capabilities that allow master admin roles to override other roles within the system. In some cases, the hierarchical permission structures can include read-only user restrictions that limit certain users to querying data without modification rights. The hierarchical organization of permissions enables granular control over database operations while maintaining flexibility for different organizational roles and responsibilities.

At step 1510, if the dynamic conditions are met, the method 1500 continues to step 1516, where the action is executed. Step 1516 performs the requested database operation after successful validation of the signature, permission level, and dynamic conditions. The action execution at step 1516 can include data manipulation operations, validation rule enforcement, complex queries, or automated actions defined within the Value Contracts 1112 (FIG. 11).

If the dynamic conditions are not met at step 1510, the method 1500 moves to step 1518, where the action is rejected because the conditions are not satisfied. Step 1518 handles requests that pass signature and permission validation but fail to meet the dynamic condition requirements. The rejection at step 1518 ensures that conditional access controls are enforced even when the user has appropriate static permissions.

Following successful execution at step 1516, the method 1500 proceeds to step 1520, where the permission action is recorded in an immutable ledger to maintain an audit trail of all authorized operations. Step 1520 creates a permanent record of the executed action on the distributed ledger, ensuring traceability and accountability for all permission-related operations within the hybrid database system.

The Permission Management Component 1114 discussed above can support event-triggered permissions that grant temporary permissions for recovery actions when errors or anomalies are detected. In some cases, the event-triggered permissions can adjust access levels during system events such as data migration or upgrades. The event-triggered permissions enable the hybrid database system to respond dynamically to operational conditions while maintaining security controls.

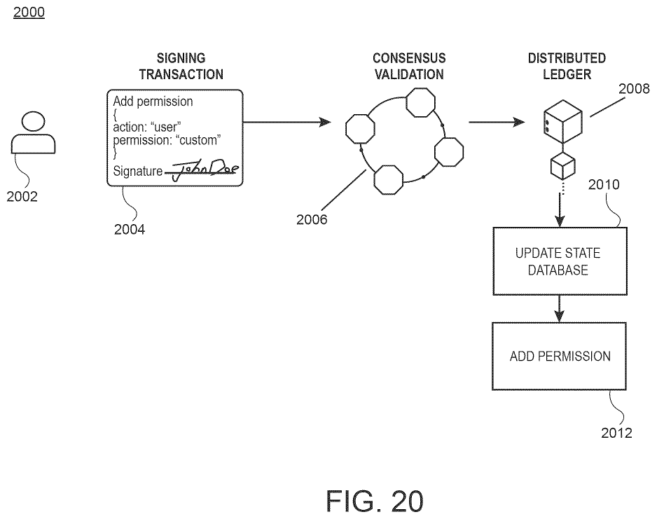

Referring now to FIG. 20, a permission enforcement workflow 2000 illustrates the process from user action initiation through blockchain-level validation and database updates. The permission enforcement workflow 2000 demonstrates the sequential stages of permission enforcement within the hybrid database system, showing how user actions are validated, recorded, and applied to the database state.

The permission enforcement workflow 2000 begins with a user 2002, who initiates the permission enforcement process by creating a signed transaction 2004. The signed transaction 2004 contains the permission-related action along with the cryptographic signature created using the user's private key. In some cases, the signed transaction 2004 can include fields specifying the permission to be added, the action to be authorized, and the signature that authenticates the request.

The signed transaction 2004 flows to a consensus validation 2006 component. The consensus validation 2006 validates the transaction to confirm its integrity across the distributed network. In some cases, the consensus validation 2006 can utilize the SDPoES Consensus Mechanism 1130 (FIG. 11) to validate the transaction across multiple nodes before the permission change is committed. The consensus validation 2006 ensures that permission modifications are agreed upon by the network before being recorded.

Following successful validation, the permission enforcement workflow 2000 proceeds to a distributed ledger 2008 for recordation. The distributed ledger 2008 records the validated transaction as an immutable entry in the ledger. The distributed ledger 2008 creates a permanent record of the permission action that cannot be altered or deleted, providing an audit trail for all permission changes within the system.

From the distributed ledger 2008, the permission enforcement workflow 2000 continues to a state database update 2010 operation. The state database update 2010 operation modifies the current state of the database to reflect the validated transaction. The state database update 2010 operation ensures that the permission change is applied to the active database state, enabling the new permission to take effect for subsequent operations.

The permission enforcement workflow 2000 concludes with a permission added to actor database 2012 operation. The permission added to actor database 2012 operation finalizes the permission enforcement process by recording the new permission in the actor database. The actor database maintains the current permission state for all users and roles within the hybrid database system, enabling the Permission Management Component 1114 to evaluate permissions for subsequent action requests.

The permission enforcement workflow 2000 demonstrates the integration of blockchain-level validation with database state management for permission operations. The workflow ensures that permission changes are validated through consensus, recorded immutably on the distributed ledger, and applied to the database state in a consistent manner across all nodes in the DLS Network 1118 (FIG. 11). This approach provides secure and auditable permission management within the decentralized hybrid database system.

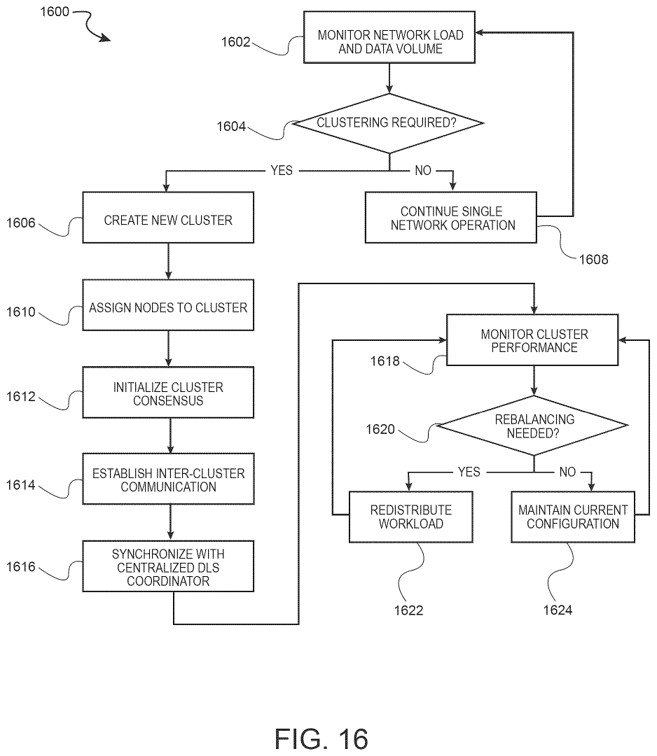

Referring now to FIG. 16, a method 1600 for dynamic clustering management in the hybrid database system is shown. The method 1600 illustrates the sequential operations for monitoring network conditions, creating and managing clusters, and maintaining system performance within the decentralized blockchain network. The method 1600 demonstrates an adaptive approach to cluster management that responds to changing network conditions and data volumes, enabling the hybrid database system to scale dynamically based on real-time performance metrics and resource requirements.

The method 1600 begins with step 1602, where the system monitors network load and data volume. Step 1602 serves as the entry point for the dynamic clustering management process within the hybrid database system. The monitoring at step 1602 can continuously evaluate data volume, query patterns, and node performance across the DLS Network 1118 (FIG. 11) to determine the current operational state of the system. In some cases, the Cluster Management System 1206 (FIG. 12) can perform the monitoring operations at step 1602 to collect metrics that inform clustering decisions.

Following step 1602, the method 1600 proceeds to step 1604, which involves determining whether clustering is required based on the monitored parameters. Step 1604 evaluates the metrics collected at step 1602 to assess whether the current network configuration can handle the data volume and processing demands. The determination at step 1604 can be based on factors such as geographic location of data requests, workload distribution across nodes, data type characteristics, performance thresholds defined within the system, and other factors. In some cases, the Centralized DLS Coordinator 1204 (FIG. 12) can coordinate with the Cluster Management System 1206 to make the clustering determination at step 1604.

If clustering is required at step 1604, the method 1600 moves to step 1606, where a new cluster is created. Step 1606 initiates the formation of a new sub-network within the Multi-Cluster DLS Architecture 1202 (FIG. 12) to handle the increased data volume or specialized workload requirements. The cluster creation at step 1606 can establish a new independent network with its own subset of the ledger and consensus mechanism. In some cases, the new cluster created at step 1606 can be similar in structure to Cluster 1 1210, Cluster 2 1218, or Cluster 3 1226 discussed above with reference to FIG. 12.

If clustering is not required at step 1604, the method 1600 proceeds to step 1608, where single network operation continues without creating additional clusters. Step 1608 maintains the current network configuration when the existing infrastructure can adequately handle the data volume and processing demands. The single network operation at step 1608 avoids unnecessary cluster creation when the system is operating within acceptable performance parameters. The system can continue to operate in the single network operation configuration until a subsequent monitoring at step 1602 indicates a need for clustering at step 1604.

Following cluster creation at step 1606, the method 1600 continues to step 1610, where nodes are assigned to the newly created cluster. Step 1610 allocates nodes from the network to the new cluster based on factors such as geographic proximity, current workload, or data affinity, for example. The node assignment at step 1610 can distribute nodes to form a distributed node structure within the new cluster, similar to the arrangement of Node 1A 1214 and Node 1B 1216 within Cluster 1 1210 (FIG. 12). In some cases, step 1610 can assign a master node to coordinate operations among the assigned nodes within the new cluster.

The method 1600 then proceeds to step 1612, where cluster consensus is initialized to establish validation mechanisms within the cluster. Step 1612 configures the consensus mechanism for the newly created cluster, enabling the cluster to validate transactions independently. The consensus initialization at step 1612 can configure the SDPoES Consensus Mechanism 1130 (FIG. 11) or a similar consensus protocol for the new cluster, ensuring that nodes within the cluster can reach agreement on transaction validity before data is committed to the cluster's ledger.

Following consensus initialization, the method 1600 advances to step 1614, where inter-cluster communication is established to enable coordination between different clusters. Step 1614 configures communication pathways between the new cluster and existing clusters within the Multi-Cluster DLS Architecture 1202. The inter-cluster communication established at step 1614 can utilize the Inter-Cluster Communication 1208 component (FIG. 12) to enable data exchange and coordination for operations that span multiple sub-networks.

The method 1600 then moves to step 1616, where synchronization with the centralized DLS coordinator is performed to maintain system-wide consistency. Step 1616 registers the new cluster with the Centralized DLS Coordinator 1204 (FIG. 12) and establishes synchronization protocols to ensure the new cluster operates in coordination with the broader network. The synchronization at step 1616 can utilize the Data Synchronization Layer 1234 (FIG. 12) to maintain synchronized data states across the distributed cluster architecture.

The clustering path from step 1616 proceeds to step 1618, where the system monitors cluster performance to evaluate the effectiveness of the current configuration. Step 1618 collects performance metrics from all clusters and nodes within the Multi-Cluster DLS Architecture 1202 to assess system health and efficiency. The performance monitoring at step 1618 can track metrics such as transaction throughput, query latency, node availability, and resource utilization across the distributed network.

The method 1600 then proceeds to step 1620, which determines whether rebalancing is needed based on the performance monitoring results. Step 1620 evaluates the metrics collected at step 1618 to identify imbalances in workload distribution or resource utilization across clusters. The rebalancing determination at step 1620 can identify scenarios where certain clusters are overloaded while other clusters remain underutilized, or where data locality can be improved by redistributing workloads.

If rebalancing is needed at step 1620, the method 1600 moves to step 1622, where workload redistribution is performed to optimize system performance across clusters. Step 1622 can redistribute data, reassign nodes between clusters, or adjust query routing to balance the load across the Multi-Cluster DLS Architecture 1202. The workload redistribution at step 1622 can be coordinated by the Centralized DLS Coordinator 1204 in conjunction with the Load Balancer 1236 (FIG. 12) to ensure that redistribution operations do not disrupt ongoing transactions or compromise data consistency. The system can continue operating in its redistributed state until subsequent monitoring at step 1618 indicates a need for a further redistribution.

If rebalancing is not needed at step 1620, the method 1600 proceeds to step 1624, where the current configuration is maintained without modification. Step 1624 preserves the existing cluster configuration and workload distribution when the system is operating within acceptable performance parameters. The configuration maintenance at step 1624 allows the system to continue operating in its current state until subsequent monitoring at step 1618 indicates a need for adjustment.

The hybrid database system includes automated recovery mechanisms to maintain data consistency across the distributed network. In some cases, nodes can synchronize their states during each production cycle by comparing their state with the confirmed ledger on the blockchain. If discrepancies arise during synchronization, nodes can perform automated recovery by retrieving the correct state from the confirmed ledger and updating their local state accordingly. The automated state recovery ensures that all nodes within the DLS Network 1118 (FIG. 11) and across clusters within the Multi-Cluster DLS Architecture 1202 maintain consistent data states even when temporary inconsistencies occur due to network delays or node failures.

The hybrid database system also includes mechanisms for removing nodes that fail to meet operational requirements. In some cases, nodes that fail to produce blocks or fall behind in synchronization for an extended period can be removed from the active production list. The node failure removal reduces the risk of data fragmentation by preventing unreliable nodes from participating in consensus operations or data distribution. The removal of failing nodes ensures that the active node set within each cluster maintains operational reliability and can continue to validate transactions and synchronize data without disruption from non-performing nodes.

The method 1600 demonstrates the adaptive approach of the hybrid database system to cluster management, enabling the system to scale dynamically in response to changing network conditions and data volumes. The integration of the Centralized DLS Coordinator 1204, the Cluster Management System 1206, and the Inter-Cluster Communication 1208 within the Multi-Cluster DLS Architecture 1202 (discussed above with reference to FIG. 12) provides a coordinated framework for managing distributed database operations across multiple clusters while maintaining data integrity and system performance.

The scalability and reliability characteristics of the hybrid database system were validated through extensive testing to evaluate system performance under various network configurations and operational conditions. More particularly, the hybrid database system described herein underwent extensive scalability testing through a distributed ledger system testnet to evaluate performance, scalability, and reliability characteristics. The testing provided insights into the system's capabilities across different network configurations and identified areas for optimization to ensure the hybrid database system meets demands of decentralized environments.

Performance testing was conducted across configurations with 1, 10, and 20 nodes to measure transaction throughput and system scalability. Random transactions were pushed to simulate real-world operations, with each transaction verified by the consensus mechanism before being added to the ledger. The testing results demonstrated the system's ability to scale as more nodes are added to the network. Indeed, with a single node configuration, the system achieved a throughput of 1,000 transactions per second (TPS). Expanding to 10 nodes increased throughput to 4,000 TPS. Testing with 20 nodes demonstrated a capacity of 6,000 TPS. These results indicate that the hybrid database system can scale to improve overall system performance as additional nodes are added to the network.

Block size and ledger write speed were also evaluated during the testing phase. In some cases, blocks can be configured with a recommended size of 1 MB, resulting in a ledger write speed of approximately 2 MB per second. This configuration can ensure fast and efficient ledger operations even under high transaction loads. Each test transaction contained a single action, and the speed varied depending on the size of the action as measured in memory, bytes, or storage.

The relationship between memory usage, number of nodes, and actions per transaction was also examined during testing. In the hybrid database system, data can be replicated on every node, which increases memory usage as the number of nodes grows. Testing revealed steady growth in memory requirements between 1 and 10 nodes, with a slower, non-linear increase beyond 20 nodes. This pattern reflects diminishing returns in performance gains as the number of nodes increases. Memory usage scales linearly with the number of actions per transaction for each node configuration, as each action adds a consistent load to the system. The memory scaling characteristics inform capacity planning decisions for deployments of the hybrid database system across different network sizes.

The scalability testing included a developer-focused testnet initiative that encouraged participants to deploy nodes, join the protocol, create databases, and implement value contracts. This initiative simulated real-world use cases and exposed potential scalability bottlenecks within the system. In a second stage of testing, developers joined the testnet as master nodes, subjecting the system to significant load. At one point, the testnet faced challenges due to failures of over 300 master nodes, as well as complications caused by other operational issues. These stress tests helped identify vulnerabilities and areas where system optimizations were needed.

The failures observed during scalability testing highlighted the importance of refining the system's consensus scheduling mechanism. Malicious or misconfigured master nodes posed a risk to the integrity and performance of the ledger. Since master nodes have the ability to halt the ledger or violate established rules if more than one-third of them act maliciously, addressing this risk was a priority. Adjustments to the consensus scheduling mechanism were implemented to ensure that the system remained secure and scalable even under adverse conditions. These updates allowed the chain to continue running while reducing the risk of disruption caused by malicious or failing nodes. The consensus mechanism refinements strengthened the reliability and resilience of the system, preparing the hybrid database system for deployment scenarios. The novel and improved consensus mechanism (SDPoES) is discussed in further detail below.

The reliability of the hybrid database system was tested by subjecting the system to worst-case scenarios, such as large-scale node failures and malicious activity. The system's ability to handle these challenges validated its robustness and dependability. By ensuring that master nodes could compromise the system with more than one-third acting maliciously, the hybrid database system maintained the integrity and continuity of its operations. The refined consensus mechanism further reduced the risk of disruption even when faced with widespread node failures.

The hybrid database system discussed herein supports various integration tools and application programming interfaces (APIs) to facilitate data management and programmatic access to the decentralized database. These tools enable developers to integrate the hybrid database system into diverse applications and environments, leveraging the hybrid relational and non-relational capabilities across different programming platforms and operational contexts.

The hybrid database system includes programming libraries for JavaScript and .NET environments to enable direct interaction with the database from application code. A JavaScript library, such as Inery-JS TM, allows developers to interact with the hybrid database system directly from JavaScript applications. Inery-JS TM provides seamless integration with blockchain functionalities, enabling developers to manage and query data programmatically within decentralized environments. In some cases, Inery-JS TM can support operations such as data insertion, updates, queries, and transaction management through a JavaScript-based interface that abstracts the underlying blockchain communication protocols.

For .NET developers, the hybrid database system includes a C# library referred to as Inery-Sharp TM. Inery-Sharp TM provides capabilities similar to Inery-JS TM for applications built in .NET environments. In some cases, Inery-Sharp TM can enable .NET applications to perform database operations, manage transactions, and interact with the distributed ledger through a native C# interface. The availability of both Inery-JS TM and Inery-Sharp TM enables developers to integrate the hybrid database system into applications across different technology stacks while maintaining consistent functionality and access patterns.

The hybrid database system can also expose RESTful APIs that provide a standardized and widely supported interface for managing and querying data. The RESTful APIs enable developers to perform operations such as data insertion, updates, queries, and deletions through HTTP methods. In some cases, the RESTful APIs can enable integration with web and mobile applications that communicate using HTTP protocols. The RESTful API interface provides a platform-agnostic access method that can be utilized by applications regardless of the underlying programming language or framework.

For developers and administrators who prefer direct control over database operations, the hybrid database system can include a Command-Line Interface (CLI). The CLI supports various commands to query, manipulate, and manage data directly through the console. In some cases, the CLI can provide advanced users with an efficient method for interacting with the database without requiring application code or graphical interfaces. The CLI can support operations such as executing queries, managing database schemas, configuring system parameters, and monitoring database status through text-based commands.

The hybrid database system can also include a WebSocket plugin on master nodes that enables real-time communication and event-driven interactions. The WebSocket plugin can be particularly useful for applications requiring live updates or notifications from the database. In some cases, the WebSocket plugin can enable applications to subscribe to database events and receive notifications when data changes occur, supporting real-time data synchronization between the database and connected applications. The event-driven communication provided by the WebSocket plugin can reduce polling overhead and enable responsive application behavior based on database state changes.

In some cases, the hybrid database system can be configured to support a custom query language referred to as IneryDB TM QL. IneryDB TM QL is tailored specifically to the features and architecture of the decentralized database system, enabling developers to construct queries optimized for the distributed environment. In some cases, IneryDB TM QL can provide query constructs that address the specific characteristics of blockchain-based data storage and retrieval, including operations that span both relational and non-relational data models within the hybrid database. Accompanying JavaScript libraries can be developed to simplify adoption of IneryDB TM QL and enhance accessibility for developers familiar with JavaScript environments.

The hybrid database system can further include migration plugins through its graphical user interface (GUI) to facilitate smooth migrations from other database systems and data formats. In some cases, the migration plugins can support migrations from MongoDB, Redis, JSON files, CSV files, XML files, and traditional relational databases. The migration plugins can enable organizations and users to import and adapt data from different sources into the hybrid database system, whether the source data is relational or non-relational in structure. The migration plugin capabilities can reduce the complexity of transitioning from existing database infrastructures to the hybrid database system by providing automated data transformation and import functionality.

As will be evident from the foregoing, the hybrid database system described herein provides a unified data model that supports both structured and unstructured data within a single platform. As a result, organizations and users can manage complex, structured datasets with well-defined relationships alongside flexible, unstructured information without requiring separate database systems. In some cases, the unified data model can eliminate the need for data integration processes between disparate database systems, reducing operational complexity and data synchronization overhead. The ability to store relational data with enforced schemas and non-relational data with flexible structures within the same database enables organizations and users alike to address diverse data storage requirements through a single interface and toolset.

It is also noted that the hybrid database system of this disclosure provides improved scalability through its decentralized architecture and clustering capabilities. Indeed, the distributed node architecture can expand to accommodate growing data volumes and network demands by adding nodes to the network or creating additional clusters. In some cases, the clustering approach can isolate workloads within sub-networks based on factors such as geographic location, workload characteristics, or data type, reducing the query and processing burden on individual nodes. The scalability characteristics enable the hybrid database system to handle increasing data volumes without overloading existing network resources, supporting growth from small deployments to large-scale distributed environments.

The hybrid database system also provides enhanced data security through blockchain technology and permission management capabilities. The decentralized architecture distributes data across a network of nodes, providing resilience against single points of failure and reducing vulnerability to targeted attacks on centralized infrastructure. In some cases, the immutability of blockchain transactions ensures that all data modifications and permission changes are traceable and auditable, providing a permanent record of database operations. The permission management capabilities enable granular control over database operations through role-based access controls, hierarchical permission structures, and dynamic permissions based on conditions such as time constraints or network state.

Flexible indexing capabilities for optimized query performance across both relational and non-relational data models are also provided by the hybrid database system. The indexing mechanism described herein supports automatic index generation based on predefined rules and data usage patterns, as well as user-defined indexes that allow customization for specific query requirements. In some cases, the indexing mechanism can support up to sixteen different indexes per composition, enabling precise control over data retrieval and efficient execution of complex queries. The combination of hash-based indexing for exact match queries, tree-based indexing for range queries, and multi-dimensional indexing for queries involving multiple attributes enables the hybrid database system to optimize retrieval performance across diverse query patterns.

Adaptable schema enforcement is achieved through value contracts that accommodate both rigid relational structures and flexible non-relational data models. Value contracts can define strict schema rules for data that requires consistency and referential integrity while allowing flexible, schema-less storage for data with varying structures. In some cases, value contracts can include custom validation logic to enforce business rules or data dependencies beyond simple data types and structures. The centralized management of data rules through value contracts simplifies the maintenance of data integrity policies across the system and enables updates to schema definitions as data requirements evolve.

Efficient query processing for both relational and non-relational data is enabled through a unified processing pipeline within the hybrid database system. The query processing adapts based on the data model being accessed, leveraging traditional indexing and query optimization techniques for relational queries while utilizing specialized indexing methods for non-relational queries. In some cases, the caching mechanisms including state caching, action and transaction caching, and database index caching can reduce latency and improve query performance by minimizing disk operations and network communication. The bounded indexing approach with lower and upper bounds enables efficient pagination and dataset traversal for large datasets without requiring retrieval of all records simultaneously.

Application development is simplified by providing multiple integration options and handling data validation at the database level. Developers can interact with the hybrid database system through JavaScript libraries, C# libraries, RESTful APIs, command-line interfaces, and WebSocket plugins, enabling integration across different technology stacks and application types. In some cases, the data validation handled through value contracts at the database level allows application developers to focus on business logic rather than implementing extensive data validation routines in application code. The unified interface for interacting with both relational and non-relational data enables developers to access and manipulate diverse data types using the same set of tools and access patterns.

Practical applications across various domains benefit from the combination of relational and non-relational data management within the decentralized framework provided by the hybrid database system. In enterprise solutions, the hybrid database system can manage structured transactional data such as financial records, inventory systems, or customer management systems alongside unstructured analytics data such as log files, user-generated content, or reporting data within a single platform. In some cases, enterprise applications can leverage the relational capabilities for data requiring strict consistency and referential integrity while utilizing the non-relational capabilities for flexible data storage and high-volume data ingestion.

In IoT data management scenarios, the hybrid database system can handle diverse data types from connected devices within the decentralized framework. In some cases, the hybrid database system can store sensor readings using key-value structures for fast access while maintaining flexible document structures for device metadata that varies between sensor types. The scalability characteristics of the hybrid database system can accommodate the high volume and velocity of data generated by IoT device networks, while the decentralized architecture provides resilience for distributed IoT deployments across multiple geographic locations.

In the example use case of healthcare records management, the hybrid database system can enforce strict schemas for sensitive patient data while accommodating unstructured logs, clinical notes, or diagnostic reports. In some cases, the relational capabilities can maintain referential integrity between patient records, treatment histories, and provider information while the non-relational capabilities can store varying document structures for clinical documentation that differs between specialties or care settings. The permission management capabilities can enforce access controls that comply with healthcare data privacy requirements, while the immutable audit trail provided by the blockchain architecture can support regulatory compliance and accountability for data access.

In another example use case, such as supply chain management applications, the hybrid database system can track structured records such as inventory levels, shipment manifests, or supplier information alongside dynamic, non-relational inputs such as sensor data from tracking devices, inspection reports, or exception notifications. In some cases, the decentralized architecture can provide transparency across supply chain participants while maintaining appropriate access controls for proprietary information. The combination of structured and unstructured data management within a single platform can enable comprehensive supply chain visibility that incorporates both transactional data and contextual information from diverse sources.

### Self-Delectaged Proof of Equal Stake (SDPoES) Consensus Mechanism

This section of the disclosure relates to systems and methods for implementing a Self-Delegated Proof of Equal Stake (SDPoES) consensus mechanism in distributed ledger systems. As further discussed herein, the SDPoES consensus mechanism enables secure, efficient, and decentralized operations by incorporating features such as system value contracts, self-delegation via staking, equal stake authority, dynamic scheduling and a hybrid database framework for managing master node states, production cycles and global block information. This innovative consensus mechanism is not only inclusive, but also extremely well suited for any number of use cases and industries, including those requiring high levels of decentralization, scalability and reliability, such as financial systems, supply chain management and other enterprise or public blockchain networks. As discussed below, the consensus mechanism of the present disclosure ensures robust network performance and resilience, even at scale.

The SDPoES consensus mechanism addresses several deficiencies found in traditional blockchain consensus mechanisms, particularly Delegated Proof of Stake (DPoS) systems. For one, traditional consensus mechanisms exhibit centralization tendencies by concentrating authority in entities with the highest stakes in native currency, which undermines decentralization and creates risks of collusion. Additionally, existing consensus mechanisms lack inclusivity by requiring participants to hold substantial amounts of cryptocurrency to become validators, thereby limiting the influence and participation of smaller holders.

The SDPoES consensus mechanism described herein resolves these issues through equal stake distribution among nodes, promoting decentralized ecosystem participation and equitable involvement across the network. The framework of SDPoES encourages broader participation by enabling nodes to become master nodes through self-delegation via memory staking rather than currency-based delegation. This approach fosters large-scale networks with substantial numbers of master nodes while maintaining scalability and real-time operational efficiency without compromising decentralization.

Traditional consensus mechanisms prioritize block production over network resilience, leading to vulnerabilities in decentralization, scalability, and fault tolerance. The SDPoES consensus mechanism of this disclosure, on the other hand, emphasizes network resilience by enabling nodes to act as maintainers of the network and as endpoints for communication with the novel hybrid database framework discussed elsewhere herein. This design enhances fault tolerance while providing robust scheduling and strict ordering of nodes throughout the consensus process.

Further, the lack of scalability in traditional consensus mechanisms limits their ability to adapt for enterprise and supply chain use cases that require high transaction volumes and complex workflows. On the other hand, the SDPoES consensus mechanism of this disclosure integrates hierarchical authority with custom business logic through a hybrid authority and permission system, making the mechanism adaptable for enterprise-specific and supply-chain specific needs. The flexibility of the system discussed herein allows the SDPoES consensus mechanism to cater to complex requirements in sectors such as supply chain management and enterprise operations.

In addition, the SDPoES consensus mechanism mitigates delegation risks associated with traditional consensus mechanisms by moving away from currency-based delegation and eliminating vulnerabilities associated with economic monopolization. As a result, fairness through equal participation and predefined authority structures is ensured, leading to more reliable and secure operations. This consensus mechanism also incorporates system value contracts that define validation and integrity rules to ensure master nodes adhere to predefined conditions for staking, validation, and consensus participation.

As further discussed herein, a system according to this disclosure utilizes a novel hybrid database framework for managing master node states, production cycles, scheduling, and global block information. This hybrid database framework integrates the strengths of both relational and non-relational databases within a decentralized framework, providing structure and predictability while maintaining flexibility and scalability. As will be evident, the hybrid database approach contributes to improvements in decentralized systems by offering the benefits of both database types within a single framework.

In sum, the SDPoES consensus mechanism achieves decentralization through equal stake distribution and broad participation, reducing risks of collusion and power concentration. In addition, its scalability with high throughput and low latency makes this novel consensus mechanism suitable for public distributed ledger systems. Further still, the hybrid approach discussed herein ensures flexibility and customization across various industries and applications, while prioritizing network stability and resilience for continuous operation and robust performance in enterprise-grade applications.

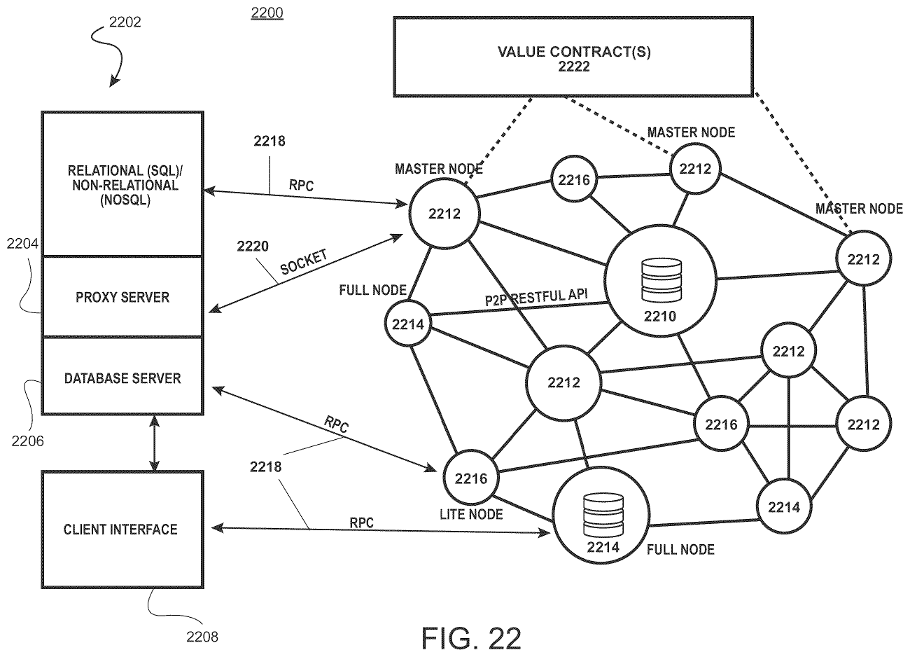

Referring now to FIG. 22, an exemplary DLS network topology 2200 according to this disclosure is shown. This network topology 2200 is configured to support distributed ledger operations in a blockchain environment. The DLS network topology 2200 can include a Hybrid Database (“Hybrid DB”) 2202 (discussed further herein) that integrates both relational SQL and non-relational NoSQL database capabilities within a decentralized framework. The Hybrid DB 2202 can provide structure and predictability through relational database functionality as discussed herein, while maintaining flexibility and scalability through non-relational database components.

The DLS network topology 2200 can include several types of nodes, each serving distinct roles within the distributed ledger system. A Genesis Node 2210, for example, can serve as an initial node in the network and can establish foundational network parameters. The Genesis Node 2210 can connect to multiple other nodes to facilitate network initialization and ongoing operations, as shown in this figure.

Master Nodes 2212 can participate in consensus operations and block production within the DLS network topology 2200. The Master Nodes 2212 can be interconnected with each other through mesh-like configurations to enable distributed consensus operations and data synchronization across the network. In some cases, the Master Nodes 2212 can maintain connections with the Genesis Node 2210 and can communicate with other node types to facilitate network operations.

Full Nodes 2214 can store complete copies of the ledger and can participate in network validation processes. The Full Nodes 2214 can connect to both Master Nodes 2212 and other node types to maintain network integrity and data consistency. In some cases, Full Nodes 2214 can serve as intermediary nodes for data propagation and validation across the network.

Lite Nodes 2216 can participate in network operations with reduced storage requirements compared to Full Nodes 2214, for example. The Lite Nodes 2216 can maintain connections with Master Nodes 2212 and/or Full Nodes 2214 while operating with lighter computational and storage demands. In some cases, Lite Nodes 2216 can enable broader network participation by accommodating nodes with limited resources.

As further shown in FIG. 22, the DLS network topology 2200 can include infrastructure components that facilitate database operations and network communication. A proxy server 2204 can connect to the Hybrid DB 2202 and can facilitate communication between the database layer and other network components. The proxy server 2204 can serve as an intermediary for database access and can manage communication protocols between different system components.

A database server 2206 can connect to or can be part of the Hybrid DB 2202 and can manage data storage and retrieval operations. The database server 2206 can handle database transactions and can maintain data consistency across the hybrid database framework. In some cases, the database server 2206 can coordinate between relational and non-relational database components within the Hybrid DB 2202.

A client interface 2208 can connect to the proxy server 2204 and can enable external clients to interact with the DLS network topology 2200. The client interface 2208 can provide access points for applications and users to communicate with the distributed ledger system. In some cases, the client interface 2208 can handle authentication and authorization for external access to network resources.

The DLS network topology 2200 can include various connection types to facilitate communication between components. An RCP (Remote Procedure Call) connection 2218 can link the database server 2206 to at least one of the Master Nodes 2212, Lite Nodes 2216 and/or Full Nodes 2214, providing remote procedure call functionality for database operations. A socket connection 2220 can similarly connect the proxy server 2204 to at least one Master Node 2212, Lite Node 2216 and/or Full Node 2214, enabling real-time data transmission and communication between the database layer and network nodes.

System value contract(s) 2222 can connect to the Master Nodes 2212 and can define validation and integrity rules for the network. As further discussed herein, the system value contract(s) 2222 can enforce predefined conditions for staking, validation, and/or consensus participation among Master Nodes 2212. In some cases, the system value contract(s) 2222 can operate on-chain and can be executed directly on the blockchain to ensure transparency and immutability of network rules.

As noted above, system value contracts define validation and integrity rules that ensure master nodes adhere to predefined conditions for staking, validation, and consensus participation within the SDPoES consensus mechanism. To that end, the system value contracts can establish comprehensive frameworks for network governance and node management through automated enforcement of network rules and standards.

For instance, the system value contracts can implement stake verification rules to qualify nodes for master node status. In some cases, an account can satisfy a predefined minimum stake requirement, such as 50,000 INR tokens (or other tokes), to qualify as a master node. The stake verification rules can ensure that participants with adequate resources can join the network as block producers while rejecting nodes that do not meet the minimum stake threshold during the onboarding process.

State transition validation can govern the progression of nodes from regular participants to master producers through strict rules included in the validation and integrity rules. In some cases, a node can be prevented from joining a master composition unless the predefined minimum stake is verified and locked. State transition validation can reflect changes to staking status in real-time to maintain system integrity throughout the network.

Timeliness and order verification can be implemented through the system value contracts to enforce scheduling protocols among master nodes. The master nodes can produce blocks in rotation based on entry times, and the system value contracts can enforce this scheduling to ensure no node disrupts the sequence. In some cases, nodes with verified stake and valid status can participate in block production according to the established order verification protocols.

Identity and role authorization can validate accounts against master composition requirements to ensure proper network participation. The system value contracts can authorize accounts with required stake and proper configuration to become block producers. In some cases, the identity and role authorization can validate these accounts to ensure that eligible nodes produce blocks and participate in governance functions.

Performance monitoring can track metrics such as block production activity, response times, and adherence to scheduling protocols for all master nodes. The system value contracts can enforce continuously monitoring performance to identify underperforming or inactive nodes within the network. In some cases, performance monitoring can be used to evaluate node reliability and consistency in meeting assigned production quotas.

Block production validation can enforce rules to ensure each master node produces blocks according to established schedules. To that end, the system value contracts can be used to flag master nodes that consistently fail to produce blocks or meet assigned production quotas as underperforming. In some cases, block production validation can be leveraged to maintain network efficiency by identifying nodes that fail to meet production standards.

Automatic node removal can be implemented when master nodes fail to produce blocks for extended periods. The system value contracts can enforce the automatic removal of underperforming nodes from the master composition to maintain network efficiency and prevent delays in block production. In some cases, automatic node removal can preserve network performance by eliminating nodes that consistently fail to meet production requirements.

Rejoining mechanisms can allow removed nodes to reapply for master composition participation by re-staking required amounts and fulfilling performance criteria. The system value contracts can evaluate rejoining requests to ensure fairness while maintaining high standards for network participation. In some cases, rejoining mechanisms can provide pathways for nodes to restore their status after addressing performance issues.

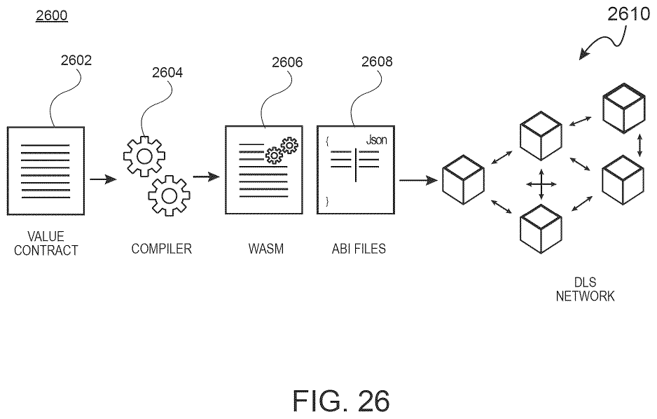

Referring now to FIG. 26, a value contract workflow 2600 illustrates the process of deploying and executing system value contracts within the distributed ledger system. The value contract workflow 2600 can demonstrate the transformation of contract code from initial development through compilation to deployment on the network infrastructure.

A value contract 2602 can contain contract code written in a smart contract programming language, such as C++, for example. The value contract 2602 can define the validation and integrity rules that govern master node behavior and network operations. In some cases, the value contract 2602 can specify the logic for stake verification, performance monitoring, and node management functions within the SDPoES consensus mechanism.

A compiler 2604 can process the value contract 2602 to compile the contract code into executable formats suitable for blockchain deployment. The compiler 2604 can be an Inery(TM) compiler configured to handle smart contract compilation for the distributed ledger system. In some cases, the compiler 2604 can be configured to transform the C++ contract code into formats compatible with blockchain execution environments, as discussed below.

The compiler 2604 can generate two outputs from the compilation process: WASM 2606 and ABI files 2608. The WASM 2606 can represent the WebAssembly format of the compiled contract, providing a portable and efficient execution format for blockchain environments. The Application Binary Interface (“ABI”) files 2608 can contain ABI specifications that define interaction protocols for the compiled contract.

Following compilation, both the WASM 2606 and the ABI files 2608 can be deployed to a DLS network 2610. The DLS network 2610 can store and execute the system value contracts according to the compiled specifications. In some cases, the DLS network 2610 can enable API calls and interactions according to the rules defined in the value contract 2602 through the deployed WASM 2606 and ABI files 2608.

In some cases, the system value contracts can be deployed on-chain through transactions that send compiled contracts to the blockchain network. Deployment can be validated and recorded by the network to ensure transparency and consistency across all participating nodes. In some cases, the deployment process can involve broadcasting deployment transactions to the blockchain network for consensus approval.

Enforcement of the system value contracts can occur through the SDPoES consensus mechanism, where master nodes validate transactions interacting with the contracts. Each transaction can be evaluated to ensure adherence to rules defined in the system value contracts. In some cases, the consensus mechanism can ensure that operations such as staking, state changes, and event triggers follow the contract logic.

Updates to the system value contracts can involve deploying new contract versions through governance approval processes, as further discussed herein. The update process can include specific permissions and governance mechanisms to ensure network consensus on contract modifications. In some cases, updated contracts can be propagated across all master nodes to ensure consistent network operation with new logic and rules.

Master nodes qualify for participation in the SDPoES consensus mechanism through self-delegation by staking a fixed amount of memory rather than traditional currency-based staking approaches. The fixed memory stake amount can be determined by the system value contracts and can be updated as needed to suit specific scenarios or network requirements. In some cases, the memory stake requirement can be calibrated to meet the demands of varying network sizes and conditions without compromising performance or stability.

The memory stake maps the native network currency into shared memory, aligning the staking mechanism with the network's operational needs during genesis protocol initialization. This currency-memory mapping concept enables the distributed ledger system to utilize memory stored in RAM for direct and efficient data access. In some cases, the memory stake may be influenced by the hardware capabilities of nodes within the network, as the system relies on RAM-based memory storage to enable efficient data operations.

The minimum stake requirement can be set to a predetermined amount, such as 50,000 INR(TM) tokens, for master node qualification. This minimum threshold ensures that participants with adequate resources can join the network as block producers while maintaining network security and integrity. In some cases, the stake verification rules can reject nodes that do not meet the minimum stake requirement during the onboarding process.

Memory stake confirmation can occur through execution of a system value contract action that stakes tokens representing equivalent bytes required for RAM storage. These tokens can function as a stable coin within the system to ensure consistent valuation of memory allocation. In some cases, the staking action can be validated through the SDPoES consensus mechanism, where successful validation allows the master node to proceed with registering as a candidate for block production.

Master nodes can utilize static IP addresses to ensure stability and continuous node availability within the network. If a static IP address becomes unavailable or changes, the affected node becomes unreachable by other nodes in the system, causing the node to stop producing blocks and validating transactions. In some cases, the network can detect the unavailability of such nodes and automatically remove them from the active block producer list until the issue is resolved and the node's IP address is updated in the network configuration.

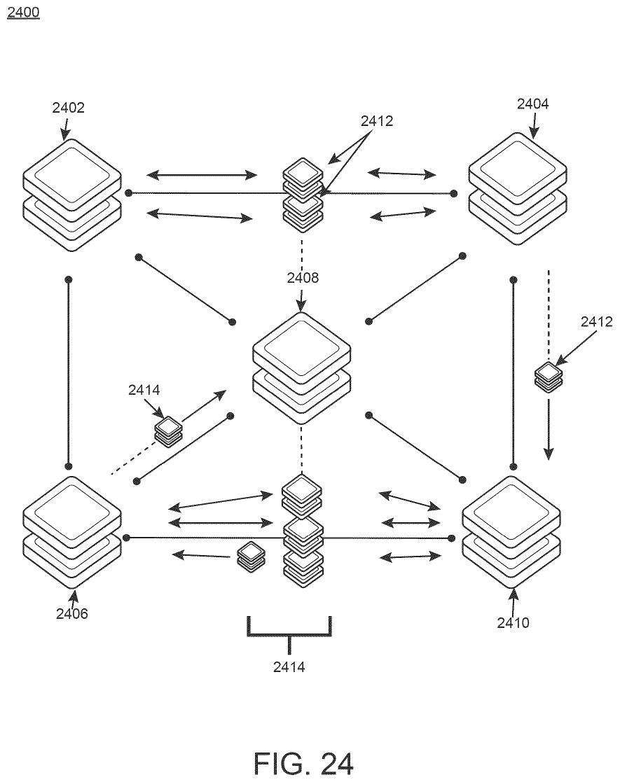

Referring now to FIG. 24, a node state flowchart 2400 illustrates the communication and interaction structure among master nodes in the distributed blockchain network. The node state flowchart 2400 includes multiple master nodes arranged in a network topology that demonstrates the mesh-like connectivity and data flow patterns within the SDPoES consensus framework.

Master node 1 2402 is shown positioned in the upper left portion of the network and is depicted as a layered stack structure representing a node with database capabilities. Master node 2 2404 is located in the upper right portion of the network and comprises a similar layered stack structure. Master node 3 2406 is positioned in the lower left portion of the network and it exhibits the same layered stack configuration as the other master nodes.

Master node 4 2408 is located in the center of the network and it also comprises a layered stack structure that serves as a central connection point. Master node 5 2410 is positioned in the lower right portion of the network and it maintains the same structural representation as the other master nodes in the network. In some cases, the master nodes can be interconnected through bidirectional communication pathways that enable distributed consensus operations and data synchronization.

As further shown in FIG. 24, block(s) 2412 are represented as smaller cubic structures positioned between the master nodes to demonstrate the creation, propagation, and validation of blocks throughout the network. The block(s) 2412 can appear at various points throughout the node state flowchart 2400 to illustrate how blocks are transmitted and processed among the master nodes during consensus operations.

Transaction(s) 2414 are also represented as smaller cubic structures similar in appearance to the block(s) 2412 and can be positioned at various points throughout the node state flowchart 2400. The transaction(s) 2414 demonstrate the creation, propagation, and validation of transactions between master nodes during network operations. In some cases, the transaction(s) 2414 can flow through the communication pathways established between the master nodes to facilitate distributed ledger operations.

Master node 1 2402 is shown connected to the Master node 2 2404 via bidirectional arrows passing through the block(s) 2412, demonstrating block transmission between these nodes. Master node 1 2402 is also connected to Master node 4 2408 through pathways involving the transaction(s) 2414. In some cases, Master node 2 2404 connects to Master node 4 2408 and Master node 5 2410 through bidirectional communication channels that facilitate consensus operations.

Master node 4 2408 serves as a central connection point in the node state flowchart 2400, with communication pathways extending to Master node 1 2402, Master node 2 2404, Master node 3 2406, and Master node 5 2410. Master node 3 2406 connects to Master node 4 2408 and Master node 5 2410 through bidirectional arrows. In some cases, Master node 5 2410 maintains connections with Master node 2 2404, Master node 4 2408, and Master node 3 2406 to complete the mesh-like network topology.

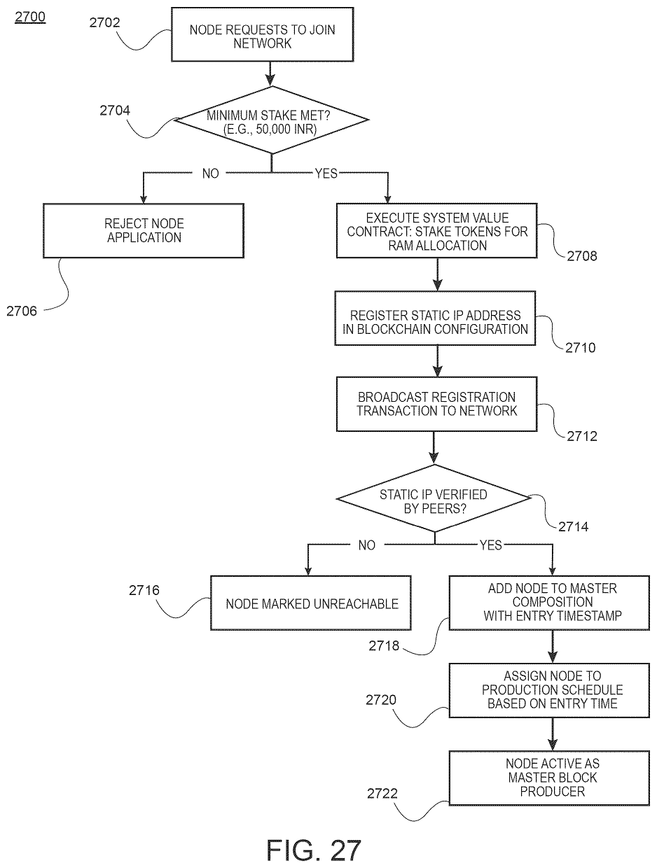

Referring now to FIG. 27, a method 2700 illustrates the master node onboarding and validation process within the SDPoES consensus mechanism. The method 2700 demonstrates the comprehensive validation steps and decision criteria that maintain network integrity and security during node qualification procedures.

The method 2700 begins with step 2702, where a node requests to join the network as a master node participant. The process then proceeds to step 2704, which presents a decision point to determine whether the minimum stake requirement is met. In some cases, step 2704 can check if the node has staked the predetermined required amount, such as 50,000 INR(TM) tokens, for example, to qualify for master node status.

If the minimum stake requirement is not met, the method 2700 proceeds to step 2706, where the node application is rejected and the node cannot participate as a master node. If the minimum stake requirement is satisfied, the method 2700 continues to step 2708, where the system executes a system value contract to stake tokens for RAM allocation according to the memory staking requirements.

Following successful token staking, the method 2700 moves to step 2710, where the node registers its static IP address in the blockchain configuration. The process then advances to step 2712, where the registration transaction is broadcast to the network for validation by peer nodes. In some cases, step 2712 can involve propagating the static IP registration information across the distributed network for consensus validation.

The method 2700 then reaches step 2714, which presents another decision point to determine whether the static IP address has been verified by peer nodes in the network. If the static IP verification fails, the method 2700 proceeds to step 2716, where the node is marked as unreachable and cannot participate in block production operations. In some cases, step 2716 can prevent nodes with invalid or unverifiable IP addresses from joining the master composition.

If the static IP verification succeeds, the method 2700 continues to step 2718, where the node is added to the master composition with an entry timestamp. The entry timestamp can be used for scheduling purposes and can determine the node's position in the production rotation, as further discussed below. In some cases, step 2718 can record the node's qualification status and entry time for future scheduling operations.

Upon successful addition to the master composition, the method 2700 proceeds to step 2720, where the node is assigned to the production schedule based on its entry time and performance metrics. The method 2700 can conclude with step 2722, where the node becomes active as a master block producer and can participate in the SDPoES consensus mechanism. In some cases, step 2722 can enable the newly qualified master node to begin participating in block production and validation operations according to the established scheduling protocols.

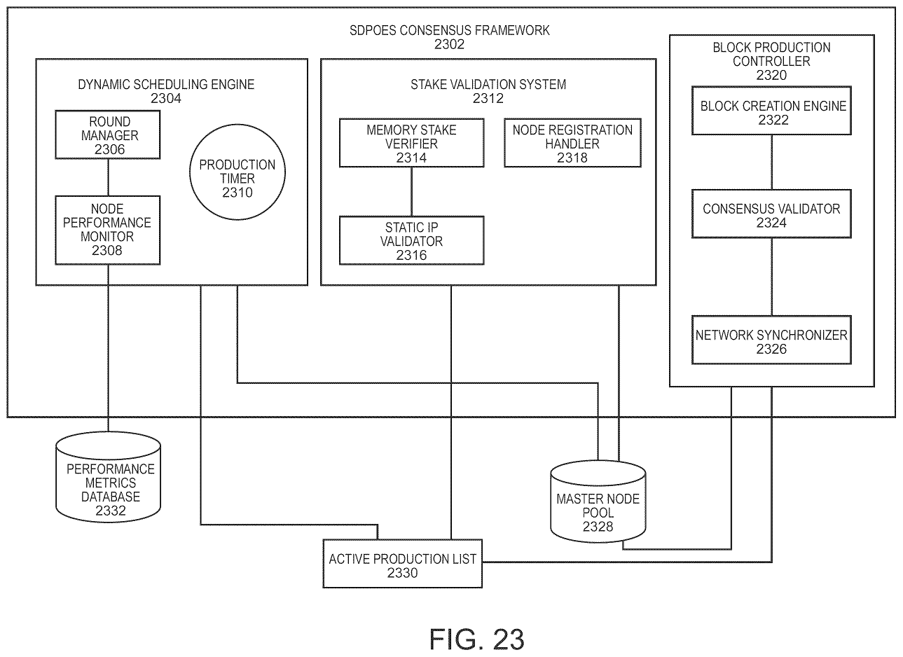

Referring now to FIG. 23, an SDPoES Consensus Framework 2302 illustrates the comprehensive architecture for managing blockchain consensus operations within the distributed ledger system. The SDPoES Consensus Framework 2302 comprises multiple interconnected subsystems that coordinate to ensure reliable and efficient consensus operations across the network. The framework can integrate various components to handle scheduling, validation, and block production functions within the SDPoES consensus mechanism.

The SDPoES Consensus Framework 2302 includes a Dynamic Scheduling Engine 2304 that manages the timing and coordination of block production activities among master nodes. The Dynamic Scheduling Engine 2304 can coordinate the selection and scheduling of master nodes for block production rounds according to the equal stake principles of the SDPoES consensus mechanism. In some cases, the Dynamic Scheduling Engine 2304 can optimize network performance through automated scheduling protocols that ensure fair participation among all qualified master nodes.

A Round Manager 2306 operates within the Dynamic Scheduling Engine 2304 to coordinate the organization of master nodes into production rounds. The Round Manager 2306 can manage the rotation of master nodes through sequential production cycles, ensuring that each qualified node receives equal opportunities for block production. In some cases, the Round Manager 2306 can organize nodes into groups of seventeen master nodes per round, facilitating structured and predictable block production sequences.

A Node Performance Monitor 2308 connects to the Round Manager 2306 and can track performance metrics for all participating master nodes within the network. The Node Performance Monitor 2308 can evaluate metrics such as block production rates, response times, and adherence to scheduling protocols to assess node reliability. In some cases, the Node Performance Monitor 2308 can utilize ping checks to determine node activity and can identify inactive or unresponsive nodes that may disrupt block production continuity.

A Production Timer 2310 operates within the Dynamic Scheduling Engine 2304 to manage timing operations for block production cycles. The Production Timer 2310 can enforce predetermined time windows for block creation, such as 0.5 second intervals, to maintain network throughput and minimize latency. In some cases, the Production Timer 2310 can coordinate with the Node Performance Monitor 2308 to skip inactive nodes in favor of responsive ones to maintain block production continuity.

The SDPoES Consensus Framework 2302 includes a Stake Validation System 2312 that manages the qualification and validation processes for master node participation. The Stake Validation System 2312 can enforce the memory staking requirements and network connectivity standards that govern master node eligibility. In some cases, the Stake Validation System 2312 can coordinate with the system value contract(s) 2222 to ensure compliance with predefined validation and integrity rules.

A Memory Stake Verifier 2314 operates within the Stake Validation System 2312 to validate memory stake requirements for nodes seeking master node status. The Memory Stake Verifier 2314 can verify that nodes have staked the predetermined minimum amount, such as 50,000 INR(TM) tokens, to qualify for block production participation. In some cases, the Memory Stake Verifier 2314 can coordinate with the system value contract(s) 2222 to execute token staking actions and validate memory allocation requirements.

A Static IP Validator 2316 connects to the Memory Stake Verifier 2314 and can verify that master nodes maintain static IP addresses as required by the network protocols. The Static IP Validator 2316 can validate IP address stability and accessibility to ensure continuous node availability for consensus operations. In some cases, the Static IP Validator 2316 can coordinate with peer nodes to verify IP address connectivity and can flag nodes with invalid or unreachable addresses.

A Node Registration Handler 2318 processes registration requests from nodes seeking to join the master composition and can validate eligibility according to established criteria. The Node Registration Handler 2318 can coordinate the onboarding process for new master nodes, including stake verification and IP address validation. In some cases, the Node Registration Handler 2318 can assign entry timestamps to newly qualified nodes and can add them to the master composition for scheduling purposes.

The SDPoES Consensus Framework 2302 also includes a Block Production Controller 2320 that manages the creation, validation, and synchronization of blocks within the distributed ledger system. The Block Production Controller 2320 can coordinate block production activities among scheduled master nodes and can ensure compliance with consensus requirements. In some cases, the Block Production Controller 2320 can enforce a two-thirds consensus threshold requirement for block validation and acceptance.

A Block Creation Engine 2322 operates within the Block Production Controller 2320 to manage the creation of new blocks according to the established production schedule. The Block Creation Engine 2322 can coordinate with scheduled master nodes to facilitate block generation within the designated time windows. In some cases, the Block Creation Engine 2322 can ensure that blocks are created according to the sequential ordering established by the Dynamic Scheduling Engine 2304.

A Consensus Validator 2324 connects to the Block Creation Engine 2322 and can validate that blocks meet the required consensus thresholds before acceptance into the ledger. The Consensus Validator 2324 can evaluate block validation responses from participating master nodes to determine whether the two-thirds consensus requirement has been satisfied. In some cases, the Consensus Validator 2324 can reject blocks that fail to achieve adequate consensus and can trigger the next scheduled node to produce a replacement block.

A Network Synchronizer 2326 connects to the Consensus Validator 2324 and can ensure synchronization of block data across all participating nodes in the network. The Network Synchronizer 2326 can propagate validated blocks to all master nodes and can maintain consistency of the distributed ledger across the network. In some cases, the Network Synchronizer 2326 can coordinate with the Node Performance Monitor 2308 to identify and address synchronization issues among network participants.

The SDPoES Consensus Framework 2302 also includes a Master Node Pool 2328 that stores information about available master nodes within the network. The Master Node Pool 2328 can maintain records of qualified master nodes, including their stake status, performance metrics, and availability for block production. The Master Node Pool 2328 can connect to components such as the Node Registration Handler 2318, the Block Creation Engine 2322, and the Network Synchronizer 2326 to coordinate master node management across the framework components.

An Active Production List 2330 maintains a current roster of nodes actively participating in block production operations. The Active Production List 2330 can connect to components such as the Production Timer 2310, the Node Registration Handler 2318, and the Network Synchronizer 2326 to coordinate scheduling and production activities. In some cases, the Active Production List 2330 can be updated dynamically to reflect changes in node availability and performance status.

A Performance Metrics Database 2332 can connect to the Node Performance Monitor 2308, for example, and can store performance data for nodes within the network. The Performance Metrics Database 2332 can maintain historical records of node performance, including block production success rates, response times, and reliability metrics. The Round Manager 2306 can also connect to the Performance Metrics Database 2332 to access performance information for scheduling decisions, and to the Active Production List 2330 to coordinate block production rounds among active nodes.

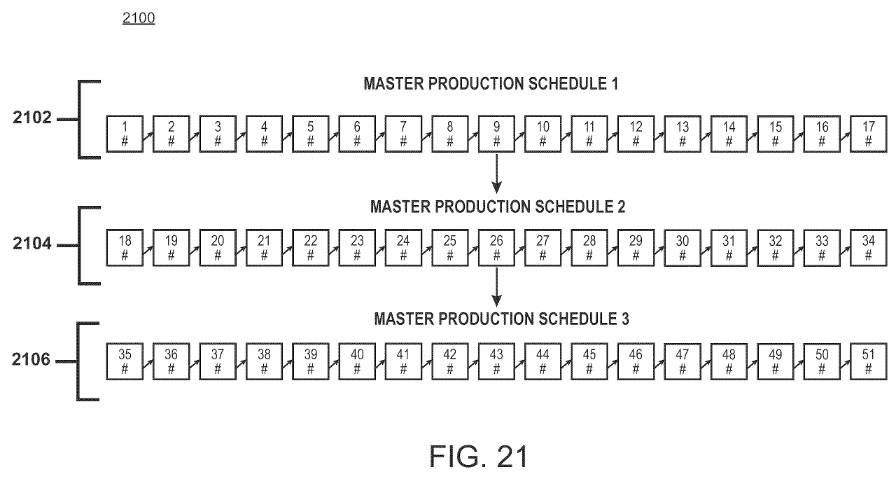

Referring now to FIG. 21, a master production cycle 2100 illustrates the sequential organization of block production rounds within the SDPoES consensus mechanism. The master production cycle 2100 demonstrates how master nodes are organized into structured production sequences that ensure equal participation and fair distribution of block production responsibilities across the network. The master production cycle 2100 comprises multiple distinct production rounds that rotate through different groups of master nodes to maintain decentralized consensus operations.

The master production cycle 2100 includes a first master production round 2102 positioned at the top of the diagram, which includes a sequence of seventeen numbered blocks arranged horizontally from left to right. Each block in this first master production round 2102 is labeled 1 through 17, denoting the sequence of block production in this round. The blocks in this first round of production 2102 are connected by arrows indicating the progression of block production (from block 1 through block 17) through the round, demonstrating the sequential nature of block creation within each production round.

A second master production round 2104 is positioned in the middle of the diagram and similarly comprises seventeen numbered blocks arranged in a horizontal sequence. The blocks in this second master production round 2104 are also numbered sequentially, continuing the production sequence from the first master production round 2102. Each block in this second master production round 2104 is connected to adjacent blocks by directional arrows showing the flow of block production, maintaining the structured progression established in the previous round.

Lastly, a third master production round 2106 is shown positioned at the bottom of the diagram and it too contains seventeen numbered blocks arranged horizontally in the same pattern as the previous rounds. The blocks in this round 2106 follow the same structural configuration as the previous master production rounds 2102, 2104, with sequential numbering and directional arrows connecting adjacent blocks. This third master production round 2106 represents the continuation of the production cycle following completion of the second master production round 2104.

Vertical arrows extend downward between the rounds within the master production cycle 2100, indicating transitions and connections between consecutive production rounds. A vertical arrow extends from the middle block of the first master production round 2102 to demonstrate the progression to the second master production round 2104. Similarly, a vertical arrow extends from the middle block of the second master production round 2104 to show the transition to the third master production round 2106, illustrating how the production cycle flows through multiple rounds of block creation.

The master production cycle 2100 demonstrates the rotation mechanism whereby master nodes participate in block production across multiple rounds, with each round in this example comprising exactly seventeen sequential block production slots. The production list includes exactly seventeen active master nodes that are rotated dynamically based on performance metrics and entry times. In some cases, the master production cycle 2100 can ensure that all qualified master nodes receive equal opportunities to participate in block production through the structured rotation of production rounds.

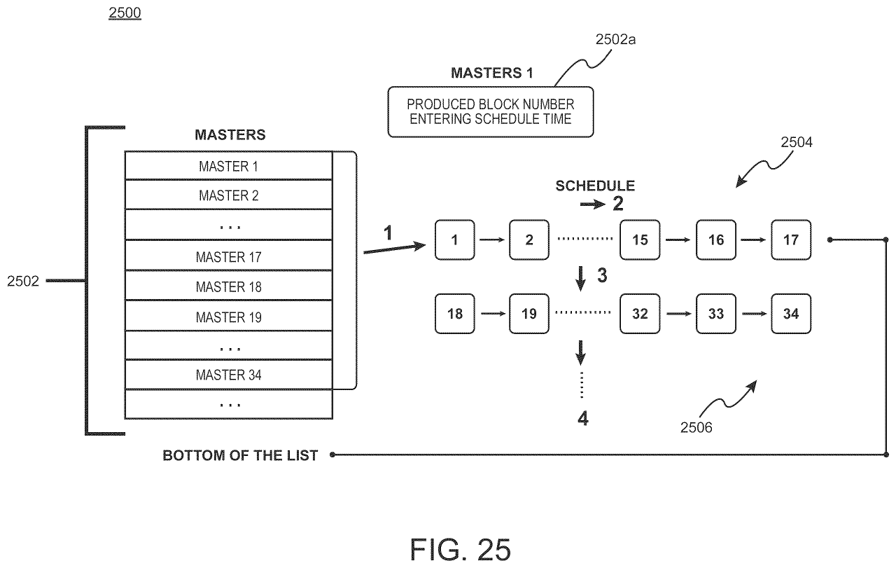

Referring now to FIG. 25, a dynamic consensus scheduling diagram 2500 illustrates the process of master node scheduling and block production coordination within the SDPoES consensus mechanism. The dynamic consensus scheduling diagram 2500 demonstrates how master nodes are selected, organized, and rotated through production schedules to maintain fair participation and efficient block creation across the distributed network.

The dynamic consensus scheduling diagram 2500 includes master nodes 2502 organized into a list structure. The master nodes 2502 include multiple master nodes arranged in sequential order, including master node 1 2502a shown at the top of the list, followed by additional master nodes numbered sequentially through the available pool of qualified nodes. The master nodes 2502 represent the complete pool of qualified master nodes available for participation in block production operations.

A round 1 schedule 2504 comprises a sequence of numbered blocks, including blocks 1 through 17, connected by arrows indicating the sequential flow of block production within the first production round. The round 1 schedule 2504 demonstrates how the first seventeen master nodes from the master nodes 2502 are selected for block production, with master node 1 2502a scheduled to produce block 1, and subsequent master nodes assigned to produce blocks 2 through 17 in sequential order.

Following completion of the round 1 schedule 2504, the scheduling process proceeds to a round 2 schedule 2506, which includes blocks 18 through 34. These blocks are connected by arrows showing the progression of block production in the second round. The round 2 schedule 2506 demonstrates the continuation of the production cycle with the next group of seventeen master nodes from the list of master nodes 2502, ensuring that additional qualified nodes receive opportunities for block production participation.

The dynamic consensus scheduling diagram 2500 includes numbered arrows that indicate the flow of the scheduling process, showing how nodes are selected from the list of master nodes 2502, participate in block production through the round 1 schedule 2504 and the round 2 schedule 2506, and then cycle back to allow other nodes to participate in subsequent rounds. A return path extends from the end of the round 1 schedule 2504 back to the bottom of the master nodes 2502 list, illustrating the cyclical nature of the scheduling process.

Master nodes are organized into rounds and cycles, where each round represents a sequence of seventeen blocks produced by designated nodes, and cycles encompass multiple rounds to establish comprehensive scheduling patterns. The scheduling criteria prioritize nodes with lower production times and better performance metrics to ensure efficient block creation and network reliability. In some cases, the Dynamic Scheduling Engine 2304 (FIG. 23) can coordinate with the Round Manager 2306 (FIG. 23) to implement these scheduling criteria and maintain optimal network performance.

The total number of rounds within a complete cycle can vary, and can be calculated using the mathematical formula: Total Rounds per Cycle=Total Master Nodes (n)/Nodes per Round (17). For example, in a network with 170 master nodes, the cycle would comprise 10 rounds, with each round consisting of seventeen master nodes participating in block production. Notably, this mathematical relationship ensures that all qualified master nodes receive equal opportunities for participation across complete production cycles.

Schedules can be updated after each round based on node performance metrics evaluated by the Node Performance Monitor 2308 (FIG. 23) and stored in the Performance Metrics Database 2332 (FIG. 23). The Round Manager 2306 (FIG. 23) can access performance information to make scheduling decisions for subsequent rounds, ensuring that nodes with better performance metrics receive appropriate scheduling priority. In some cases, the Active Production List 2330 (FIG. 23) can be updated dynamically to reflect changes in node availability and performance status, maintaining the accuracy of the scheduling process across production cycles.

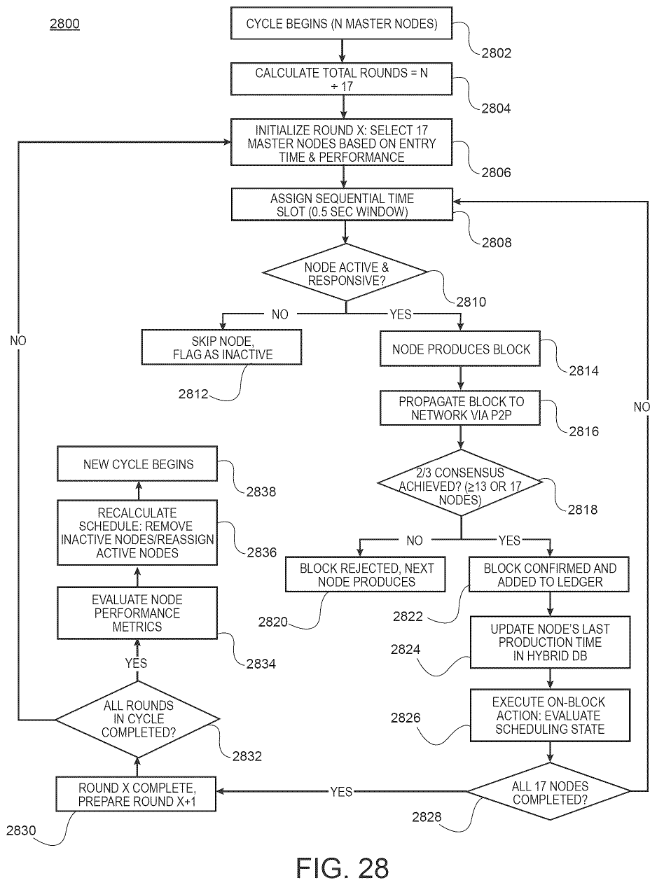

Referring now to FIG. 28, a method 2800 illustrates the comprehensive SDPoES consensus mechanism process for dynamic scheduling and block production operations within the distributed ledger system. The method 2800 demonstrates the complete workflow from cycle initialization through block validation and schedule recalculation, encompassing the automated processes that maintain network consensus and ensure equitable participation among master nodes.

The method 2800 begins with step 2802, where a cycle begins with n master nodes available for participation in block production operations. The value of n represents the total number of qualified master nodes within the network that have satisfied the staking requirements and connectivity standards established by the Stake Validation System 2312 (FIG. 23). In some cases, step 2802 can initialize the production cycle with all master nodes that have been validated through the Node Registration Handler 2318 (FIG. 23) and added to the Master Node Pool 2328 (FIG. 23).

The method 2800 then proceeds to step 2804, which calculates the total rounds using the mathematical formula n÷17. This calculation determines how many production rounds will be required to provide equal participation opportunities for all qualified master nodes within the complete cycle. In some cases, step 2804 can ensure that the cycle structure accommodates all available master nodes through systematic division into seventeen-node production rounds, with any remainder nodes being incorporated into subsequent cycles.

Following the round calculation, the method 2800 continues to step 2806, which initializes Round X by selecting seventeen master nodes based on entry time and performance metrics. The Round Manager 2306 (FIG. 23) can coordinate this selection process by accessing data from the Performance Metrics Database 2332 (FIG. 23) to identify the most suitable nodes for the current production round. In some cases, step 2806 can prioritize nodes with lower production times and better performance metrics to ensure efficient block creation and network reliability.

The method 2800 then moves to step 2808, which assigns sequential time slots with 0.5 second windows to each selected node within the seventeen-node production group. The Production Timer 2310 (FIG. 23) can coordinate these time slot assignments to ensure that each master node receives a designated window for block creation. In some cases, step 2808 can establish the 0.5 second time window (or another designated time window) for packet formation to ensure high throughput and minimal delay between block productions, enabling the network to process substantial numbers of transactions in real-time or near real-time applications.

Following time slot assignment, the method 2800 proceeds to step 2810, which determines whether a node is active and responsive within its designated time window. The Node Performance Monitor 2308 (FIG. 23) can evaluate node responsiveness through ping checks and connectivity assessments to verify that scheduled nodes can participate in block production. In some cases, step 2810 can utilize artificial intelligence driven mechanisms to ensure inclusion of the most stable nodes in each round, enhancing network reliability and reducing the likelihood of latency or exploitation.

If the node is not active or responsive, the method 2800 can proceed to step 2812, which skips the node and flags the node as inactive for future scheduling considerations. The Active Production List 2330 (FIG. 23) can be updated to reflect the inactive status of the skipped node, preventing the node from disrupting the block production sequence. In some cases, step 2812 can enable the Dynamic Scheduling Engine 2304 (FIG. 23) to maintain production continuity by excluding unresponsive nodes from the current round.

If the node is active and responsive, the method 2800 moves to step 2814, where the node produces a block according to the established production schedule. The Block Creation Engine 2322 (FIG. 23) can coordinate with the scheduled master node to facilitate block generation within the designated 0.5 second time window. In some cases, step 2814 can ensure that blocks are created according to the sequential ordering established by the Dynamic Scheduling Engine 2304 (FIG. 23) and contain the appropriate transaction data and validation information.

The method 2800 then proceeds to step 2816, where the block is propagated to the network via peer-to-peer communication protocols. The Network Synchronizer 2326 (FIG. 23) can coordinate the distribution of the newly created block to all participating master nodes for validation and consensus evaluation. In some cases, step 2816 can utilize the mesh-like network topology demonstrated in the node state flowchart 2400 (FIG. 24) to ensure efficient block propagation across the distributed network.

Following block propagation, the method 2800 reaches step 2818, which evaluates whether two-thirds consensus has been achieved with at least thirteen of the seventeen nodes in the current production round. The Consensus Validator 2324 (FIG. 23) can assess the validation responses from participating master nodes to determine whether the consensus threshold has been satisfied. In some cases, step 2818 can implement the consensus mechanism that requires two-thirds confirmation for block validation, which can equate to approximately 667 nodes in networks with 1000+ master nodes, though the immediate validation occurs within the seventeen-node production group.

If consensus is not achieved, the method 2800 moves to step 2820, where the block is rejected and the next node produces a block according to the established sequence. The Block Production Controller 2320 (FIG. 23) can coordinate the transition to the next scheduled node to maintain production continuity despite the rejected block. In some cases, step 2820 can ensure that block production continues without significant delays by immediately proceeding to the next available node in the production sequence.

If consensus is achieved, the method 2800 proceeds to step 2822, which confirms and adds the block to the ledger as an irreversible transaction. The validated block becomes part of the permanent distributed ledger record and can be synchronized across all network participants. In some cases, step 2822 ensures the integrity of the ledger by incorporating only blocks that have achieved the required two-thirds consensus threshold among the participating master nodes.

Following successful block confirmation, the method 2800 moves to step 2824, which updates the node's last production time in the Hybrid DB. The Performance Metrics Database 2332 (FIG. 23) can record the successful block production activity to maintain accurate performance records for future scheduling decisions. In some cases, step 2824 can provide the Round Manager 2306 (FIG. 23) with updated performance data for subsequent round planning and node selection processes.

The method 2800 can then proceed to step 2826, which executes an on-block action to evaluate the scheduling state and coordinate subsequent production activities. This on-block action can trigger automatically each time a block is applied to the ledger and can assess the current status of the production round. In some cases, step 2826 can request the removal of inactive nodes to ensure they do not participate in future rounds and can assign new brackets of master nodes responsible for block creation in upcoming scheduling cycles.

The method 2800 then reaches step 2828, which determines whether all seventeen nodes have completed their assigned tasks within the current production round. The Round Manager 2306 (FIG. 23) can track the progress of block production activities to determine when the current round has been completed. In some cases, step 2828 can evaluate whether each of the seventeen selected master nodes has had the opportunity to produce a block or has been appropriately skipped due to inactivity.

If not all nodes have completed their assignments, the method 2800 can return to step 2808 to continue the current round with the next scheduled node in the sequence. This return path ensures that all seventeen nodes in the production group receive their designated opportunities for block production. The method 2800 can continue cycling through the seventeen-node group until all active nodes have participated or been appropriately handled according to their responsiveness status.

If all seventeen nodes have completed their assignments, the method 2800 moves to step 2830, which marks Round X as complete and prepares Round X+1 for initialization. The completion of the current round triggers the preparation of the subsequent production round with a new group of seventeen master nodes. In some cases, step 2830 can coordinate with the Dynamic Scheduling Engine 2304 (FIG. 23) to transition smoothly between production rounds without interrupting the overall block production flow.

The method 2800 then proceeds to step 2832, which determines whether all rounds in the cycle are complete based on the calculation performed in step 2804. The Round Manager 2306 (FIG. 23) can evaluate whether the total number of required rounds has been completed to provide equal participation opportunities for all qualified master nodes. In some cases, step 2832 can assess whether the complete cycle has provided each master node in the network with appropriate opportunities for block production participation.

If not all rounds are complete, the method 2800 returns to step 2806 to initialize the next round with a new group of seventeen master nodes selected from the remaining qualified participants. This return path ensures that the cycle continues until all master nodes have received equal opportunities for participation. In some cases, the method 2800 can continue cycling through different groups of seventeen nodes until the complete master node pool has been accommodated within the production cycle.

If all rounds are complete, the method 2800 can proceed to step 2834, which evaluates node performance metrics accumulated during the completed cycle. The Node Performance Monitor 2308 (FIG. 23) can assess performance data stored in the Performance Metrics Database 2332 (FIG. 23) to identify nodes that have met or failed to meet established performance standards. In some cases, step 2834 can evaluate metrics such as block production success rates, response times, and reliability indicators to determine node eligibility for subsequent cycles.

Following performance evaluation, the method 2800 can move to step 2836, which recalculates the schedule by removing inactive nodes and reassigning active nodes for the next production cycle. The Round Manager 2306 (FIG. 23) can coordinate with the Master Node Pool 2328 (FIG. 23) to update the roster of qualified participants based on performance assessments. In some cases, step 2836 can ensure that nodes failing to meet performance criteria are excluded from future cycles while maintaining opportunities for improved nodes to rejoin through the rejoining mechanisms established by the system value contract(s) 2222 (FIG. 22).

The method 2800 can conclude with step 2838, where a new cycle begins with the updated roster of qualified master nodes, returning the process to the initial state established in step 2802. This cyclical structure ensures continuous block production operations while maintaining the equal participation principles of the SDPoES consensus mechanism. In some cases, step 2838 can initiate the next production cycle with an updated value of n master nodes that reflects the performance-based adjustments made during the schedule recalculation process, ensuring that the network maintains optimal performance and reliability across successive production cycles.

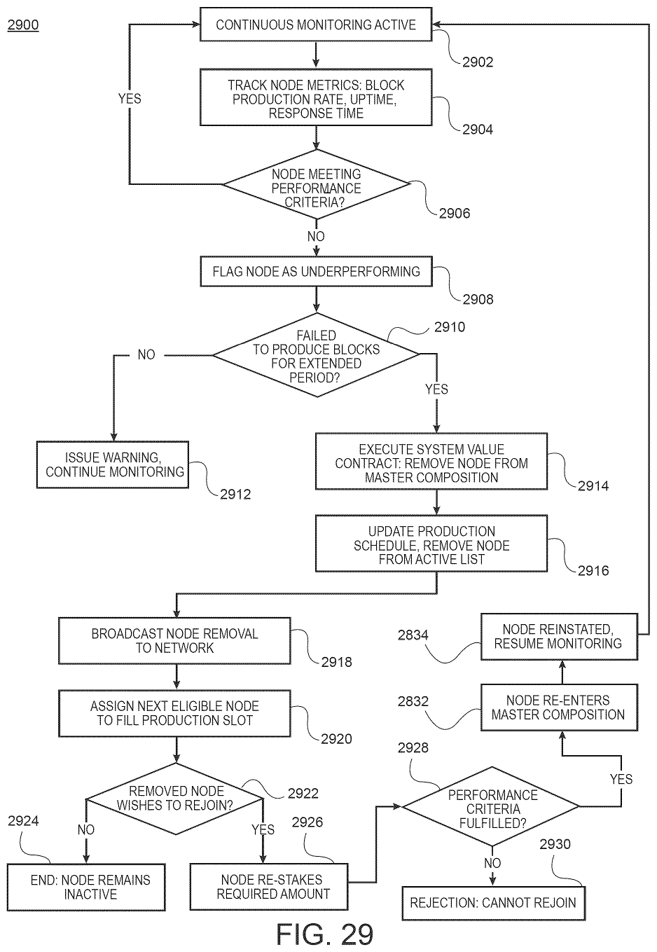

Referring now to FIG. 29, method 2900 illustrates an automated node performance monitoring and management process within the SDPoES consensus framework. Method 2900 demonstrates comprehensive procedures for maintaining network integrity through continuous performance assessment, automated node removal mechanisms, and controlled rejoin processes that ensure only qualified nodes participate in consensus operations.

Method 2900 begins with step 2902, where continuous monitoring is activated for all master nodes in the network. The Node Performance Monitor 2308 (FIG. 23) can coordinate this continuous monitoring process to maintain real-time awareness of node status and performance across the distributed network. In some cases, step 2902 can establish baseline monitoring protocols that track multiple performance indicators simultaneously to provide comprehensive assessment of node reliability and functionality.

Method 2900 then proceeds to step 2904, which involves tracking node metrics including block production rate, uptime, and response time for each participating node. The Performance Metrics Database 2332 (FIG. 23) can store these performance measurements to maintain historical records of node behavior and reliability patterns. In some cases, step 2904 can also track stake compliance and network interconnection metrics, with different weighting factors applied to each metric category to reflect their relative importance in overall performance assessment.

Block production rate can be measured as the frequency at which a node successfully produces blocks, and this metric may be highly weighted as consistent block production maintains ledger integrity and ensures smooth network functioning. Uptime can reflect the duration a node remains online and operational, with higher uptime values indicating greater reliability, and this metric may also be highly weighted to emphasize the importance of continuous participation in network operations.

Response time can evaluate how quickly a node validates transactions and propagates blocks, and while this parameter might not be weighted as heavily as block production or uptime, for example, response time can play a role in ensuring fast and efficient transaction processing. Stake compliance can assess whether a node maintains the required stake amount, which can be moderately weighted to signify the node's commitment to network security and integrity within the SDPoES framework.

Network interconnection can measure the level of connectivity a node maintains with other peer nodes in the network, and this metric may be moderately weighted as nodes with strong interconnections enhance data propagation and maintain robust network topology. The different weighting factors applied to these metrics can enable the Node Performance Monitor 2308 (FIG. 23) to calculate comprehensive performance scores that accurately reflect each node's contribution to network operations.

Method 2900 then moves to step 2906, where the system determines whether a node is meeting the established performance criteria based on the weighted metrics collected in step 2904. The Node Performance Monitor 2308 (FIG. 23) can evaluate the performance data against predetermined thresholds to identify nodes that may be underperforming or failing to meet network standards. In some cases, step 2906 can utilize automated assessment algorithms that compare current performance metrics against historical baselines and network-wide performance standards.

If the node meets the performance criteria, method 2900 returns to step 2902 to continue monitoring operations, maintaining the continuous assessment cycle for all participating master nodes. If the node fails to meet the performance criteria, method 2900 proceeds to step 2908, where the node is flagged as underperforming for further evaluation and potential remedial action.

Following the flagging process, method 2900 advances to step 2910, which evaluates whether the node has failed to produce blocks for an extended period. The Block Production Controller 2320 (FIG. 23) can assess the node's recent block production history to determine if the failure pattern warrants removal from the master composition. In some cases, step 2910 can establish specific time thresholds or consecutive failure counts that trigger automatic removal procedures to maintain network efficiency.

If the node has not failed for an extended period, method 2900 moves to step 2912, where a warning can be issued and monitoring continues with increased scrutiny of the flagged node's performance. This warning mechanism can provide nodes with opportunities to address performance issues before facing removal from the master composition. In some cases, step 2912 can implement graduated response protocols that escalate monitoring intensity for nodes showing declining performance trends.

If the node has failed for an extended period, method 2900 proceeds to step 2914, where a system value contract is executed to remove the node from the master composition. The system value contract(s) 2222 (FIG. 22) can enforce automatic node removal procedures to maintain network efficiency and prevent delays in block production caused by consistently underperforming nodes. In some cases, step 2914 can trigger the automated removal mechanism that eliminates nodes failing to meet production standards from the Active Production List 2330 (FIG. 23).

The removal process continues with step 2916, where the production schedule is updated and the node is removed from the active list maintained by the Round Manager 2306 (FIG. 23). The Dynamic Scheduling Engine 2304 (FIG. 23) can coordinate the schedule adjustment to ensure that block production continues without interruption despite the node removal. In some cases, step 2916 can immediately update the Master Node Pool 2328 (FIG. 23) to reflect the changed composition of qualified participants.

Method 2900 then moves to step 2918, where the node removal is broadcast to the network to inform all participating nodes of the composition change. The Network Synchronizer 2326 (FIG. 23) can coordinate this broadcast to ensure that all master nodes receive updated information about the current roster of active participants. In some cases, step 2918 can utilize the mesh-like network topology to efficiently propagate removal notifications across the distributed network.

Subsequently, step 2920 assigns the next eligible node to fill the production slot previously occupied by the removed node. The Node Registration Handler 2318 (FIG. 23) can coordinate the selection of replacement nodes from the pool of qualified candidates to maintain the seventeen-node production group structure. In some cases, step 2920 can ensure continuity of block production operations by immediately integrating replacement nodes into the established production schedule.

Next, method 2900 proceeds to step 2922, which determines whether the removed node wishes to rejoin the network through the established rejoining mechanism. This decision point can provide pathways for nodes to restore their status after addressing performance issues that led to their removal. In some cases, step 2922 can implement time-based restrictions or cooling-off periods before allowing removed nodes to attempt rejoining the master composition.

If the node does not wish to rejoin, method 2900 moves to step 2924, where the node remains inactive and the process ends for that particular node. The node can maintain its inactive status indefinitely or until it chooses to pursue rejoining through the established procedures. In some cases, step 2924 can maintain records of inactive nodes for potential future reintegration if network conditions or node performance capabilities change.

If the node wishes to rejoin, method 2900 advances to step 2926, where the node re-stakes the required amount according to the memory staking requirements established by the Memory Stake Verifier 2314 (FIG. 23). The rejoining node can demonstrate renewed commitment to network participation by satisfying the same staking requirements applied to new master node candidates. In some cases, step 2926 can require the rejoining node to stake the predetermined minimum amount, such as 50,000 INR(TM) tokens, to re-qualify for master node status.

Following the re-staking process, method 2900 moves to step 2928, which evaluates whether the performance criteria have been fulfilled by the rejoining node. The Static IP Validator 2316 (FIG. 23) can verify that the node maintains proper network connectivity, while the Node Performance Monitor 2308 (FIG. 23) can assess whether the node has addressed the performance issues that led to its previous removal. In some cases, step 2928 can implement probationary monitoring periods to verify sustained performance improvement before full reintegration.

If the performance criteria are not fulfilled, method 2900 proceeds to step 2930, where the rejoin request is rejected and the node cannot rejoin the master composition. This rejection mechanism can ensure that nodes demonstrate genuine performance improvements before being allowed to resume participation in consensus operations. In some cases, step 2930 can provide feedback to rejected nodes regarding specific performance deficiencies that must be addressed for future rejoin attempts.

If the performance criteria are fulfilled, method 2900 advances to step 2932, where the node re-enters the master composition with updated status and performance records. The Node Registration Handler 2318 (FIG. 23) can coordinate the reintegration process to ensure that the rejoining node is properly incorporated into the production scheduling system. In some cases, step 2932 can assign new entry timestamps to rejoining nodes to establish their position in the production rotation sequence.

Method 2900 concludes the rejoin process with step 2934, where the node is reinstated and monitoring resumes according to the continuous assessment protocols established in step 2902. The reinstated node can participate in block production operations according to the scheduling protocols managed by the Round Manager 2306 (FIG. 23). In some cases, step 2934 can implement enhanced monitoring for recently rejoined nodes to ensure sustained performance improvement and network reliability.

The automated node performance monitoring and management process demonstrated by method 2900 provides multiple safeguards to prevent bottlenecks and single points of failure within the SDPoES consensus framework. Node rotation and redundancy can be maintained through the Dynamic Scheduling Engine 2304 (FIG. 23), which ensures that no single node is responsible for excessive consecutive block productions, with master nodes rotated after each block production to prevent overloading and ensure fair participation across the network.

Active node monitoring can be implemented through the continuous assessment protocols established in step 2902, where the Node Performance Monitor 2308 (FIG. 23) can utilize ping checks to determine node activity and can identify inactive or unresponsive nodes that may disrupt block production continuity. If a node is inactive or fails to produce a block, the node can be skipped and replaced by the next active node to ensure that the network can continue producing blocks despite unresponsive participants.

Failure detection and recovery can be coordinated through the automated removal and rejoining mechanisms demonstrated in steps 2914 through 2934, where nodes that fail to produce blocks for specified periods are removed from the production schedule to prevent persistent failures from disrupting network operations. Inactive nodes can rejoin once they become active again through the controlled rejoining process, ensuring smooth recovery while maintaining performance standards.

Distributed consensus can be maintained through the SDPoES Consensus Framework 2302 (FIG. 23), which prevents any single node from having excessive influence over the consensus process by requiring cooperation from a majority of nodes, such as two-thirds of seventeen nodes per round, ensuring that control is distributed across the network and reducing the risk of single points of failure.

Geographic distribution can be facilitated through the mesh-like network topology demonstrated in the node state flowchart 2400 (FIG. 24), where nodes can be geographically distributed to ensure that regional latency or failure conditions do not significantly impact overall network performance, allowing the distributed network to continue operating despite localized disruptions or connectivity issues.

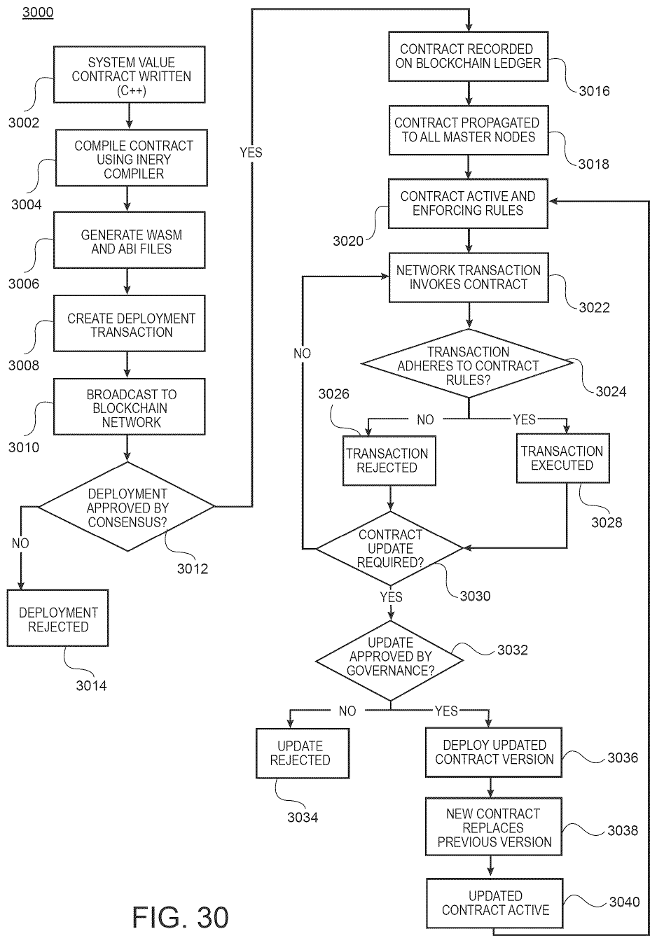

Referring now to FIG. 30, method 3000 illustrates a system value contract deployment and execution process within the blockchain network. Method 3000 demonstrates the complete lifecycle of system value contracts, including deployment, execution, validation, and updating processes that ensure proper governance and enforcement of network rules within the SDPoES consensus framework.

Method 3000 begins with step 3002, where a system value contract is written in C++ , for example. The contract code can define the validation and integrity rules that govern master node behavior, staking requirements, and consensus participation protocols within the distributed ledger system. In some cases, step 3002 can involve developing smart contract logic that specifies stake verification rules, performance monitoring criteria, and automated node removal procedures according to the SDPoES consensus mechanism requirements.

Method 3000 proceeds to step 3004, which involves compiling the contract using a compiler, such as an Inery(TM) compiler. The compiler 2604 (FIG. 26) can be configured to process the C++ contract code to transform the source code into executable formats suitable for blockchain deployment and execution. In some cases, step 3004 can utilize specialized compilation processes that optimize the contract code for distributed ledger environments and ensure compatibility with the network's execution infrastructure.

Step 3006 follows, where WASM and ABI files are generated from the compilation process. The WASM 2606 (FIG. 26) can represent the WebAssembly format of the compiled contract, providing a portable and efficient execution format for blockchain environments. The ABI files 2608 (FIG. 26) can contain Application Binary Interface specifications that define interaction protocols for the compiled contract, enabling external applications and network components to communicate with the deployed contract.

Method 3000 then moves to step 3008, where a deployment transaction is created for the contract. The deployment transaction can encapsulate the compiled WASM 2606 (FIG. 26) and ABI files 2608 (FIG. 26) in a format suitable for blockchain network transmission and processing. In some cases, step 3008 can include metadata and configuration parameters that specify the contract's operational parameters and deployment requirements within the distributed ledger system.

Step 3010 involves broadcasting the deployment transaction to the blockchain network for consensus evaluation and approval. The Network Synchronizer 2326 (FIG. 23) can coordinate the propagation of the deployment transaction to all participating master nodes for validation and consensus determination. In some cases, step 3010 can utilize the mesh-like network topology to ensure efficient distribution of the deployment transaction across the distributed network infrastructure.

Method 3000 then reaches step 3012, which presents a decision point asking whether the deployment is approved by consensus among the participating master nodes. The Consensus Validator 2324 (FIG. 23) can evaluate the validation responses from master nodes to determine whether the deployment transaction has achieved the required consensus threshold for approval. In some cases, step 3012 can implement the two-thirds consensus requirement that governs block validation and contract deployment decisions within the SDPoES consensus mechanism.

If the deployment is not approved, method 3000 proceeds to step 3014, where the deployment is rejected and the contract cannot be activated within the network. The rejection can prevent improperly validated or potentially harmful contracts from being deployed to the blockchain network. In some cases, step 3014 can provide feedback regarding the specific reasons for deployment rejection, enabling contract developers to address validation issues and resubmit improved contract versions.

If the deployment is approved, method 3000 moves to step 3016, where the contract is recorded on the blockchain ledger as a permanent and immutable record. The validated contract becomes part of the distributed ledger infrastructure and can be referenced by network operations and transaction processing activities. In some cases, step 3016 can ensure that the contract deployment is synchronized across all participating nodes to maintain consistency of the blockchain ledger.

Following successful deployment, step 3018 involves propagating the contract to all master nodes in the network to ensure uniform availability and execution capability. The Master Node Pool 2328 (FIG. 23) can coordinate the distribution of the deployed contract to all qualified master nodes for local storage and execution preparation. In some cases, step 3018 can verify that each master node has successfully received and validated the contract deployment before proceeding to activation.

Step 3020 follows, where the contract becomes active and begins enforcing rules according to the validation and integrity specifications defined in the contract code. The system value contract(s) 2222 (FIG. 22) can begin monitoring network operations and enforcing compliance with the predefined conditions for staking, validation, and consensus participation. In some cases, step 3020 can activate automated enforcement mechanisms that continuously evaluate network transactions and node behavior against the contract specifications.

Method 3000 then proceeds to step 3022, where a network transaction invokes the contract during normal network operations. Network participants can interact with the deployed contract through transaction submissions that trigger contract execution and rule evaluation. In some cases, step 3022 can involve various types of network transactions, including staking operations, node registration requests, and block production activities that must comply with the contract specifications.

Step 3024 presents another decision point, determining whether the transaction adheres to the contract rules established during the deployment process. The Block Production Controller 2320 (FIG. 23) can coordinate the evaluation of transaction compliance against the contract specifications to ensure proper rule enforcement. In some cases, step 3024 can implement automated validation processes that assess transaction parameters, node qualifications, and operational compliance against the predefined contract criteria.

If the transaction does not adhere to the rules, method 3000 moves to step 3026, where the transaction is rejected and cannot be processed by the network. The rejection mechanism can prevent non-compliant operations from affecting network integrity and consensus operations. In some cases, step 3026 can provide detailed feedback regarding the specific rule violations that caused the transaction rejection, enabling network participants to correct compliance issues and resubmit valid transactions.

If the transaction adheres to the rules, method 3000 proceeds to step 3028, where the transaction is executed according to the contract specifications and network protocols. The validated transaction can be processed and incorporated into the blockchain ledger as an approved network operation. In some cases, step 3028 can trigger additional contract actions, such as updating node performance records or adjusting production schedules based on the executed transaction.

Both step 3026 and step 3028 lead to step 3030, which presents a decision point asking whether a contract update is required to modify the existing contract specifications or functionality. Contract updates may be needed to address changing network requirements, performance optimizations, or governance policy modifications. In some cases, step 3030 can be triggered, for example, by governance proposals, network performance assessments, and/or identified deficiencies in the current contract implementation.

If no update is required, method 3000 returns to step 3022 to continue processing network transactions according to the existing contract specifications. This return path can maintain continuous contract enforcement and transaction processing operations without interruption. In some cases, method 3000 can continue operating with the current contract version until governance decisions or network conditions necessitate contract modifications.

If an update is required, method 3000 moves to step 3032, which determines whether the update is approved by governance mechanisms established within the network. The governance approval process can ensure that contract modifications receive appropriate consensus and authorization before implementation. In some cases, step 3032 can implement voting mechanisms or consensus requirements that enable network participants to evaluate and approve proposed contract changes.

If the update is not approved, method 3000 proceeds to step 3034, where the update is rejected and the existing contract continues operating without modification. The rejection mechanism can prevent unauthorized or potentially harmful contract modifications from being implemented within the network. In some cases, step 3034 can maintain the stability and reliability of existing contract operations while providing pathways for improved update proposals to be developed and submitted.

If the update is approved, method 3000 moves to step 3036, where an updated contract version is deployed through the same deployment process established in earlier steps. The updated contract can incorporate the approved modifications while maintaining compatibility with existing network operations and infrastructure. In some cases, step 3036 can utilize the same compilation and deployment procedures demonstrated in steps 3004 through 3018 to ensure proper validation and distribution of the updated contract version.

Step 3038 follows, where the new contract replaces the previous version within the blockchain network infrastructure. The replacement process can ensure seamless transition from the old contract to the updated version without disrupting ongoing network operations. In some cases, step 3038 can implement version control mechanisms that maintain records of previous contract versions while activating the updated contract specifications.

Method 3000 then proceeds to step 3040, where the updated contract becomes active and begins enforcing the modified rules and specifications. The updated contract can implement the approved changes while maintaining continuity of network governance and rule enforcement functions. In some cases, step 3040 can coordinate with the Dynamic Scheduling Engine 2304 (FIG. 23) and other network components to ensure that the updated contract specifications are properly integrated into ongoing consensus operations.

From step 3040, method 3000 returns to step 3020, creating a continuous loop that allows the updated contract to begin enforcing rules and processing transactions according to the modified specifications. This cyclical structure can ensure that contract updates are properly integrated into network operations while maintaining the continuous enforcement and transaction processing capabilities established by the system value contract deployment and execution process.

The SDPoES consensus mechanism described herein demonstrates scalability characteristics that enable networks to accommodate up to 1,000 or more master nodes while maintaining operational efficiency and minimal latency degradation. The scalability architecture addresses the computational and communication challenges inherent in large-scale distributed networks through systematic optimization of network topology and dynamic parameter adjustment mechanisms.

Network scalability testing has demonstrated performance characteristics across varying node configurations, with transaction throughput scaling from 1,000 transactions per second in single-node configurations to 3,890 transactions per second in five-node deployments. Testing also shows that query processing capabilities similarly scale from 1,000 queries per second with single nodes to 5,000 queries per second with five-node configurations, demonstrating the system's ability to handle increased computational loads through horizontal scaling approaches.

The total operational capacity combines transaction and query processing to achieve 2,000 operations per second with single-node configurations, 3,700 operations per second with two-node deployments, and 8,890 operations per second with five-node configurations. These performance metrics illustrate the system's capacity to maintain high throughput while scaling across multiple master nodes, supporting enterprise-grade applications that require substantial transaction processing capabilities.

Dynamic block confirmation parameter adjustment occurs when networks reach predetermined node thresholds, such as 100, 500, or 1,000 total network participants. The system herein can monitor network growth and automatically recalibrate consensus requirements to maintain validation efficiency while preserving security standards. Parameter adjustment mechanisms ensure that validation processes remain within acceptable time windows despite increasing network complexity and geographic distribution of participating nodes.

The challenge of achieving efficient block confirmation in large-scale networks was identified during testing phases when networks exceeding 1,000 master nodes required approximately 667 validation confirmations to satisfy the two-thirds consensus requirement. The physical and computational delays associated with transmitting validation packets across geographically dispersed nodes exceeded the established 0.5 second block creation window, creating bottlenecks that could stall block production under original network configurations.

An optimized network topology addresses these scalability challenges by enhancing interconnection pathways between nodes to minimize validation packet propagation time across geographically distributed networks. The topology optimization reduces the time required for validation packets to traverse the network infrastructure, ensuring that block validation processes remain within the designated creation windows even as network size increases substantially.

The optimized topology enables faster communication between nodes through strategic routing and connection management, particularly benefiting geographically dispersed networks where physical distance can introduce significant latency factors. Network interconnection enhancements allow the system to handle virtually unlimited numbers of master nodes without compromising block confirmation efficiency or consensus reliability.

Latency and production timing balance is achieved through active node monitoring mechanisms that can utilize ping-based activity checks to assess node responsiveness in real-time. The system herein prioritizes nodes that can quickly respond and produce blocks within designated time windows, while automatically skipping inactive or unresponsive nodes to maintain production continuity and minimize delays.

Dynamic scheduling protocols herein adapt to node availability by constantly evaluating node activity status and adjusting production sequences accordingly. When nodes experience delays due to high computational loads, network connectivity issues, or geographic distance factors, for example, the system excludes these nodes from current production rounds in favor of more responsive alternatives, ensuring that block production processes continue without significant interruption.

The trade-off management between latency reduction and node participation involves balancing the need for fast block production against maintaining sufficient active nodes to meet production schedules. The system herein avoids extended delays by implementing automated node skipping mechanisms, though this approach may occasionally exclude nodes with slightly higher latency in favor of faster and more reliable participants.

Block production timing maintains consistency through predetermined time slot assignments, such as 0.5 second windows for packet formation, which enable high throughput and minimal delay between consecutive block productions. The short time window design supports real-time and near real-time applications while accommodating the computational requirements of consensus validation across distributed node networks.

Network resilience is maintained through redundancy mechanisms that ensure continuous operation despite individual node failures or temporary unavailability. The system's ability to skip unresponsive nodes and automatically adjust production schedules prevents single points of failure from disrupting overall network performance, while geographic distribution of nodes provides additional protection against regional connectivity issues or infrastructure disruptions.

Scalability optimization extends beyond simple node count increases to encompass comprehensive network performance management that addresses the complex interactions between consensus requirements, geographic distribution, and real-time processing demands. The combination of optimized topology, dynamic parameter adjustment, and intelligent node selection enables the SDPoES consensus mechanism to maintain high performance standards across varying network scales and operational conditions.

The SDPoES consensus mechanism described herein provides substantial advantages over traditional blockchain consensus mechanisms through comprehensive solutions to fundamental deficiencies that limit the effectiveness, scalability, and inclusivity of existing systems. These advantages encompass structural improvements in decentralization, performance optimization, network resilience, and operational flexibility that address the core limitations of conventional consensus approaches.

Equal stake authority within the SDPoES framework prevents centralization risks that commonly affect traditional consensus mechanisms, particularly Delegated Proof of Stake systems that concentrate authority in entities with the highest stakes in native currency. Traditional DPOS systems create power imbalances by favoring nodes with substantial financial resources, leading to oligopolistic control structures that undermine the decentralized principles of blockchain networks. The equal stake distribution approach of SDPoES eliminates these power concentration risks by ensuring that all qualified master nodes receive identical authority levels regardless of their financial capacity beyond the minimum threshold requirement.

The prevention of centralization risks extends beyond simple authority distribution to encompass comprehensive governance structures that eliminate economic monopolization vulnerabilities. Traditional currency-based delegation systems enable wealthy participants to accumulate disproportionate influence through stake accumulation, creating systemic risks of collusion and market manipulation. SDPoES addresses these vulnerabilities by implementing predefined authority structures that cannot be circumvented through financial accumulation, ensuring that network governance remains distributed across all qualified participants rather than concentrated among economic elites.

Dynamic scheduling optimization provides performance advantages that surpass the capabilities of traditional consensus mechanisms through intelligent resource allocation and automated load balancing. Traditional systems often rely on static scheduling approaches that cannot adapt to changing network conditions, node availability fluctuations, or performance variations among participants. The dynamic scheduling protocols of SDPoES continuously evaluate node performance metrics and automatically adjust production sequences to optimize network throughput while maintaining fairness principles.

The performance optimization achieved through dynamic scheduling encompasses real-time responsiveness to network conditions that traditional mechanisms cannot match. When nodes experience temporary performance degradation, connectivity issues, or computational limitations, for example, the SDPoES system automatically redistributes production responsibilities to maintain consistent block creation intervals. This adaptive capability ensures that network performance remains stable despite individual node variations, whereas traditional systems typically experience significant delays or disruptions when scheduled nodes encounter operational difficulties.

Scalability support through robust trade-off mechanisms enables the SDPoES consensus mechanism to accommodate substantially larger networks than traditional systems while maintaining operational efficiency. Traditional consensus mechanisms face exponential complexity increases as network size grows, leading to performance degradation, increased latency, and reduced throughput that limit their practical applicability for large-scale deployments. The SDPoES framework addresses these scalability challenges through systematic parameter adjustment, optimized network topology, and intelligent node selection processes that maintain performance standards across varying network scales.

The robust trade-off mechanisms implemented in SDPoES enable networks to balance competing requirements such as decentralization, security, and performance without sacrificing fundamental operational capabilities. Traditional systems often require significant compromises in one area to achieve improvements in another, such as reducing decentralization to improve performance or sacrificing security to enhance scalability. SDPoES maintains optimal balance across these competing requirements through dynamic adjustment mechanisms that adapt to network conditions while preserving core operational principles.

Static IP address requirements and hybrid database integration ensure reliable operations that exceed the stability and consistency capabilities of traditional consensus mechanisms. Traditional systems often struggle with node identification, network connectivity management, and data consistency issues that can disrupt consensus operations and compromise network reliability. The static IP requirement ensures that master nodes maintain consistent network identities and reliable connectivity, while the hybrid database framework provides robust data management capabilities that support both structured and flexible data operations.

The reliability improvements achieved through static IP addresses and hybrid database integration extend to comprehensive network stability that traditional systems cannot provide. Node connectivity issues, database inconsistencies, and data synchronization problems that commonly affect traditional consensus mechanisms are systematically addressed through the integrated approach of SDPoES. The combination of verified network connectivity and advanced database management ensures that consensus operations continue reliably even under challenging network conditions or high transaction volumes.

As noted above, traditional DPOS systems exhibit centralization tendencies that fundamentally compromise the decentralized principles of blockchain networks through concentration of authority among high-stake participants. These systems create feedback loops where wealthy participants accumulate additional influence through delegation rewards, progressively concentrating power and creating systemic vulnerabilities to collusion and market manipulation. SDPoES eliminates these centralization tendencies by implementing equal authority distribution that cannot be circumvented through financial accumulation or delegation strategies.

The centralization risks in traditional DPOS systems extend beyond simple authority concentration to encompass governance capture scenarios where small groups of high-stake participants can effectively control network decisions and protocol modifications. These governance vulnerabilities can lead to policy decisions that benefit concentrated interests rather than the broader network community, undermining the democratic principles that blockchain networks are intended to embody. SDPoES prevents governance capture through equal participation structures that ensure all qualified nodes have equivalent influence over network decisions and protocol evolution.

Lack of inclusivity in Proof of Work and Proof of Stake systems creates barriers to participation that limit network diversity and compromise decentralization objectives. Indeed, Proof of Work systems require substantial computational resources and energy expenditures that exclude participants without access to specialized hardware and low-cost electricity, creating geographic and economic barriers that concentrate mining operations in specific regions and among well-funded entities. Proof of Stake systems similarly exclude participants who cannot afford to hold substantial amounts of cryptocurrency, limiting validator participation to wealthy individuals and institutions.

The inclusivity limitations of traditional systems extend to operational barriers that prevent smaller participants from meaningful network involvement even when they meet minimum requirements. Complex technical requirements, high operational costs, and sophisticated infrastructure needs create additional barriers that favor large-scale operators over individual participants or smaller organizations. SDPoES addresses these inclusivity challenges by implementing accessible participation requirements that enable broader network involvement while maintaining security and performance standards.

Limited adaptability for enterprise and supply chain use cases represents a fundamental constraint of traditional consensus mechanisms that cannot accommodate the complex requirements of business applications. Enterprise environments require flexible governance structures, customizable business logic integration, and hierarchical authority models that traditional consensus mechanisms cannot provide. Supply chain applications need real-time transaction processing, complex workflow support, and integration capabilities that exceed the capabilities of conventional blockchain consensus approaches.

The adaptability limitations of traditional systems stem from rigid architectural designs that cannot accommodate diverse business requirements or complex operational workflows. Enterprise applications often require hybrid authority structures that combine decentralized consensus with hierarchical management capabilities, while supply chain systems need flexible data models and customizable validation rules that traditional mechanisms cannot support. SDPoES addresses these adaptability requirements through hybrid authority and permission systems that integrate hierarchical authority with custom business logic.

Delegation risks associated with currency-based delegation create systemic vulnerabilities that compromise network security and governance integrity in traditional consensus mechanisms. Currency-based delegation enables economic attacks where malicious actors can temporarily acquire substantial influence through token accumulation or market manipulation, potentially compromising network decisions or consensus operations. These delegation risks extend to long-term governance capture scenarios where persistent economic advantages enable sustained control over network operations.

The delegation vulnerabilities in traditional systems encompass both direct economic attacks and indirect influence mechanisms that can compromise network integrity without obvious malicious activity. Gradual stake accumulation, delegation reward optimization, and strategic alliance formation can enable subtle forms of network control that may not be immediately apparent but can significantly impact network governance and operational decisions over time. SDPoES eliminates these delegation risks through equal participation structures that cannot be circumvented through economic strategies or alliance formation.

True decentralization achieved through SDPoES encompasses comprehensive distribution of authority, responsibility, and influence that exceeds the decentralization capabilities of traditional consensus mechanisms. The equal stake authority model ensures that network control cannot be concentrated among wealthy participants or strategic alliances, while the dynamic scheduling system prevents operational centralization by distributing block production responsibilities across all qualified participants. This comprehensive decentralization approach addresses both governance and operational aspects of network control.

The decentralization benefits of SDPoES extend beyond simple authority distribution to encompass resilience characteristics that traditional systems cannot provide. Geographic distribution of equal-authority nodes creates robust networks that can withstand regional disruptions, regulatory challenges, or infrastructure failures without compromising overall network operations. The combination of equal authority and geographic distribution ensures that network control remains distributed across diverse participants and locations, providing superior resilience compared to traditional consensus mechanisms.

Extensive testing with large networks has demonstrated high throughput and low latency capabilities that exceed the performance characteristics of traditional consensus mechanisms under comparable conditions. Testing with networks exceeding 1,000 master nodes has validated the scalability claims of SDPoES while identifying and addressing performance bottlenecks that would compromise traditional systems at similar scales. The testing results demonstrate that SDPoES can maintain consistent performance standards across varying network sizes and geographic distributions.

The performance validation through extensive testing encompasses real-world operational scenarios that traditional consensus mechanisms cannot handle effectively. High transaction volumes, geographic distribution challenges, and network connectivity variations that commonly disrupt traditional systems have been successfully managed through the adaptive capabilities of SDPoES. The testing results provide empirical evidence that SDPoES can deliver enterprise-grade performance while maintaining decentralization principles that traditional systems often sacrifice for performance improvements.

Flexibility through the hybrid approach combining hierarchical authority with business logic enables SDPoES to accommodate diverse application requirements that traditional consensus mechanisms cannot support. The hybrid authority model allows networks to implement customized governance structures that reflect specific business needs while maintaining decentralized consensus for core operations. Business logic integration capabilities enable complex workflow support and customizable validation rules that extend far beyond the capabilities of traditional blockchain consensus approaches.

The flexibility advantages of the hybrid approach extend to comprehensive customization capabilities that enable SDPoES to adapt to evolving business requirements and regulatory environments. Traditional consensus mechanisms typically require fundamental architectural changes to accommodate new requirements, while SDPoES can adapt through configuration modifications and business logic updates that preserve network stability and operational continuity. This adaptability ensures that SDPoES networks can evolve with changing business needs without requiring disruptive system migrations or architectural overhauls.

Network stability prioritization in SDPoES ensures continuous operation and robust performance that exceeds the reliability capabilities of traditional consensus mechanisms. The emphasis on network resilience over simple block production creates systems that can maintain operations despite individual node failures, connectivity disruptions, or performance variations that would compromise traditional networks. The stability prioritization encompasses both technical resilience and operational continuity that support enterprise-grade applications requiring high availability and consistent performance.

The stability advantages achieved through network resilience prioritization extend to comprehensive fault tolerance capabilities that traditional systems cannot provide. Automated failure detection, dynamic recovery mechanisms, and redundant operational pathways ensure that network operations continue despite various types of disruptions or challenges. The combination of technical resilience and operational flexibility creates networks that can adapt to changing conditions while maintaining consistent service levels that meet enterprise requirements for reliability and availability.

### System Integration

A unified platform according to this disclosure integrates any of the following interconnected components to provide secure, scalable, and user-accessible distributed data management across blockchain networks: an interactive graphical user interface (GUI) for decentralized database management, a hybrid relational and non-relational database system, and a Self-Delegated Proof of Equal Stake (SDPoES) consensus mechanism. These components cooperate to address the technical challenges of decentralized data management while maintaining accessibility for users without extensive blockchain expertise.

The interactive GUI, described in detail above with reference to FIGS. 1A through 10B, provides a user-friendly interface layer that abstracts blockchain complexities from end-users. The GUI layer 101 (FIG. 1A) includes the input mapping module 102 for translating user actions into backend commands, the real-time monitoring module 104 for displaying node status and database health metrics, and the error handling module 106 for assisting users in troubleshooting issues. Through this interface layer, users can perform database operations such as schema creation, data querying, and access control management without requiring direct knowledge of underlying blockchain protocols or cryptographic operations.

The hybrid relational and non-relational database system, described in detail above with reference to FIGS. 11 through 20, provides the data storage and management foundation for the unified platform. The hybrid database system integrates structured data storage with schema-defined relationships alongside flexible, schema-less data structures within a single platform. The Value Contracts 1112 (FIG. 11) define database schemas and validation rules, while the Indexing Mechanism 1128 (FIG. 11) creates and maintains indexes for optimizing data retrieval operations. The Multi-Cluster DLS Architecture 1202 (FIG. 12) enables scalability through dynamic clustering that can expand to accommodate growing data volumes and network demands.

The SDPoES consensus mechanism, described in detail above with reference to FIGS. 21 through 30, provides the consensus foundation that validates and synchronizes database operations across the distributed network. The SDPoES Consensus Framework 2302 (FIG. 23) can include the Dynamic Scheduling Engine 2304 for coordinating block production activities, the Stake Validation System 2312 for managing master node qualification, and the Block Production Controller 2320 for managing block creation and validation. The equal stake authority model ensures that network control remains distributed across all qualified participants rather than concentrated among high-stake entities.

These three components cooperate through defined communication pathways and shared data structures. For example, the GUI layer 101 (FIG. 1A) can communicate with the node layer 108 (FIG. 1A), which serves as an intermediary between user interface operations and the blockchain layer 116 (FIG. 1A). When a user initiates a database operation through the interactive GUI, the input mapping module 102 translates the user action into backend commands that are processed by the proxy server 110 (FIG. 1A). The proxy server validates and formats requests for blockchain interaction before forwarding them to the hybrid database system for execution.

The hybrid database system receives validated requests and processes them according to the data model being accessed. For relational queries, the system executes SQL-like queries with schema enforcement through the relational value contract 1904 (FIG. 19). For non-relational queries, the system executes flexible queries on schema-less data through the document value contract 1906, wide columnar value contract 1908, and/or key-value contract 1910 (FIG. 19). The Hybrid DB Transaction Interface 1110 (FIG. 11) packages processed data into blocks that can be submitted to the distributed ledger network for consensus validation.

The SDPoES consensus mechanism validates database transactions through the consensus process described with reference to FIG. 28. Master nodes participating in the active production schedule validate blocks by reaching consensus before data is committed to the distributed ledger. The two-thirds consensus requirement ensures that database updates are agreed upon by a substantial portion of the network before being recorded as immutable entries. The Network Synchronizer 2326 (FIG. 23) propagates validated blocks to all participating nodes, ensuring data consistency across the distributed network.

The cooperation between these components enables unique and advantageous operational capabilities. For example, real-time monitoring through the GUI layer provides visibility into consensus operations and database health, allowing users to track block production, transaction validation, and node performance through the explorer lite plugin 604 (FIG. 6). The Permission Management Component 1114 (FIG. 11) enforces access controls that are validated through the consensus mechanism, ensuring that permission changes are recorded immutably on the distributed ledger as shown in the permission enforcement workflow 2000 (FIG. 20).

The unified platform also supports horizontal scalability through the integration of these components. As additional nodes join the network through the master node onboarding process described with reference to FIG. 27, the SDPoES consensus mechanism incorporates them into the production schedule while the hybrid database system replicates data across the expanded node pool. The Centralized DLS Coordinator 1204 (FIG. 12) coordinates operations between clusters to ensure consistent data integrity and inter-cluster communication as the network grows.

In some cases, the unified platform can support automated database deployment, backup, and version control operations that leverage all three components. For instance, the GUI layer can provide visual tools for configuring these automated operations, the hybrid database system can manage the data storage and retrieval aspects, and the SDPoES consensus mechanism can validate and record the operations on the distributed ledger. This integration enables organizations to benefit from automated database management while preserving the security and integrity guarantees provided by the blockchain infrastructure.

The present disclosure contemplates a computer-readable storage medium that includes one or more sequences of computer-readable instructions. The computer-readable instructions, when executed by one or more processors, can cause a computer device, system, or platform to perform operations described herein, including operations performed by the hybrid database system, the SDPoES consensus mechanism, the interactive GUI, and related components, devices, and systems. In some cases, the computer-readable storage medium can include a single medium or multiple media that store one or more sets of instructions. The computer-readable storage medium can include any medium that can store or encode a set of instructions for execution by a machine and that causes the machine to perform any one or more of the methodologies described in this disclosure.

The hybrid database system described herein can include and can be implemented by one or more specialized computers including specialized hardware and software components. A specialized computer can be a programmable machine capable of performing arithmetic and logical operations and specially programmed to perform the functions described herein, including rendering the interactive GUI and executing the SDPoES consensus mechanism. In some cases, computers can comprise processors, memories, data storage devices, and other components. These components can be connected physically or through network or wireless links. Computers can also comprise software that can direct the operations of the components.

The processors within the specialized computers can execute the computer-readable instructions stored on the computer-readable storage medium to perform operations of the hybrid database system. In some cases, the processors can execute instructions for receiving database operation requests through the interactive GUI, determining whether database operation requests are for relational or non-relational data, processing database operation requests using appropriate data models, validating processed database operations through the SDPoES consensus mechanism, and updating the hybrid database to reflect validated database operations. The processors can also execute instructions for creating and maintaining indexes, enforcing access controls, executing queries that span both relational and non-relational data models, distributing and replicating data across nodes, dynamically adjusting system resources based on operational demands, and rendering real-time monitoring displays through the interactive GUI including node status, database health, and blockchain transaction information.

The memories within the specialized computers can store data and instructions for execution by the processors. In some cases, the memories can include volatile memory such as random access memory (RAM) for storing data during active processing operations, and non-volatile memory for storing persistent data and instructions. The memories can support the caching mechanisms described herein, including state caching for frequently accessed data, action and transaction caching for data being processed, and database index caching for commonly used indexes. The type-mapping operations described herein can utilize the memories to organize structured data with type information for efficient access and processing. The memories can also support session management for the interactive GUI, enabling multiple user sessions simultaneously on a single node.

The data storage devices within the specialized computers can provide persistent storage for the distributed ledger, database indexes, value contracts, and other data maintained by the hybrid database system. In some cases, the data storage devices can include solid-state drives, hard disk drives, or other storage media capable of storing the ledger data replicated across nodes in the network. The data storage devices can store the blocks containing validated transactions confirmed through the SDPoES consensus mechanism, the indexes created by the indexing mechanism, and the schema definitions and validation rules specified in value contracts.

Computers within the hybrid database system can be referred to as servers, personal computers, mobile devices, and other terms for computing and communication devices. These terms can be used interchangeably for purposes of this disclosure, and any special purpose computer particularly configured for performing the described functions can be used to implement the hybrid database system. In some cases, the computers can include servers that function as master nodes within the distributed ledger network participating in the SDPoES consensus mechanism, personal computers that function as client devices for accessing the hybrid database through the interactive GUI, and mobile devices that interact with the database through APIs or other interfaces.

Computers within the hybrid database system can be linked to one another via one or more networks. A network can be any plurality of completely or partially interconnected computers wherein some or all of the computers are able to communicate with one another. In some cases, connections between computers can be wired, such as via wired TCP connections or other wired connections. In some cases, connections between computers can be wireless, such as via Wi-Fi network connections or other wireless protocols. Any connection through which at least two computers can exchange data can be the basis of a network for the hybrid database system.

Separate networks can be interconnected such that one or more computers within one network can communicate with one or more computers in another network. In such cases, the plurality of separate networks can form a single network for purposes of the hybrid database system. The network architecture can support the distributed ledger system described herein, enabling master nodes to communicate for SDPoES consensus validation through dynamic scheduling and block production coordination, data replication, and state synchronization across the decentralized network. In some cases, the network architecture can support the multi-cluster configuration described herein, enabling inter-cluster communication and coordination through the centralized coordinator, with the interactive GUI providing real-time visibility into network operations and cluster status.

The term “computer” as used herein can refer to any electronic device or devices, including those having capabilities to be utilized in connection with an electronic information or transaction system. The computer can comprise a server, a processor, a microprocessor, a personal computer such as a laptop, palm PC, desktop, or workstation, a network server, a mainframe, or an electronic wired or wireless device. In some cases, the computer can comprise a telephone, a cellular telephone, a personal digital assistant, a smartphone, an interactive television such as a television adapted to be connected to the Internet, an electronic device adapted for use with a television, an electronic pager, or any other computing and communication device capable of interacting with the hybrid database system through the interactive GUI or participating in the SDPoES consensus mechanism as a master node.

The term “network” as used herein can refer to any type of network or networks, including those capable of being utilized in connection with the systems and methods described herein. In some cases, the network can include public networks such as the Internet, private networks such as intranets, or extranets that provide controlled access to external parties. The network can include wired networks, wireless networks, or combinations thereof. The network infrastructure can support the distributed architecture of the hybrid database system, enabling communication between master nodes participating in the SDPoES consensus mechanism, clusters, and client applications accessing the system through the interactive GUI across diverse network topologies and geographic locations.

The specialized computers implementing the hybrid database system can be configured to execute the SDPoES consensus mechanism operations described herein. In some cases, the computers can execute instructions for validating transactions through the Self-Delegated Proof of Equal Stake (SDPoES) consensus mechanism, requiring master nodes in an active production schedule to validate blocks by reaching two-thirds consensus before data is committed. The computers can execute instructions for participating in consensus rounds organized into seventeen-node production groups, validating signatures, checking permission levels, producing blocks within designated 0.5 second time windows, and recording validated transactions on the distributed ledger. The interactive GUI can provide users with real-time monitoring of consensus operations, block production progress, and node performance metrics through the explorer lite plugin and real-time monitoring module.

The specialized computers can also be configured to execute the clustering and scalability operations described herein. In some cases, the computers can execute instructions for monitoring network load and data volume, determining when clustering is required, creating new clusters, assigning nodes to clusters, initializing cluster consensus through the SDPoES mechanism, establishing inter-cluster communication, and synchronizing with centralized coordinators. The computers can execute instructions for monitoring cluster performance, determining when re-balancing is needed, and redistributing workloads across clusters to maintain system performance. The interactive GUI can display cluster status, performance metrics, and workload distribution through customizable dashboards, enabling users to monitor and manage the distributed system without requiring extensive blockchain expertise.

The specialized computers can further be configured to execute the permission management operations described herein. In some cases, the computers can execute instructions for validating signatures on action requests initiated through the interactive GUI, checking permission levels against access controls, evaluating dynamic conditions such as time constraints or network state, executing authorized actions validated through the SDPoES consensus mechanism, and recording permission actions in the immutable ledger. The computers can execute instructions for enforcing hierarchical permission structures and supporting event-triggered permissions based on operational conditions. The interactive GUI can provide visual tools for access control management, enabling users to configure permissions, view permission hierarchies, and monitor permission-related transactions through the database overview and key elements displays.

A number of implementations have been described herein. Nevertheless, it will be understood that various modifications may be made without departing from the spirit and scope of the disclosure. Accordingly, other implementations are within the scope of the following claims.

1. A system for decentralized database management, comprising:
an interactive graphical user interface (GUI) layer configured to receive user actions for database operations, the GUI layer including:
an input mapping module configured to translate user actions into backend commands,
a real-time monitoring module configured to display metrics related to one or more of node status, database health, and blockchain transactions, and
an error handling module configured to categorize errors under specific codes for troubleshooting;
a hybrid database system integrated within a decentralized blockchain network, the hybrid database system configured to support both relational and non-relational data models, the hybrid database system including:
one or more value contracts defining database schemas and rules for data operations, and
an indexing mechanism configured to create and maintain indexes for optimizing data retrieval operations; and
a Self-Delegated Proof of Equal Stake (SDPoES) consensus mechanism configured to validate and synchronize database operations across a plurality of nodes in the decentralized blockchain network, the SDPoES consensus mechanism including:
a dynamic scheduling engine configured to coordinate block production activities among master nodes with equal stake authority, and
a stake validation system configured to manage qualification of master nodes through memory staking requirements.

2. The system of claim 1, wherein the input mapping module is further configured to compile the backend commands into WebAssembly (WASM) format for execution within the decentralized blockchain network.

3. The system of claim 2, wherein the input mapping module is further configured to generate Application Binary Interface (ABI) files during compilation of the backend commands into the WASM format.

4. The system of claim 1, wherein the real-time monitoring module includes an explorer lite plugin configured to provide monitoring of one or more of node performance, block production, and transaction inspection.

5. The system of claim 1, wherein the GUI layer is configured to enable users to customize dashboards by selecting specific metrics to monitor and setting thresholds for alerts.

6. The system of claim 1, wherein the GUI layer further includes one or more visual tools configured for at least one of schema creation, data querying, and access control management.

7. The system of claim 6, wherein the one or more visual tools include a drag-and-drop interface for designing database schemas.

8. The system of claim 1, further comprising a node layer positioned between the GUI layer and the hybrid database system, the node layer including:
a proxy server configured to validate requests from the GUI layer and format the requests for blockchain interaction; and
a data buffer configured to temporarily store data during operations.

9. The system of claim 8, wherein the proxy server is configured to implement security measures including at least one of rate-limiting, IP filtering, and signature verification.

10. The system of claim 8, wherein the node layer further includes a consensus interaction module configured to interface with the SDPoES consensus mechanism for confirming transactions.

11. The system of claim 8, wherein the node layer further includes a load balancer configured to distribute traffic and transaction requests across nodes to prevent bottlenecks during high-demand periods.

12. The system of claim 8, wherein the node layer further includes a temporary database configured to store pending actions when network traffic is high or when a node is unable to push data to the decentralized blockchain network immediately.

13. The system of claim 1, wherein the one or more value contracts are configured to define a combination of table structures, column types, and relationships between entities for relational data.

14. The system of claim 1, wherein the one or more value contracts are configured to provide flexible schema definitions for non-relational data while enforcing rules requiring specific metadata fields to be present in documents.

15. The system of claim 1, wherein the indexing mechanism is configured to automatically generate indexes based on predefined rules and data usage patterns.

16. The system of claim 15, wherein the indexing mechanism is further configured to support user-defined indexes that enable users to manually define custom indexes for specific records.

17. The system of claim 1, wherein the indexing mechanism supports up to sixteen different indexes per composition for query operations.

18. The system of claim 1, wherein the hybrid database system further includes a permission management component configured to establish and enforce access controls for database operations at a blockchain level.

19. The system of claim 18, wherein the permission management component is configured to support dynamic permissions based on specific conditions comprising at least one of time constraints and network state.

20. The system of claim 18, wherein the permission management component is configured to record permission actions in an immutable ledger and maintain an audit trail of all authorized operations.

21. The system of claim 1, wherein the hybrid database system further includes a hybrid database transaction interface configured to package processed data into blocks for submission to the decentralized blockchain network for consensus validation.

22. The system of claim 1, wherein the dynamic scheduling engine includes a round manager configured to organize master nodes into production rounds of seventeen master nodes each.

23. The system of claim 22, wherein the SDPoES consensus mechanism requires a majority consensus of two-thirds of the seventeen master nodes in a production round to validate and confirm each transaction.

24. The system of claim 1, wherein the stake validation system includes a static IP validator configured to verify that master nodes maintain static IP addresses for continuous node availability.

25. The system of claim 1, wherein the stake validation system includes a memory stake verifier configured to validate that nodes meet a minimum stake requirement for master node qualification.

26. The system of claim 1, wherein the SDPoES consensus mechanism further includes a block production controller configured to manage creation, validation, and synchronization of blocks within the decentralized blockchain network, wherein the block production controller enforces a block creation time window of 0.5 seconds for each master node in a production schedule.

27. The system of claim 26, wherein the block production controller includes a network synchronizer configured to propagate validated blocks to all participating master nodes for data synchronization across the decentralized blockchain network.

28. The system of claim 1, wherein the SDPoES consensus mechanism further includes a node performance monitor configured to track performance metrics for participating master nodes, the performance metrics including at least one of block production rate, uptime, and response time.

29. The system of claim 28, wherein the SDPoES consensus mechanism is configured to automatically remove master nodes from a production schedule when the master nodes fail to meet established performance criteria for a pre-defined period.

30. The system of claim 1, further comprising a multi-cluster architecture including a centralized coordinator configured to oversee and coordinate operations between a plurality of clusters to ensure consistent data integrity and inter-cluster communication.
